(19) United States
(12) Patent Application Publication
(10) Pub. No.: US 2017/0053076 A1
(43) Pub. Date: Feb. 23, 2017

(54) Systems and Methods for Determining HIPAA Compliance

(71) Applicant: ITus Health LLC, Eagleville, PA (US)

(72) Inventors: Ashok Lulla, Eagleville, PA (US); Scott E. Emmert, Green Lane, PA (US); Edward A. Cienki, Hammonton, NJ (US); Surya Chitra, Wilmington, DE (US)

(21) Appl. No.: 15/242,296

(22) Filed: Aug. 19, 2016

Related U.S. Application Data
(60) Provisional application No. 62/208,268, filed on Aug. 21, 2015.

(51) Int. Cl. G06F 19/00; G06F 21/62

(52) U.S. Cl. CPC G06F 19/328; G06F 19/3431; G06F 21/6245

(57) ABSTRACT

Methods, systems and platforms for identifying, processing, and analyzing the nature and scope of health-care compliance status related to health-care information at rest, in motion and in storage in a network. Analysis can be made of progress in completing health-care compliance activities based on selected parameters. A database comprising hierarchical data structures reflecting relationships among health-care compliance activities can be established and analyzed. Further disclosed is mapping of the healthcare ecosystem as reflected in relevant networks comprising a set and subset of nodes through which Protected Health Information can pass, with resulting determination of risk parameters thereof.

### CROSS-REFERENCE TO RELATED APPLICATIONS

This application claims priority to U.S. patent application Ser. No. 62/208,268, filed Aug. 21, 2015, the contents of which are incorporated by reference herein.

### BACKGROUND

There are a number of government entities involved in the oversight of the Health Insurance Portability and Accountability Act, popularly referred to as HIPAA. These entities include the U.S. Department of Health and Human Services (HHS), via Office of the National Coordinator for Health Information Technology (ONC), Center for Medicare and Medicaid Services (CMS), Office of Civil Rights (OCR), Office of Privacy (OOP), and National Institute of Standards and Technology (NIST) which have stipulated the privacy/access and security policies, rules, and regulations which must be compiled by what are knowns as covered entities (CEs) and business associates (BAs). A CE can be considered a health care provider, or a health care clearinghouse. A BA can be considered a person or entity that performs certain functions or activities that involve use or disclosure of protected health information (PHI) on behalf of, or provides services to, a CE. (http://www.hhs.gov/hipaa/for-professionals/privacv/laws-regulations/)

The obligatory measures referred to above can be difficult to implement. They may lack clarity, fragmentation, be disorganized, and not be task-oriented, because the healthcare digital ecosystem focus and adoption has been prioritized on integrating the clinical and financial services. The critical issues around security, privacy, and breach reporting have been relegated to a secondary focus and priority. A shared responsibility for CEs and BAs which has not been prioritized is the real-time workflow of PHI at the three points of the journey: motion, rest, and storage. This fact is further substantiated by the healthcare system sector vulnerabilities, which are at the top of the list, surpassing those in the financial industry. With the healthcare sector's impact representing almost 20% of the U.S. gross national product, there is a clear opportunity to address this gap and bring a systematic approach with a digital workflow solution aligned to safeguard PHI to wide and scalable acceptance. Compliance with the growing number of health-care laws, statutes, rules and regulations has been characterized by severe challenges. There has been a high level of reported breaches by providers, payers, and business associates. It has been reported that there were an estimated 145 million reported breaches in 2014 to 2015.

There has been among other things a deficit of skills, system level controls and training to manage the continuity of Protected Health Information (PHI). Even as individual entities have a difficult time, the challenge is compounded by system-level challenges. Shared responsibility—which can be very important to meeting these challenges—is lacking.

The passage of Payment Card Industry (PCI) and Protected Health Information (PHI) requirements and regulations by HHS/OCR/DOJ/FTC/NIST/ONC (discussed herein) have created an onerous burden to manage and protect data into continuity for Covered Entities and Business Associates effective Sep. 23, 2013. Further, accelerated expansion of the health-care digital ecosystems creates fragmented and porous situations, making safeguard of PCI/PHI a challenge.

There have been a number of points of convergence that characterize the current environment relating to health-care compliance. These include the following. In June 2016 OCR HIPAA Phase 2 Audit Notifications for CEs and BAA were made known. There have been ongoing compliance resolution agreements. Also, the Department of Justice has commenced criminal prosecution. Class action litigation has ensued, such as a major health care provider accused of 80 million breaches. Last but not least, effective 2016 onwards CMS/ONC Value Based Reimbursement (VBR) will require a shared responsibility platform (interoperability) for security, privacy and consent documentation from payers, providers, and vendors. (https://www.healthit.gov/sites/default/files/hie-interoperatbility/nationwide-interoperability-roadmap-final-version-1.0.pdf). This ties and integrates HIPAA regulations and incentives under ‘Value Based Reimbursements’ currently in play. This includes compliance integrated with incentives and payments so if payments are collected without safeguarding of ePHI (, i.e., electronic PHI) query whether fraud is being committed. A shared responsibility model for CEs, BAs, and third parties can help to remediate the foregoing. So far the shared responsibility model has few takers. Acceptance of shared responsibility must be accelerated to safeguard ePHI.

### DRAWINGS

The features of the various embodiments are set forth with particularity in the appended claims. The various embodiments, however, both as to organization and methods of operation, together with advantages thereof, may be understood by reference to the following description, taken in conjunction with the accompanying drawings as follows:

FIG. 1 illustrates an example architecture of a health-care compliance computing environment.

FIG. 2 illustrates an example network environment in which protected health information (PHI) in in use, at rest and in motion.

FIG. 3 illustrates relationships among entities and PHI risks associated therewith.

FIG. 4 illustrates an example design and architecture layout in accord with aspects of the invention.

FIG. 5 illustrates an example module for Business Associate Agreement (BAA) and Enterprise Architecture (EA) document uploads.

FIG. 6 illustrates an example platform web services stack and/or architecture.

FIG. 7 illustrates an example functionalities and architectures that can deploy agent risk analysis and assessment of PHI.

FIG. 8 illustrates an example agent integration architecture.

FIG. 9 illustrates an example functionality and architecture diagram illustrating PHI document and secure file import.

FIG. 10 illustrates an example functionality and architecture diagram illustrating a user interface and storage.

FIG. 11 illustrates an example functionality and architecture diagram illustrating an end-to-end modular offering for PHI users such as Covered Entities (CEs) and Business Associates (BAs).

FIG. 12 illustrates an example functionality and architecture diagram illustrating an end-to-end application with a cloud platform.

FIG. 13 illustrates an example health-care compliance database structure.

FIG. 14 illustrates an example health-care compliance user interface (UI).

FIG. 15 illustrates an example of mechanisms by which the system can identify and load into the system Business Associate Agreements (BAAs) and Engagement Agreements (EAs).

FIG. 16 illustrates an example screenshot related to BAAs.

FIG. 17 illustrates an example screenshot related to BAAs.

FIG. 18 illustrates an example screenshot related to BAAs.

FIG. 19 illustrates an example relationship of Solution Areas, Protocol Measures, Tasks, and Action Step, and their respective contents and actions associated therewith.

FIG. 20 illustrates an example login screen.

FIG. 21 is an example flow based on when a user accesses a Risk Assessment screen to manage Tasks.

FIG. 22 is an example flow illustrating aspects of the review process and steps associated therewith.

FIG. 23 is an example flow illustrating aspects of security and steps associated therewith.

FIG. 24 is an example flow illustrating aspects of upload and steps associated therewith.

FIG. 25 is an example flow illustrating aspects of upload and steps associated therewith.

FIG. 26 is an example flow illustrating aspects of workforce training and steps associated therewith.

FIG. 27 is an example flow illustrating aspects of workforce training and steps associated therewith.

FIG. 28 is an example flow illustrating aspects of uses/disclosures functionality and steps associated therewith.

FIG. 29 is an example health IT (HIT) ecosystem roadmap.

FIG. 30 is an example ONC shared responsibility roadmap, showing alignment with incentives.

FIG. 31 is an example CMS/Office of National Coordinator (ONC) value-based reimbursement framework.

FIG. 32 is an example CMS/ONC incentive alignment.

FIG. 33 is an example physician practice showing inventory examples.

FIG. 34 is an example PHI safeguard ecosystem diagram showing points/nodes.

FIG. 35 is an example role-based authentication diagram.

FIG. 36 is an example network topology.

FIG. 37 is an example network topology.

FIG. 38 is an example network topology.

FIG. 39 is an example report on potential policy violations.

FIG. 40 is an example report on business transactions.

FIG. 41 is an example transaction flow map.

FIG. 42 is an example diagram mapping the flow of PHI in a network.

FIG. 43 is an example diagram mapping the flow of PHI in a network

FIG. 44 is an example infrastructure analysis showing IP address logs.

FIG. 45 is an example visualization of flow of PHI in a network

FIG. 46 is an example map of the PHI ecosystem.

FIG. 47 is an added embodiment of a customized dashboard showing a posture score.

FIG. 48 is an example health-care compliance ecosystem focusing on a doctor's office.

FIG. 49 is an example of a network showing PHI and functionalities and mechanisms for handling such within the context of health-care compliance.

### DESCRIPTION

Advantages will accrue from an end-to-end (E2E) mapping of the healthcare ecosystem to safeguard PHI journey at creation, motion, and rest to destruction. Stakeholders include Covered Entities, Business Associates, and third parties.

Added advantages will accrue from mobilizing and integrating with the state of the art technology capabilities (include, Cloud, APP. API, APM, elastic storage, dynamic inventory of devices, tracking users, limiting access) as an integral part of security risk analysis and risk management processes based on digital workflow to identify the critical vulnerable nodes handling PHI. This includes implementing static and dynamic mapping in real time, identifying where PHI resides, who creates and has access to it, how it may change during the data lifecycle, by role and responsibilities, and how PHI flows internally and externally via networks (e.g., encrypted) to individuals and third parties. It also identifies the key components of developing and implementing an effective HIPAA, PCI (payment card industry) and other compliance strategy to manage risk associated with PHI and data leakage.

Healthcare organizations must develop these robust defenses to protect PHI and confidential information from an ever increasing variety of internal and external threats. They must also be prepared to detect and mitigate damaging attacks inside and outside of their networks. Finally, the overall risk analysis and risk management initiative success in complying with federal and state regulatory requirements requires a shared responsibility approach and a cost effective strategy for implementation for all the impacted stakeholders.

The four U.S. Federal agencies' oversight includes:

Human Health Services/Center for Medicare-Medicaid Services—incentive and meaningful use through a staged approach, with core requirements in each that providers and vendors can meet for privacy and security

Office of Civil Rights, which administers and enforces HIPAA privacy, security, breach notification, investigation of complaints, rules, measures and audits. An Office of Privacy has been established.

Office of National Coordinator (extension of CMS)—provides support for adoption and promotion of Electronic Health Records (EHRs) and health information exchanges and offers educational tools to assist providers with keeping electronic health information private and secure.

National Institute of Standards and Technology (NIST)—2008 HIPAA security safeguards, whose role is administrative, physical, and technical in nature, including relating to security.

In order for any organization (Covered Entity, Business Associate and third parties) to address fully the complex comprehensive requirements of the Final Rule (implemented Sep. 23, 2013), they can address the complete chain of events related to the journey of PHI which includes the total enterprise of staff, affiliates, vendors, and third parties with access to PHI. This effort is expected to be ongoing, with a cultivated ability to provide the OCR required documentation of rule implementation within two weeks of request.

These multiple components can be grouped into 12 discrete areas of focus that the Office of Civil Rights (OCR) has defined based on analysis, interpretation and issuing guidance and policies based on findings of the healthcare market survey data (Pricewaterhouse Coopers, KPMG, and Booz Allen). (The number of areas of focus can be less or more depending on the circumstances but the principles herein can be understood to apply.)

It will be appreciated that health care laws, statutes, rules, regulations, guidelines and interpretations thereof can evolve over time. It will be readily understood that the teachings herein can be applied to such new developments as they may be substantively similar to existing or prior health care precedent, whether statutes, rules and the like are under a different name, promulgate by or governed by a different body, and so on.

The OCR in 2013 submitted and identified eleven required areas for focus to comply with the HIPAA statutes, and additional areas may apply as below:

Policy Development

Business Associate Agreements

Risk Assessment

Security Management

Privacy Documentation and Access

Work Force Management

Work Force Training

Uses and Disclosure

Security Incident Procedures

Breach Assessment and Resolution

Contingency Disaster Planning

Attestation by Third Party

Various embodiments, methods, systems and platforms herein factor in each of the 168 required measures that need to be addressed to ensure adherence to the Final Rule. These 168 measures are grouped into solution areas. Each of these 168 required measures relate to activities and tasks involving multiple individuals and departments within and outside an organization (including affiliates, agents, volunteers, vendors, Accountable Care Organizations (ACOs) and exchanges). These activities typically add up to several of work flow tasks (independent and/or dependent) which are collected in groups of tasks in a solution area and stored in a database. Average scores at the task and solution area level can be calculated, analyzed for predictive analytics and benchmarking, compared to specific rule based stored procedures linked to a robust relational database to confirm, document and validate completion of task by rule and responsibility to reduce risks and meet compliance requirements. Also included is mobilization of project management capabilities to integrate all these discrete activities with just in time clear rapid communication, actions and tracking for documenting each discrete activity. This enables the organization (such as CEs and BAs) to conform and validate adherence to the requirements for security, privacy, access and meaningful consent with the enterprise infrastructure while the PHI information is at rest and in motion. The prime intent of the regulations is to organize a culture of compliance related to PHI.

Again, it will be appreciated that more or fewer measures may be relevant, names of statutes or rules, may differ and so on, fully within the scope of the teachings herein.

The methods, systems and platforms herein leverage technology capabilities including the use of cloud services to import and export data to the client servers. Methods, systems and platforms herein can apply technology capabilities to accelerate and translate the standard measures, into applied business rules and knowledge with healthcare workflow experience to create a streamlined technical platform, providing real-time reporting of a “HIPAA Posture” score and generating OCR documentation upon request. The security, privacy/access and breach notification requirements are foundational (aligned with the OCR staged approach) in that they are part of meeting meaningful use and qualifying for the various incentive programs by Centers for Medicare and Medicaid Services (CMS) and Office of the National Coordinator for Health Information Technology (ONC).

As mentioned earlier, nationwide interoperability across the diverse health IT ecosystem will require stakeholders to agree to and follow a common set of standards, services Integrating business associate agreements and service contracts), policies and practices that facilitate the appropriate exchange and use of health information nationwide and do not limit competition. Once established, maintaining interoperability will also require ongoing coordination and collaborative decision-making about future change.

It will be appreciated that the systems, platforms and methods herein are not limited to the provisions, regulations, statutes, capabilities and functionalities of the above programs but can apply to such in the future. Put another way, teachings herein can apply to HIPAA and can also apply to additional healthcare and other rules, and variations, new or evolved manifestations over time, and the like.

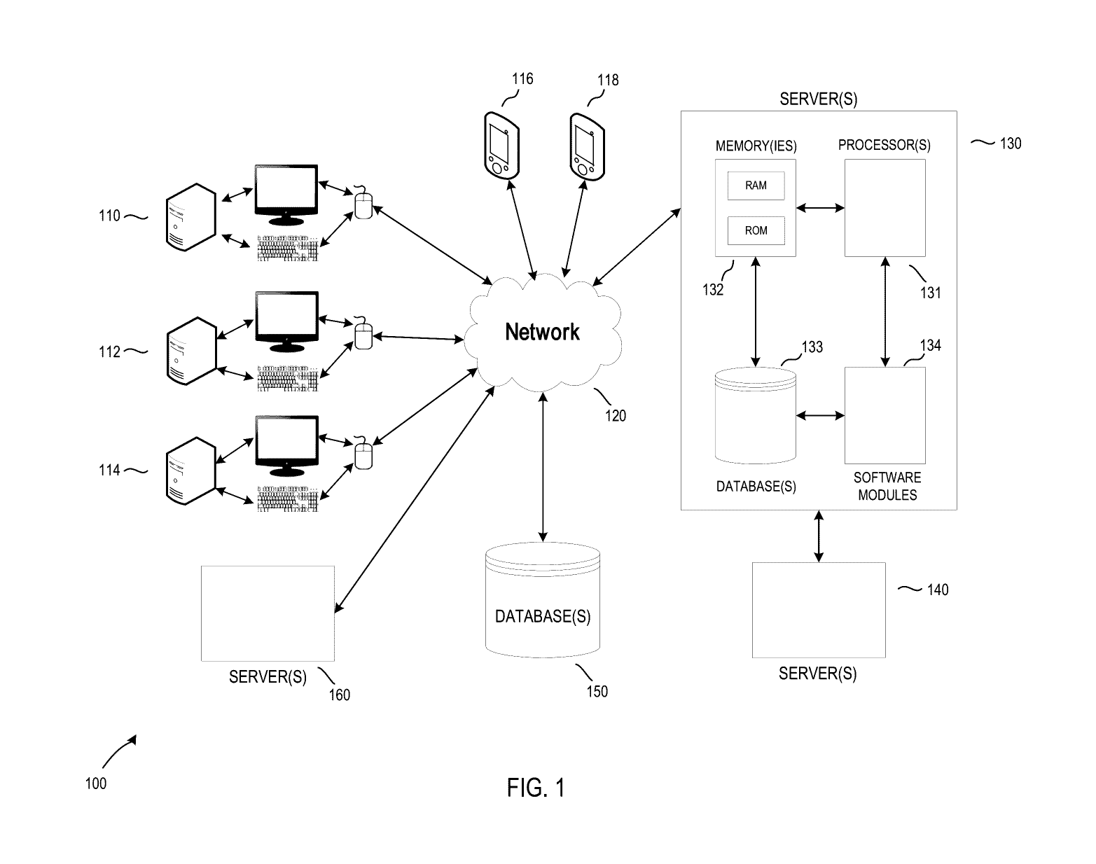

Reference will now be made in detail to several non-limiting embodiments, including embodiments showing example implementations. The figures depict example embodiments of the disclosed systems, platforms and/or methods of use for purposes of illustration only. One skilled in the art will readily recognize from the following description that alternative example embodiments of the systems and methods illustrated herein may be employed without departing from the principles described herein. FIG. 1 can illustrate a computing environment 100 for assisting with HIPAA compliance. HIPAA laws, statutes, rules and regulations can be found at http://www.hhs.qov/hipaa/for-professionals/privacy/laws-regulations. Additional authority, context and interpretation can be found at: https://www.qpo.gov/fdsys/pkg/FR-2013-01-25/pdf/2013-01073.pdd, and https://www.healthit.qov/sites/default/files/pdf/privacy/privacy-and-security-guide.pdf. (2013 OMNIBUS HIPAA Final.)

HIPAA compliance server 130 can carry out multiple actions, functionalities and processes, can be operatively associated with database 150, as by a network 120. HIPAA compliance server 130 can comprise a processor(s) 131, memory(ies) 132 including RAM and ROM, database 133, and software modules 134. Additional server(s) 140, 160 can be in operative communication with elements associated with the computing environment 100. Database 150, which can comprise multiple databases, can comprise extensive PHI associated with many individuals and entities, storing or having access to individual profiles, entity profiles, and any relevant information related to health processes and management. Network 120 can represent a network or numerous networks of any logical or physical size such as a broad network such as the Internet, and can represent a small one such as a LAN or hyperlocal network, it being understood that a network enables communication of data from one computing device to another. HIPAA compliance server 130 can be operatively associated with a computer(s), input device(s) and display(s) 110, 112, 114. Computer, input device and display 110, 112, 114 (wherein the foregoing can be singular or plural devices) can contain or be operatively associated with a processor(s), and with memory(ies) which may include software applications. Computer, input device and display 110, 112, 114 can comprise a personal computer, a laptop, a tablet, a mobile device 116, 118 such as a smart phone, smart glasses, or a smart watch; it will be appreciated that any device containing or in operative association with a processor(s) and a memory(ies) can serve the purpose of computer and input device 110, 112, 114. Network 120 can permit operative communication of the foregoing functionalities with added devices, functionalities and modules. It is understood that some or all of the foregoing functionalities can be in operative communication via one or more networks, wired or wireless. Each of the foregoing functionalities can be controlled by mechanism of software instructions embodied in a non-transitory computer medium. It will be appreciated that a software resource can be constituted within the functionality of FIG. 1 that can facilitate processing HIPAA compliance, wherein the software resource can be located within HIPAA compliance server 130, and/or any of the other components.

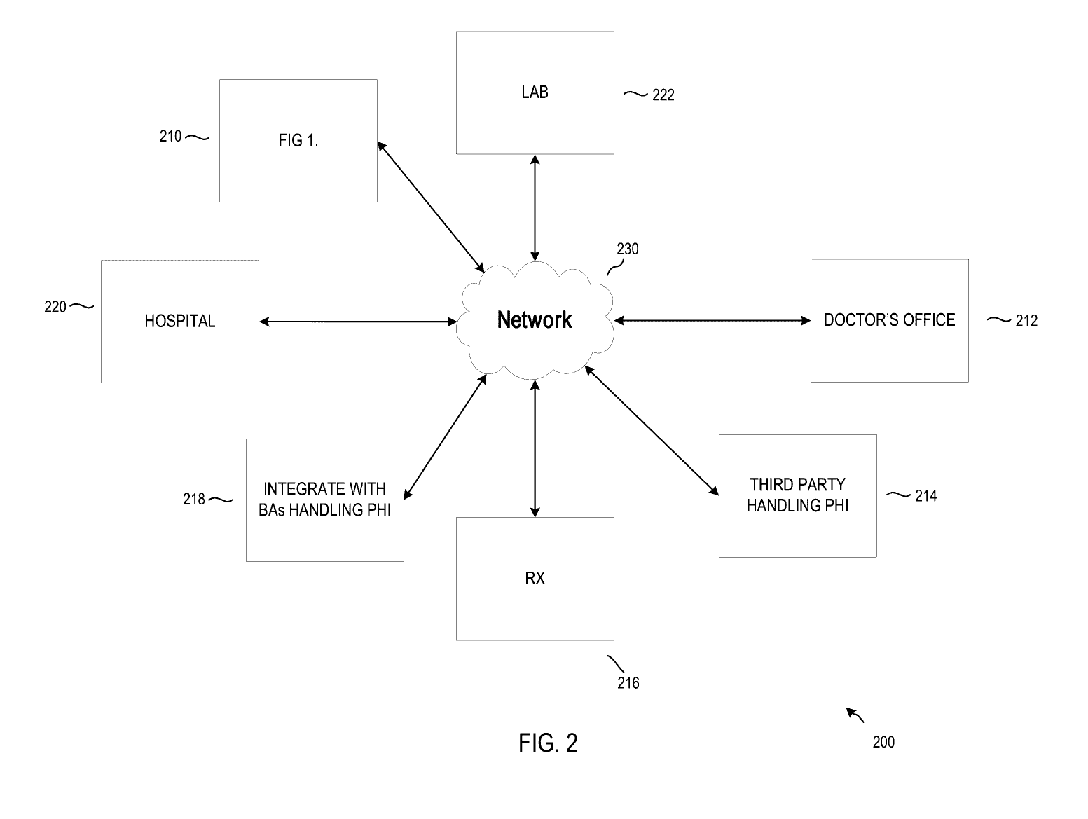

FIG. 2 is an example of an environment in which PHI information is at use, at rest and in motion. Added entities can be located therein. The functionalities and architectures seen in FIG. 1, represented as element 210, can be considered interoperative with those in FIG. 2. It will be understood that some, many or all elements of FIG. 1 can be considered to reside in or in communication with box 210, and such reference to FIG. 1 is not meant to be limiting. The PHI, then, can come from or go to: a doctor's office, 212, third-parties 214 of various kinds and their methods for handling PHI, a prescription entity 216, BAs 218 and their methods of handling PHI, a hospital 220 or other health care institution 220, and/or a lab 222. Communications to and from any of the foregoing or other entities can be made by mechanism of a network 230.

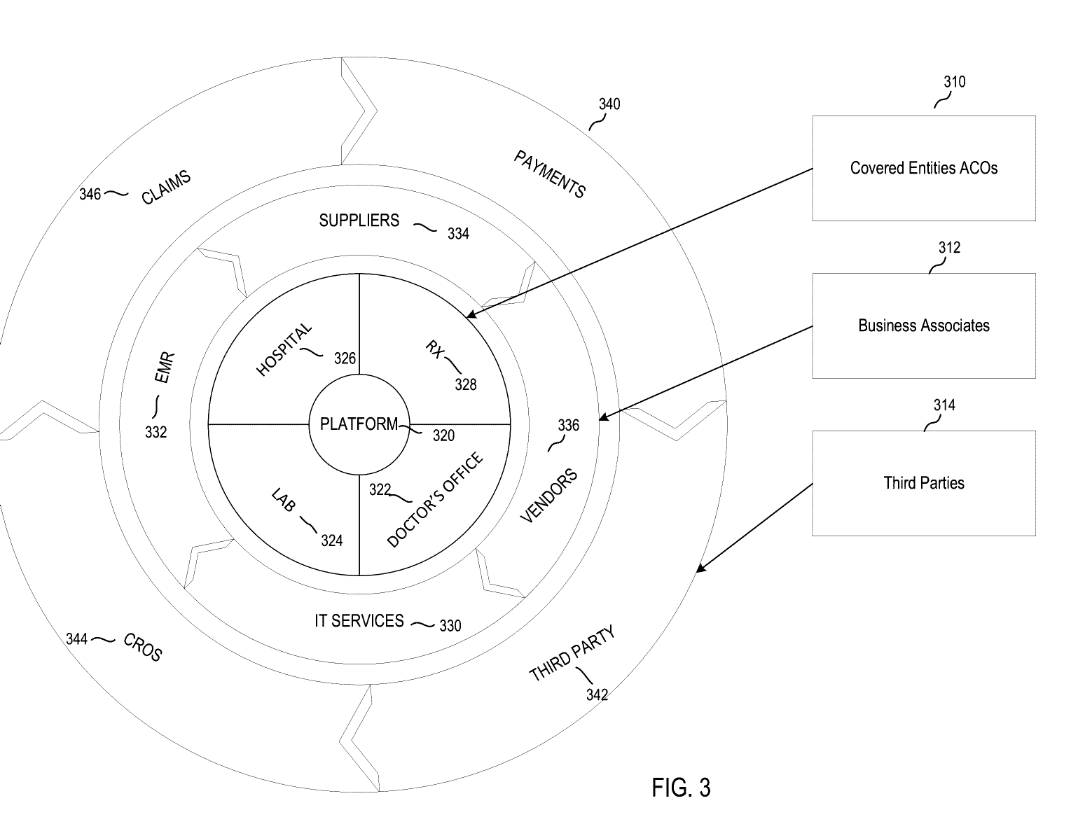

FIG. 3 is an example of an environment showing relationships among entities and PHI risks associated therewith. Shown are Covered Entities and ACOs 310, Business Associates 312, and Third Parties 314. Covered Entities and ACOs 310 have particular relationships and risks in relation to PHI associated with a doctor's office 322, lab 324, hospital 326, and prescription entity 328. Business Associates 312 have particular relationships and risks in relation to PHI associated with IT services 330, electronic medical records (EMR), suppliers 334, and vendors 336. Third parties of various types (related to the above or not) can have particular relationships and risks in relation to payments 340, third parties 342, contract research organizations (CROs), and health-care 346 claims such as related to insurance.

Embodiments of a health-care compliance platform 320 disclosed herein can, inasmuch as it can represent a hub for architectures and functionalities herein disclosed, be considered useful for systems and methods for determining HIPAA compliance.

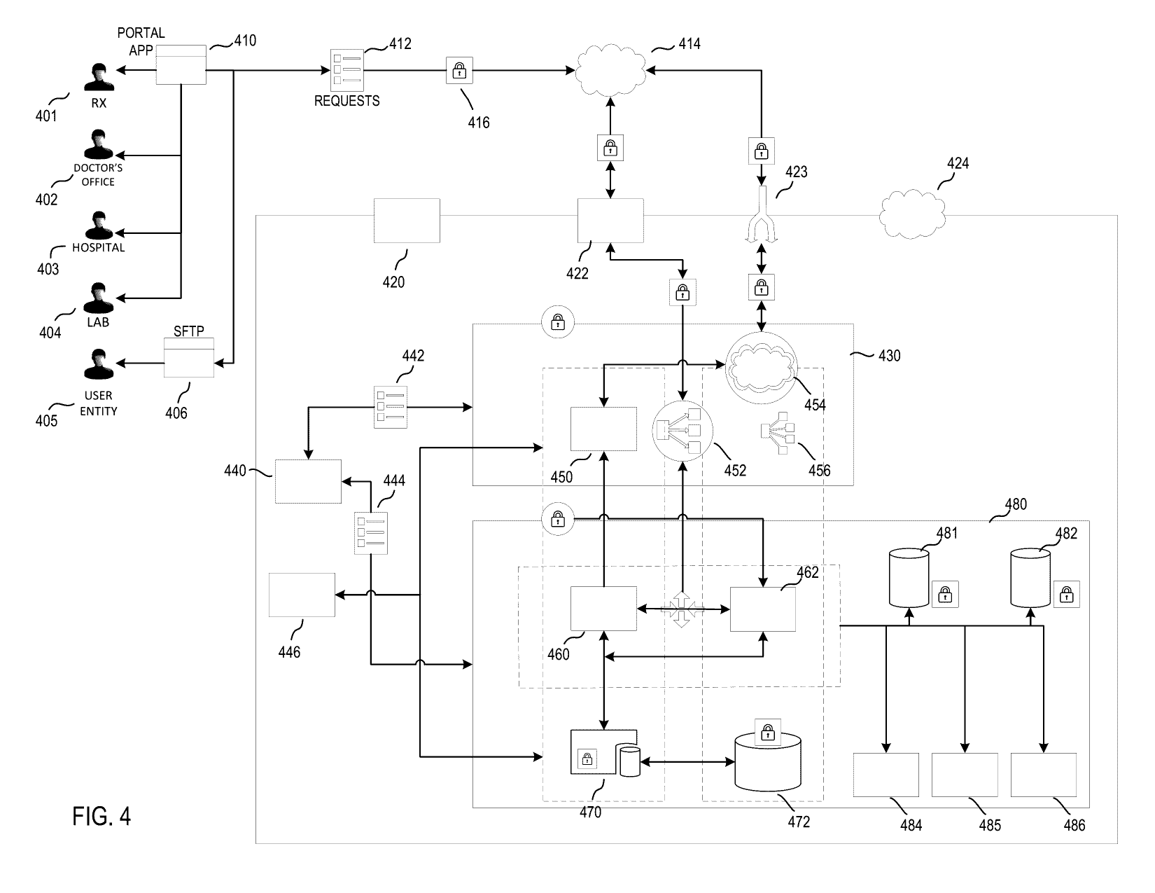

FIG. 4 is an example design and architecture layout in accord with aspects of the invention. A prescription entity 401, doctor's office 402, hospital 403, lab 404, or other user/entity 405 can employ a portal application 410 to interact with additional architecture and functionalities. Communications can be mediated such as by SSH File Transfer Protocol (SFTP) 406, or other secure modality. Requests 412 can be made in an encrypted or otherwise secure environment 416 (the icon for which can indicate further instances thereof in the drawing) through a network 414. Domain name system 422 can be employed. Functionality associated with a domain name system in this diagram and added diagrams can also be analogized to that of a router or routing mechanisms. API Gateway 423 can be used. A web services and/or cloud functionality 424 can be employed. A virtual private network (VPN) 430 can comprise elements and modules including a network gateway 454, internet gateway 456, bastion server 450, and load balancer 452. An added VPN 480 can comprise or contain added elements and modules. These can include instances 460, 462 of an application to carry out functionalities in accord with the invention, working as appropriate with auto-scaling. Also provided can be a MS SQL encrypted database 470, in one auto-scaling module, and a secondary DB slave 472 (encrypted) in an added auto-scaling module. Also present can be an encrypted database 481, and database 482 which may or may not be differentiated by storage speed, throughput, cost, etc., such as Amazon S3 or Glacier respectively. Added applications can include a natural language control interface 484 such as Cognito, a code functionality 485 such as Lambda, and searching as by CloudSearch 486. Application monitoring and analysis functionalities 440 can be interoperative, including through analytics engines 442, 444. Cloud monitoring 446 can be employed such as CloudWatch.

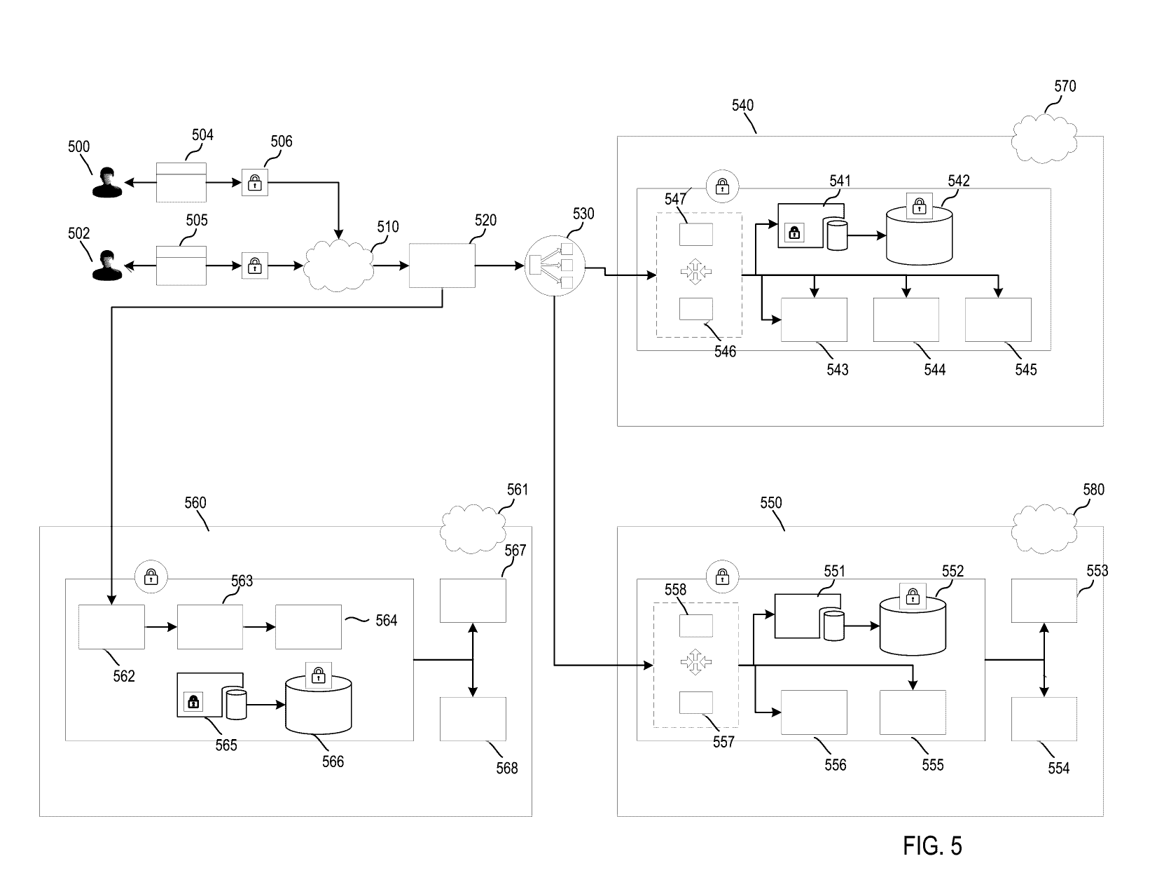

FIG. 5 is an example module for Business Associate Agreement (BAA) and Engagement Agreement integrated into a service contract (EA) document uploads. A user 500 can interact via secure mechanisms such as SFTP 504 and HTTPS 506 over a network 510 in communication with a domain name server 520 such as Amazon Route 53. In addition, a user 502 can interact with an application enabling functioning of the platform herein via secure mechanisms 505 with a network 510 in communication with a domain name server 520. In operative communication with the above can be a load balancer 530.

A Credentials Fetch module 540 can comprise a number of modules and functionalities. It can have instances 546, 547 of an application herein, with auto-scaling, to carry out teachings of the invention. An encrypted database using MS SQL (encrypted) 541 and be in communication with a secondary database slave (encrypted) 542. Additionally provided can be a natural language control interface 543 such as Cognito, cloud monitoring such as CloudWatch 544 and dynamic applications 545.

A Documents Upload Flow module 560 can comprise a number of modules and functionalities. It can operate in conjunction with network 561. A domain name server 562 can be used. A natural language control interface 563 can be provided. A search functionality can be provided 564. In communication therewith can be database 565 comprising encrypted database using MS SQL (encrypted) and be in communication with a secondary database slave 566 (encrypted).

Further, a Search and Documents Fetch Flow module 550 can be provided. It can operate in conjunction with network 580. It can have instances 557, 558 of an application herein, with auto-scaling, to carry out teachings of the invention. In communication therewith can be database 551 comprising encrypted database using MS SQL (encrypted) and be in communication with a secondary database slave (encrypted) 552. There can be search functionality 556, and storage functionality 555. It can have a monitoring service 553, and dynamic applications 554.

The modules described herein can operate in sequence, e.g., credentials fetch, documents upload flow, and search and documents fetch flow. Other sequences and portions of sequences can be used.

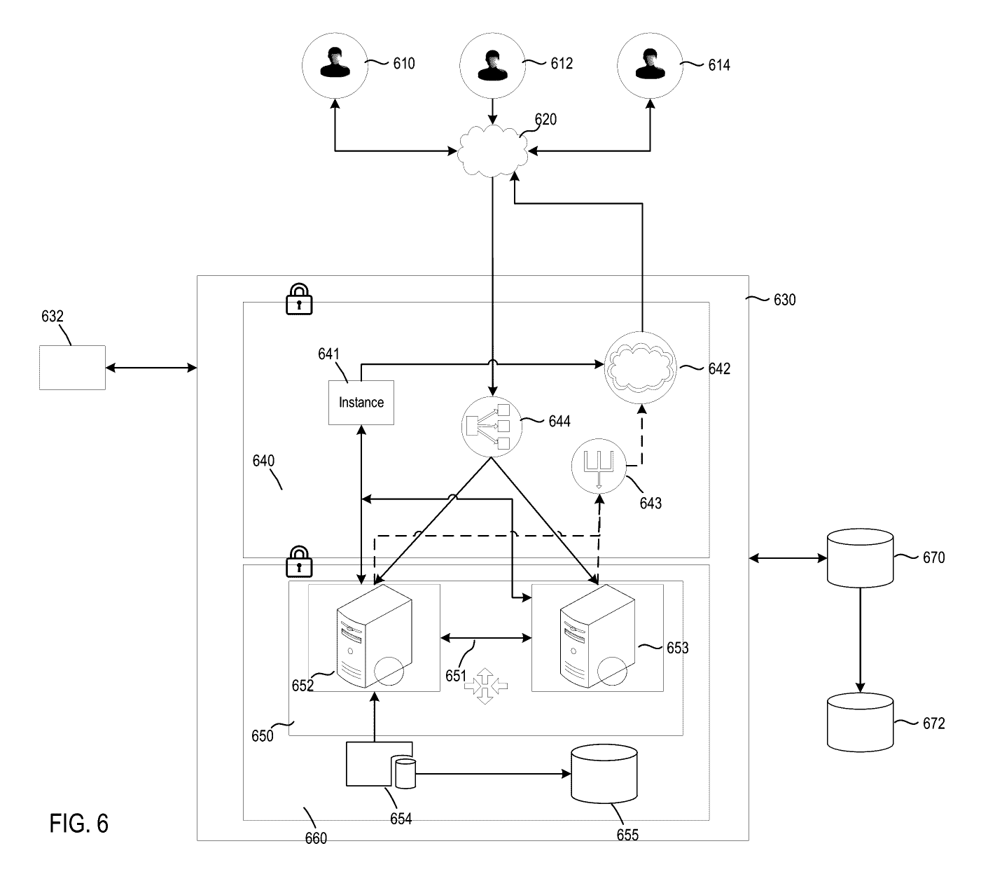

FIG. 6 is an example platform web services stack and/or architecture. Entities and/or users involved can include a contract director 610 who can for example perform BAA approval, a primary user 612 (e.g., contract manager) who can for example perform BAA import, and a secondary user 614 (e.g., legal, management, compliance) who can for example perform BAA revision. Information and operations can be carried out through a network 620 in operative communication, via secure communication, with modules and submodules, such as those given by module 630. These modules and submodules can include a Load Balancing Tier 640 which can comprise or facilitate an instance 641 of an application herein such as one in or in communication with a bastion server. An internet gateway 642 can also facilitate, as can a NAT gateway 643. An elastic load balancer 644 can perform operations. In addition, an API Tier 650 can be used, which can have a web server 652 and web server 653 that can be in operative communication 651 via IIS/.NET—Internet Information Services (IIS), and .NET framework. In addition, a Data Tier 660 can include an encrypted database using MS SQL (encrypted) 654 and be in communication with a secondary database slave (encrypted) 655. Further, a storage functionality 670 and 672 can be provided. In addition, monitoring 632 can be employed. ***And Encryption is also a safe harbor provision under the HIPAA Breach Notification Rule.35 This means that if a HIPAA Covered Entity (CE) or Business Associate (BA) (e.g., a cloud-based EHR and data services provider who may have custody of the electronic protected health information (ePHI)) chooses to encrypt ePHI consistent with guidance in the HIPAA Breach Notification Rule.36 and discovers a breach of that encrypted information, neither a CE nor a BA is required to provide the breach notifications specified in the Rule.

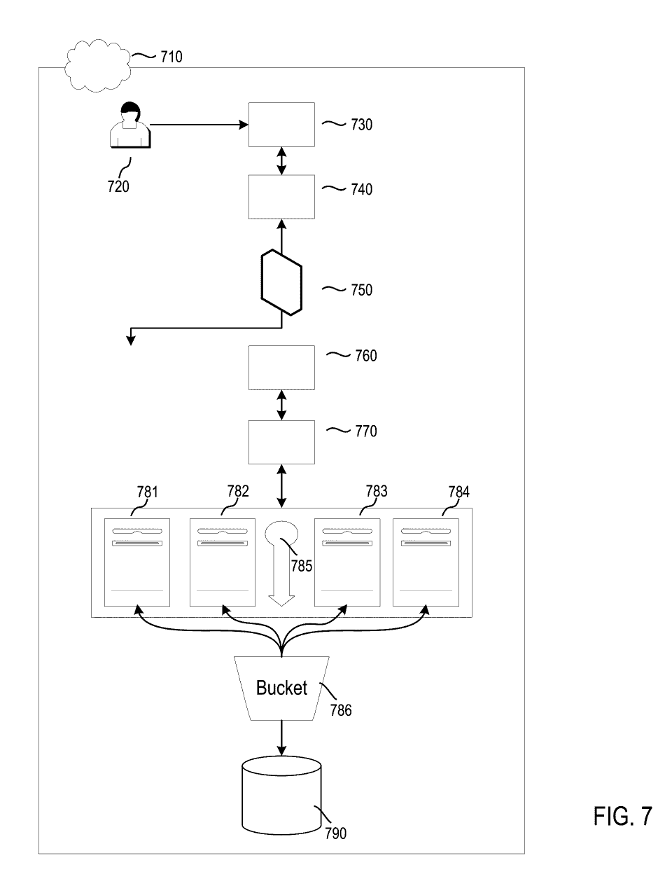

FIG. 7 is an example of functionalities and architectures that can deploy agent risk analysis and assessment of PHI. A web services mechanism 710 can be used. An entity/user 720, such as covered entities, can be in operative communication with application logic 730, itself in operative communication with an application performance management functionality 740 such as AppDynamics and other Application Performance Systems (APMs). A “wall” 750 can be interposed and there be an API gateway 760 and a load balancer 770. In communication therewith can be several devices 781, 782, 783, 784 such as but not limited to servers that can use address functionality such as Elastic IP 785 and be in communication with a bucket 786 functionality, itself in communication with a database. 790.

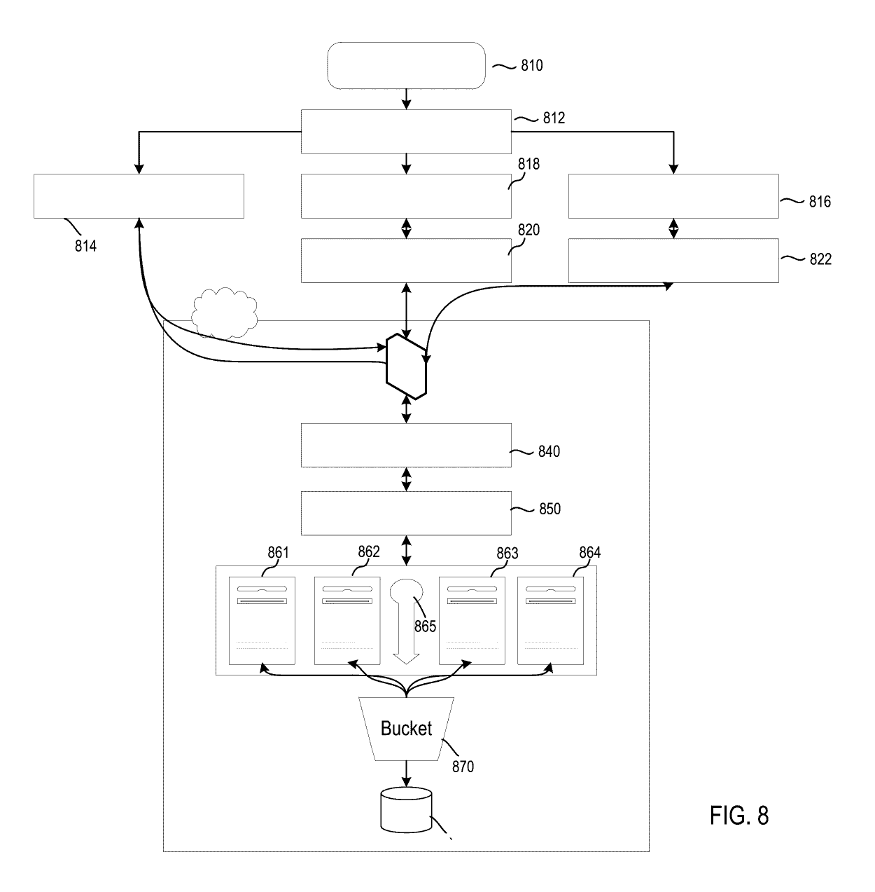

FIG. 8 is an example of an agent integration architecture. Control can pass from a BAA detail module 810 to a module listing of application steps 812, itself in communication with a fetch action step data module 814, create template module 818, and load template module 816. A template can be stored to a database 820, and data fetched from a database 822. A “wall” 830 can be interposed, and a module containing submodules and added architectures be provided. These include an API gateway 840, load balancer 850, several devices 861, 862, 863, 864 such as but not limited to servers that can use address functionality such as Elastic IP 865 and be in communication with a bucket 870, itself in communication with a database module 880, such as relational database management system.

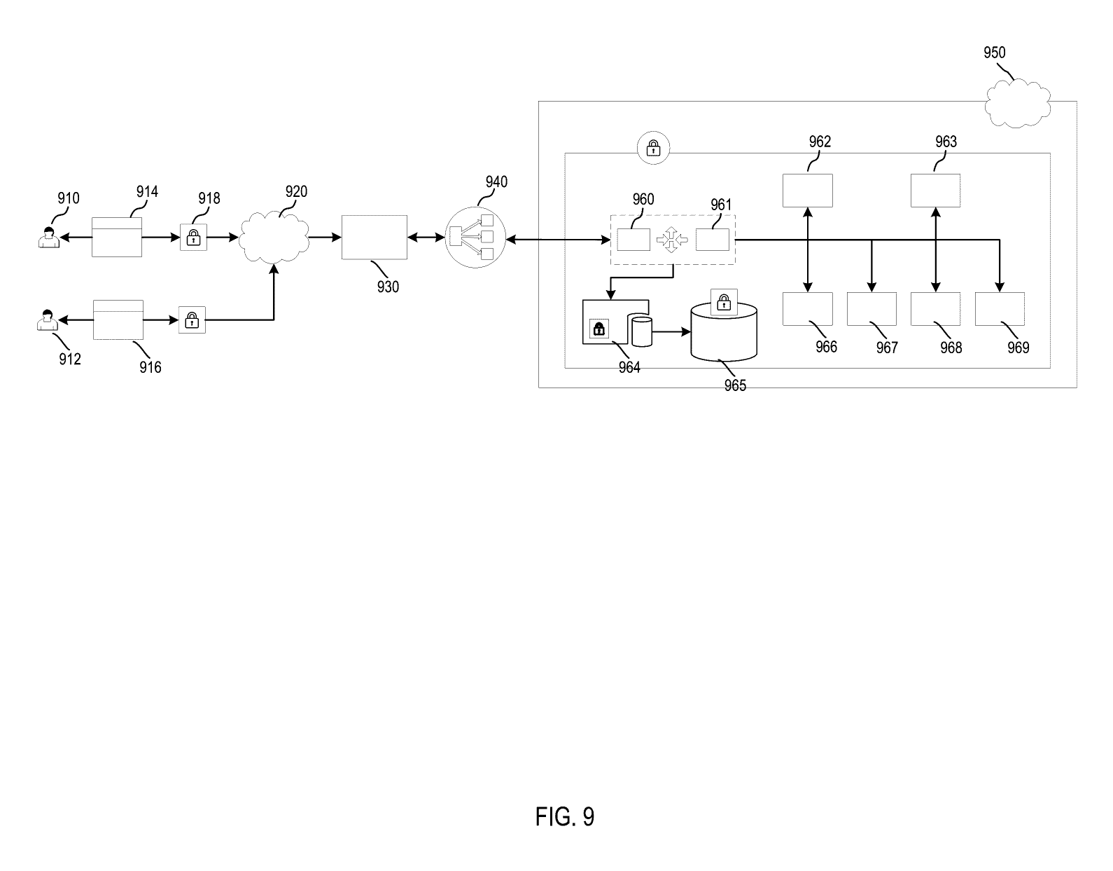

FIG. 9 is an example functionality and architecture diagram illustrating PHI document and secure file import. A user 910 can via SFTP 914 communicate in secure fashion (such as by https) via a network 920 with a domain name server 930. In addition, a user 912 can via application functionality in accord with the invention communicate with a network 920 and domain name server 930. In turn, a load balancer 940 can be provided. Instances of the application 960, 961 can reside in communication with a relevant module mediated by a web services application 950. Provided also can be a monitoring application 962 and performance management application 963. In addition, there can be provided also an encrypted database 964, and database 965 which may or may not be differentiated by storage speed, throughput, cost, etc., such as Amazon S3 or Glacier respectively. Further, code functionality 966, a natural language control interface 967, a database 968, and search functionality 969 can be provided.

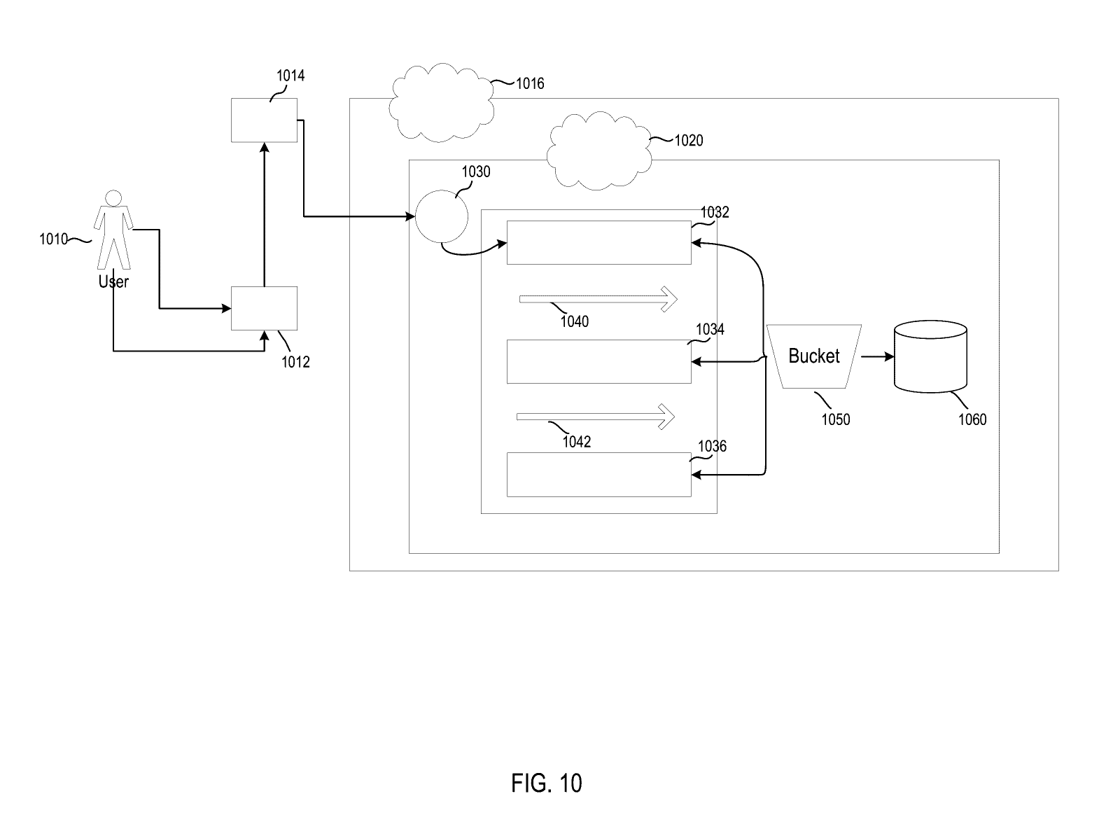

FIG. 10 is an example functionality and architecture diagram illustrating a user interface and storage. A user or users 1010 can interact with an API gateway 1012, which is in communication with a domain name server 1014. Control can pass to a module mediated by a web service 1016. An additional module can be mediated by a virtual private cloud, which can be in operative communication with devices 1032, 1034, 1036 such as but not limited to servers that can use address functionality such as Elastic IP 1040, 1042 and be in communication with a bucket 1050, itself in communication with a database 1060.

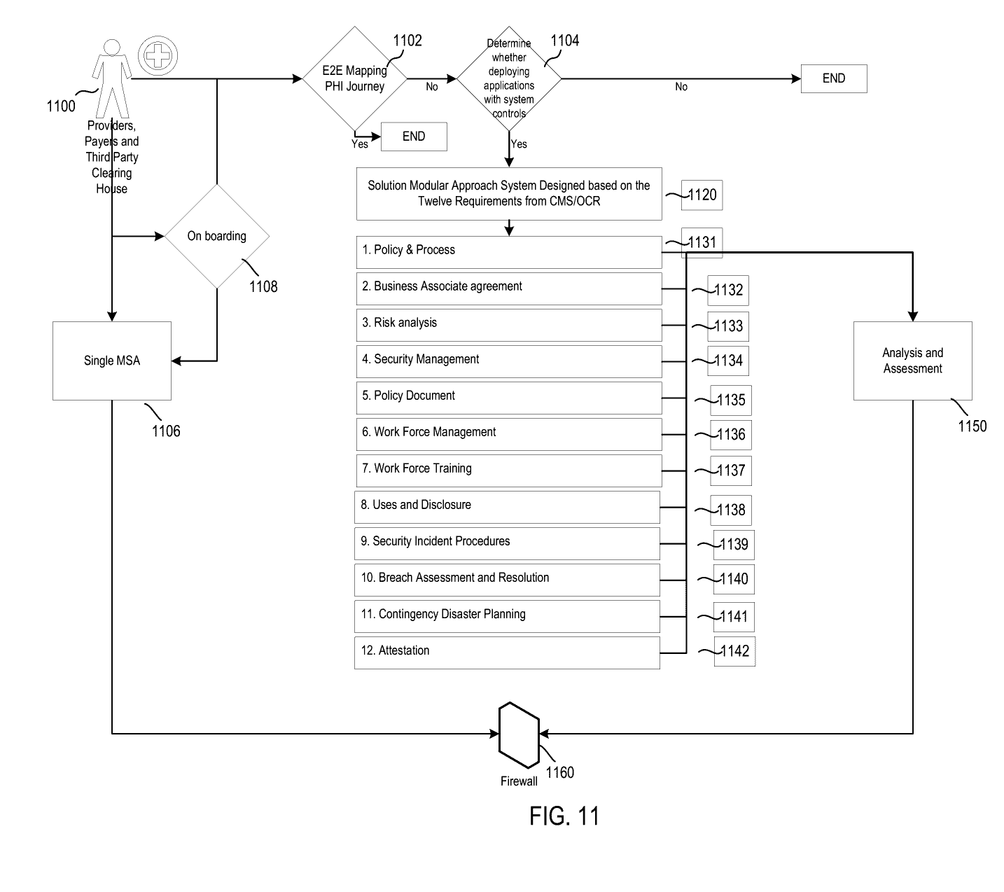

FIG. 11 is an example functionality and architecture diagram illustrating an end-to-end modular offering for PHI users such as CEs and BAs. Providers, payers and third party clearing houses 1100 can be in communication with an end-to-end mapping PHI journey module 1102. If an end-to-end mapping of the PHI journey is not made, opportunities can be determined to deploy applications with system controls 1104. If this is performed, a solution module approach can be performed, the system designed based on twelve requirements from CMS/OCR 1120. These modules can include Policy & Process 1131, Business Associate agreement 1132, Risk analysis 1133, security management 1134, policy document 1135, Work Force Management 1136, Work Force Training 1137, Uses and Disclosure 1138, Security Incident Procedures 1139, Breach Assessment and Resolution 1140, Contingency Disaster Planning 1141, and Attestation 1142. It will be appreciated that other requirements can be used, and these modified. Based on the above, analysis and assessment is performed 1150. A firewall can be interposed between this operation and a Medical Savings Account (MSA). On boarding 1108 can also be performed.

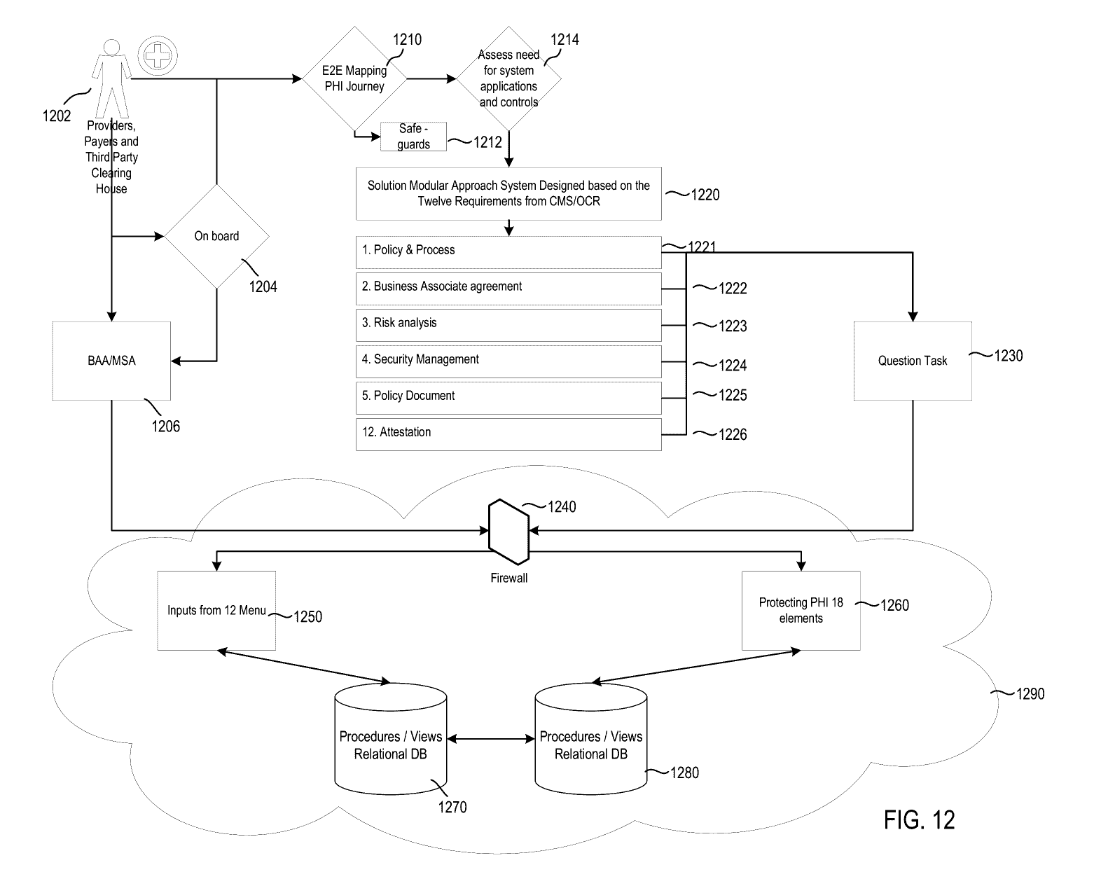

FIG. 12 is an example functionality and architecture diagram illustrating an end-to-end application with a cloud platform. Providers, payers and third party clearing houses 1202 can be in operative communication with an end-to-end mapping PHI journey module 1210. Safeguards 1212 can be in place. It can be assessed if there is a need for system applications and controls 1214. A solution module approach system designed based on the 12 requirements can be employed. These modules include but are not limited to Policy & Process 1221, Business Associate agreement 1222, Risk analysis 1223, security management 1224, policy document 1225, others as seen in FIG. 11, and attestation 1226. A question task 1230 can be given. A firewall 1240 can be strategically located in a cloud module 1290 with several functionalities. Inputs from the menu of twelve 1250 can be considered, and protecting PHI 18 elements performed. Relational databases 1270, 1280 can be used, each comprising procedures/views. It will be appreciated that databases of multiple functionalities can be used in accord with the present disclosure, relational databases being one type thereof.

In addition to the foregoing disclosure, it can be appreciated that the methods, systems and platforms herein can be designed as a Software as a Service (SAAS) model housed in a platform agnostic cloud. A Platform as a Service functionality can be used. The SAAS can include a scalable relational database that can house the data and the logic (in the form of stored procedures) necessary to perform all the HIPAA activities, tasks, and action steps, as well as provide all feedback to the organization.

Consistent with FIG. 1, access to the database can be available via the Internet using fully secured monitored networks and standard browsers including Internet Explorer, Safari, Firefox, and Google Chrome. User interfaces can be accessible via a device that is in communication with a processor and suitable memory such as desktops, mobile devices including laptops, phones, glasses, watches and so on, and on any operating system.

In addition, there can be multiple computing devices in operative communication with one or more networks. Also in operative communication with the one or more networks, and with other functionalities as illustrated herein, can be multiple servers. A non-limiting embodiment of an architecture of a server is given herein. It will be appreciated that one of skill will be able to implement embodiments herein on a number of physical and logical configurations, arrangements, and architectures, both hardware and software.

HIPAA Posture Score and Oversight Process

Each individual activity associated with the 168 measures (rules) can be assessed upon entry into methods, systems and platforms herein. This assessment can be displayed as a summary report showing the overall HIPAA score based on each of the 12 areas. This report can further break down the individual scores for each of the 12 areas so that Senior Management will know immediately the areas requiring further resources.

It will be understood that there may be numerous measures, not just 168. Correspondingly, there can be numerous areas, not just 12. There may be fewer of the above as well.

A roles based table exists within a database (such as via MS Access and MS SQL) that enables the assignment of activities to individual roles. Existing HR systems can be utilized to populate the tables in the database with the appropriate individuals associated with each role. That individual can be identified as being responsible for that activity. Many healthcare enterprises do not have the capability (staff and system level), resources, and/or tools to gain a just-in-time assessment of the risk and vulnerabilities. On the system and policy level, methods, systems and platforms herein can act such that it may be desirable for a number of individuals to mobilize and integrate these work streams into the methods, systems and platforms herein including: Chief Technology Officer (CTO), General Counsel, Chief Compliance Officer (CCO), and Chief Security Officer (CSO), with support from the Chief Executive Officer (CEO) and the Board of Directors (BODs).

The project manager (other designates and CCO, and CSO) can be able to further drill down to the individual measures, tasks and activities to determine specifically where additional resources are needed and to manage the completion of each activity. The project manager can be able to remind individuals (based on the HR roles provided) of the activities they need to complete along with the timeframe in which the activity needs to be completed.

Protecting PHI can be an enterprise level responsibility requiring a top down buy-in and commitment from the leadership team. This main (summary) dashboard can be available to C-suite and senior management (CEO, CCO, CTO, PM, CSO and BODs) for instantaneous evaluation of the Covered Entity/Business Associates HIPAA state (HIPAA Posture). This provides easy-to-read graphics for compliance with HIPAA and each individual area within HIPAA. It also enables the user-to track progress toward goals of achieving compliance and identify areas that need greater focus.

Database and Logic.

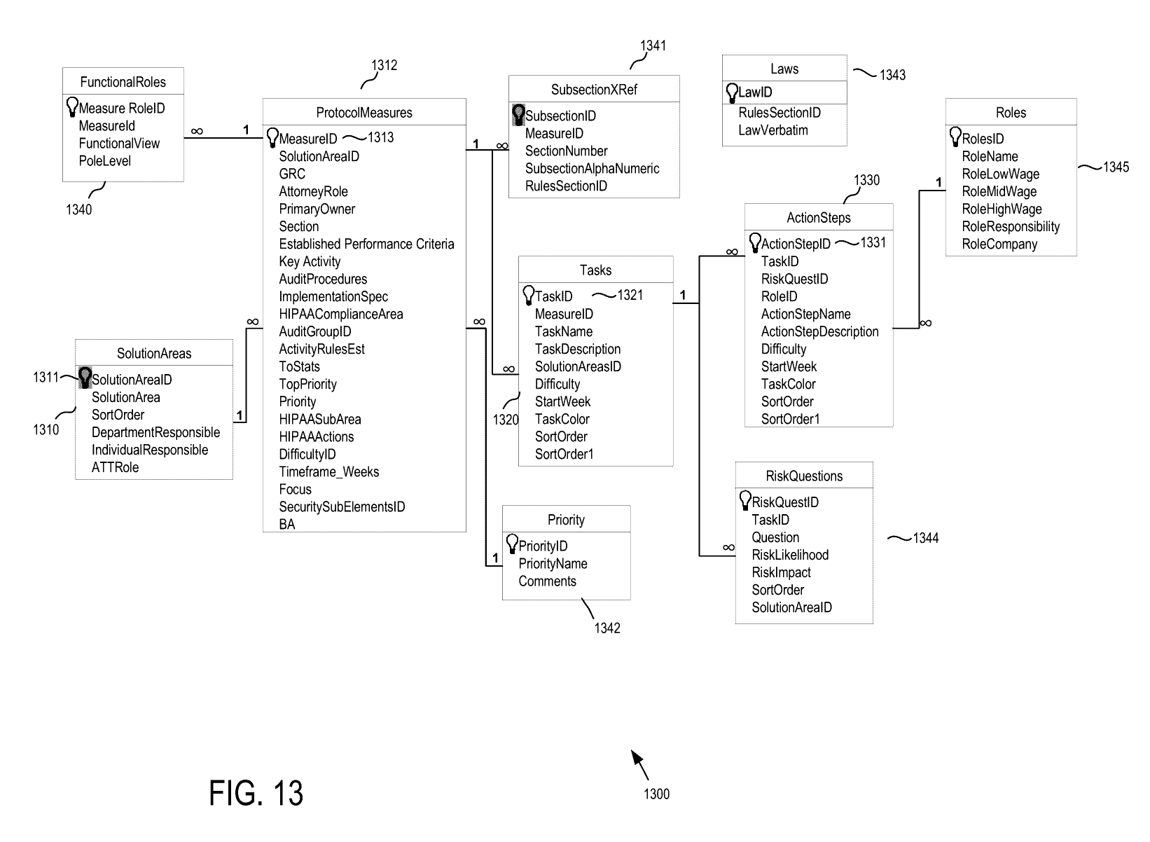

FIG. 13 shows an example database structure. A table in the database contains the 11 areas (SolutionAreas) 1310 and an associated primary key 1311 (SolutionAreaID) for each. This primary, key exists as a secondary key in a table containing the 168 audit measures 1312 or other measures (ProtocolMeasures). This enables the grouping of each measure into specific areas.

The tables can be stored in such a manner that they represent hierarchical relationships, both in a logical and physical sense. It will be understood that the tables, and the relationships thereof, can be represented in a schema. A reference such as a table name or other identifier, e.g., SolutionAreas, can also be understood as “Solution Areas” as an added mechanism for the representation thereof.

Primary key 1313 (MeasureID) in the protocol measures table (ProtocolMeasures) exists as a secondary key in a table 1320 (Tasks) that houses tasks associated with each audit measure. This links each task to the appropriate measure.

This platform can be designed to utilize parameterized code to perform different standard functions which can enable nearly unlimited evolution based on changing healthcare environments.

To summarize, parameterizing code also allows protocol measures, tasks, action steps, roles, responsibilities, timelines, scoring to evolve rapidly as healthcare continue to evolve.

Tables of the database can comprise:

SolutionAreas 1310

ProtocolMeasures 1312

Tasks 1320

RiskQuestions 1344

ActionSteps 1330

Roles 1345

Functional Roles 1340

Laws 1343

The database structure has a SolutionAreas 1310 table which contain areas of focus, here 12. The SolutionAreas table 1310 contains the primary key SolutionAreasID 1311. This primary key can exist as a secondary key in the ProtocolMeasures 1312 table. By linking these keys, each of the protocol measures, here 168, can then be grouped into specific solution areas.

In a similar fashion, Protocol Measures primary key MeasureID 1313 can exist as a secondary key in the Tasks Table 1320. This enables each Protocol measure to have specific tasks associated with them.

Next, the Task table 1320 has a primary key named TaskID 1321 which exists as a secondary key 1331 in the Action Step table. Actions steps are then associated with each Task.

The FunctionalRoles Table 1340 enables a protocol measure to be linked to a type of client. A Functions table (not shown) allows the system to define any type of client e.g., CEs (practice setting, pharmacy, hospital, nursing home); and BAs (EMR provider, legal and counsel, other service providers, etc.), and evolve the capability of the platform as healthcare continues to evolve. Functions to this table can be added as needed. A FunctionalRolesTable 1340 can be used to assign protocol measures 1312 to a specific type of client. The Protocol Measures primary key 1313 (MeasureID) exists as a secondary key in the FunctionalRoles table 1320.

As an example, a legal firm (BA) can serve as a type of client. By entering Legal in the Functions table (not shown), a row can be entered into the FunctionalRoles Table 1340 for each protocol measure that a legal firm may have to address. For each row entered, Legal can be assigned the functional role. A parameter can then can be “passed” identifying the protocol measure and the functional role into the code and create a platform customized for a legal firm.

A Roles table 1345 can be used where specific roles can be identified within a client and assigned protocol measures, task, and/or action steps to a specific role. This allows the system to provide only the specific measures, tasks or action steps to an individual thereby significantly simplifying HIPAA Compliance.

For example for the policies and procedures solution area a specific type of lawyer (Privacy Lawyer) within the legal firm may be responsible for drafting the PHI privacy policy. By assigning the Privacy Lawyer role to the action step of drafting the PHI privacy policy and “passing” the parameters for role and action step can create a list of action steps for the Privacy lawyer that includes drafting the PHI privacy policy. There can be standard roles, or roles customized to individual customers upon request.

A Laws table 1343 provides the capability to educate employees on the HIPAA Final Rule and other laws, statutes, rules, interpretations and the like. Each protocol measure is designed to address HIPAA compliance based on specific sections of the final rule (Omnibus). By using a cross reference table and a Laws 1343 table, a protocol measure can be associated with the specific section of the law that addresses that measure. Methods, systems and platforms herein can provide a link to the specific section of the law as employees address each measure.

Solution Areas

All 168 measures are grouped by 12 solutions areas. The grouping is accomplished by linking the primary key in the SolutionAreas table 1311 (SolutionsID) to a secondary key with the same name in the ProtocolMeasures Table 1312.

Business Associates Agreements

The protocol measures table (ProtocolMeasures) 1312 contains specific rows relating to Business Associate Agreements. These rows are linked via the primary key (MeasureID) in an audit measures table (not shown) to the same key in the table 1321 (Tasks) that houses all task associated Business Associate Agreements. Finally, tasks are further subdivided into action steps in a separate table 1331 (ActionSteps) linked by the TasksID key.

Tasks can be linked to specific roles so that each task and action step can be assigned to a role. An HR (Human Resource) table not shown with the individuals in the organization identified by role can be accessed to assign each task and action step to the appropriate individuals identified by that role.

A separate table for BAAs and EAs can be created to house the template documents as well as the specific versions for each individual BA. In addition, the approvers, date approved, and status for each document can be included. This information can enable logic to generate a reminder based on the approval date. It can also allow specific criteria required in each document to be evaluated and gaps in the criteria displayed.

This data structure can permit complete evaluation of all tasks associated with the Business Associate Agreements area to determine the percentage completion for this specific area.

While the database and coding is designed to simplify and systematize the complex process of meeting HIPAA Compliance, the establishment of a scoring (HIPAA Posture Score) can in real-time, or near real-time, quickly communicate how well a client is doing relative to compliance. The scoring can provide not only an overall score but each solution area can be scored based on each individual measure, task and action step. At any point in time, appropriate employees of the client can be able to identify exactly where the gaps are in meeting compliance and identify the tasks and action steps that need to improve compliance as well as the individuals accountable for each action step.

For example, scoring can be a percentage of the number of action steps completed relative to the total number of actions steps per task. If a task requires 4 action steps and 2 are completed the task can be scored at 50% (214=0.5×100=50%).

The measure of completion can be binary, such as 0% complete or 100% complete, with no added measure. Optionally, the measure of completion can be considered to the extent it is between 0% complete or 100% complete.

The score for each solution area can then be calculated as the total number of action steps completed for each task of each protocol measure associated with that solution area. If there are 2 action steps for each of 4 tasks for each of 3 protocol measures for one solution area there can be 24 action steps for the solution area (2×4×3=24) if 1 action step is completed for 4 tasks for 2 of the protocol measures then the solution area score can be 33% (1×4×2=8; 8/24=0.33×100=33%).

De-identified data from all clients can be obtained and a benchmarking database built to incorporate predictive analytics to be able to identify greatest areas of risk and how to best approach HIPAA compliance.

Organization of Solution Areas

Solution Areas not only serve to group and score the measures but they can be used to build a modular platform. In a non-limiting embodiment, methods, systems and platforms herein can consist of modules that can be arranged in any order to create a truly customized platform. If a client has internal capability to address certain solution areas, they can still be able to utilize the methods, systems and platforms herein utilizing only the functionality they need to address HIPAA compliance.

Even though a client can arrange the modules in any order, in an embodiment the system can initiate HIPAA Compliance programs with a Risk Assessment. Once that is completed Business Associates Agreements can be evaluated followed by implementing a Security Management program. In embodiments, order for the remaining areas can be as follows:

Policy Development

Workforce Management

Workforce Training/Awareness

Privacy Documents

Uses and Disclosures

Contingency/Disaster Planning

Breach Assessment and Resolution

Security Incident Procedures

It will be appreciated that the database can contain multiple tables, each with multiple columns/attributes and multiple rows/tuples. Further, multiple schemas can be constructed in order to carry out the functionalities herein, with identical, similar or non-similar features.

Task Score

Tasks are further subdivided into action steps in a separate table (ActionSteps) linked by the TasksID 1321 key. Data from the interfaces regarding each completed activity can be stored in an ActionStep table 1330 to enable reminders to be generated from this table and to determine the percent completion of each task. The percent completion of each task can be added and divided by the number of action steps to determine the task completion score for a solution area. For each task in the i-th solution area, average score for a j-th task can be calculated (Equation 1):

T(i,j)=Σₖ₌₁^{TS(i,j)}AS(i,j,k)/TS(i,j) (1)

Where

T(i,j) is the average task score for the i-th area and j-th task

AS(i,j,k) is the k-th action item value (1=completed and 0=not completed) for i-th area, j-th task.

TS(I,j) is the total number of steps in an i-th area and j-th task.

For example, in the list below are 12 Action Steps that can be completed for security management:

1. Identify needed policies/procedures

2. Draft/Revise Policies and procedures

3. Review policies/procedures

4. Revise drafts

5. Approve drafts and finalize

6. Identify employees using policies/procedures

7. Communicate new/revised policies/procedures to employees

8. Train appropriate employees on new policies/procedures

9. Post policies/procedures

10. Record Creation/revision Date

11. Yearly review of BAAs/Eas

This client has completed the first 6 steps. The completed steps can be scored as 1 each and the remaining 5 incomplete steps 0 each. Therefore the client has a total score of 6. This score can be divided by the total number of steps (11) to get the average −6/11=0.55.

So the task score for this task is 0.55.

Solution Area Score.

The completion percentage for all the individual tasks for a Solution Area can be determined and an Area completion percentage score can be calculated for each solution area as follows:

For each area, the average score for the i-th solution area can be calculated as (Equation 2):

A(i)=Σⱼ₌₁^{TT(i)}WT(i,j)*T(i,j)/TT(i) (2)

Where

A(i) is the average area score for the i-th area

T(i,j) is the average task score for the i-th area and j-th task

TT(i) is the total number of tasks in an i-th area

WT(i,j) can reflect weighting for each task in i-th area and j-th task. Initially all weights can be equal and can be assigned a value of 1. As methods, systems and platforms herein obtain time depended data from the same organization and the aggregate data from similar organizations, these weights can be updated.

For example, in the list below are 16 Tasks that can be completed for security management, specifically developing security assessment policies:

1. Develop Security Assessment Policies

2. Develop Audit/Access Review Policies

3. Maintain Documentation of Assessments/Incidents/Reviews

4. Regularly evaluated security assessments

5. Adding/Deleting Users

6. Access and Termination

7. Develop Policies for ePHI Access

8. Isolate Healthcare Clearinghouse Functions

9. Evaluate Existing Security Measures Related to Access Controls

10. Educate on Policies and procedures for systems protection

11. Develop Standards and Measurements for Reviewing All Standards and Implementation Specifications of the Security Rule

12. Conduct Periodic Evaluations

13. Document Results

14. Repeat Evaluations Periodically

15. Maintain Maintenance Records

16. Workstation Mapping

The system has already calculated the security assessment Policies task score as 0.55 in the preceding Task Score example. Using the same process methods, systems and platforms herein can calculate all of the above Task Scores. Once calculated according to methods, systems and platforms herein the system can sum them and divide by the number of tasks (16).

I.e.,0.55+0.85+0.25+0.25+0.45+0.91+0.67+0.82+0.34+0.45+0.00+0.00+0.10+0.00+0.00+0.00=5.64/16=0.35

Therefore the Security Management Solution Area has a score of 0.35

As methods, systems and platforms herein gain more data around each task a weighting of how important that task is relative to achieving HIPAA compliance can be developed. Methods, systems and platforms herein then can apply a weighting factor to adjust the contribution of each task and relative importance.

Weighted Example

Assuming it's extremely valuable to have Security Assessment Policies methods, systems and platforms herein could assign a weighting value of 1.50 to that task. Methods, systems and platforms herein also determined that Establishing Clearing House Functions have less value so methods, systems and platforms herein could weight that as 0.20. Including these weighting factors in equation methods, systems and platforms herein would recalculate a new value:

0.55(1.50)+0.85+0.25+0.25+0.45+0.91+0.67+0.82(0.20)+0.34+0.45+0.00+0.00+0.10+0.00+0.00+0.00=5.2 59/16=0.33

This can more accurately reflect the true contribution of each task.

HIPAA Posture Score

All the Solution Area scores can be averaged to calculate a HIPAA Posture score as summarized below (Equation 3):

Posture Score (PS)=Σᵢ₌₁^{TA}WA(i)*A(i)/TA (3)

Where

PS is the HIPAA Posture Score

A(i) is the average area score for the i-th area

TA is the total number of areas (currently there are 12 areas)

WA(i) is can reflect weighting for each i-th area. Initially all weights can be equal and can be assigned a value of 1. As methods, systems and platforms herein obtain time depended data from the same organization and the aggregate data from similar organizations, these weights can be updated.

For example, in the list below are 12 Solution Areas that can comprise the HIPAA posture Score:

Solution Area

1. Policy Development

2. Business Associate Agreements

3. Risk Assessment and Documentation

4. Security Management

5. Privacy Documents

6. Workforce Management

7. Workforce Training/Awareness

8. Uses and Disclosures

9. Security Incident Procedures

10. Breach Assessment and Resolution

11. Contingency/Disaster Planning

12. Attestation

The system has calculated the unweighted Security Management Area score as 0.35 in the preceding Solution Area Score example. Using the same process methods, systems and platforms herein can calculate all of the above Solution Area Scores. Once calculated they can be summed and divided by the number of Solution Areas (11). 0.73+0.95+0.42+0.35+0.95+0.61+0.67+0.87+0.45+0.81+0.00=6.81/11=0.62. Therefore the HIPAA Posture Score is 0.62.

Weighted Example.

Assuming it's extremely valuable to have Policy Development, Business Associates Agreements and Security Management methods, systems and platforms herein could assign a weighting values of 1.50, 1.34, 1.46 respectively. Methods, systems and platforms herein also determined that Uses and Disclosures have less value and so a weight can be given as 0.60. Including these weighting factors in equation methods, systems and platforms herein could recalculate a new value:

0.73(1.50)+0.95(1.34)+0.42+0.33(1.46)+0.95+0.61+0.67+0.87(0.60)+0.45+0.81+0.00=7.28/11=0.66

Once again the accuracy of the score would increase based on the weighting factor.

The database can be updated using the individual action step for each task in a given solution area with the average task values (T(i,j)) and equation (1). Using these average task values for a given solution area and the above equation (2), the average area scores (A(i)) can be updated in the database. In addition, the final HIPAA score can be calculated and updated in the database using equation (3) above.

It will be understood that the foregoing parameters can be understood as a sequence of 1 to N parameters. For example, where N=11, there can be 1 to 11 tasks, and so on. In addition, a parameter is understood broadly, and can mean a variable, activity, function, step, measure, or the like that can be distinguished as a meaningful aspect of information the health-care compliance environment.

User Interface Mechanisms, Functionalities and Analytics Displays

It will be appreciated that a user interface in accord with teachings herein can employ colors and other display features in order to provide enhanced functionality. The user interfaces, such as but not limited to dashboards and other graphs and added display screens, can use different colors, and graphical and symbolic mechanisms to signify different meanings.

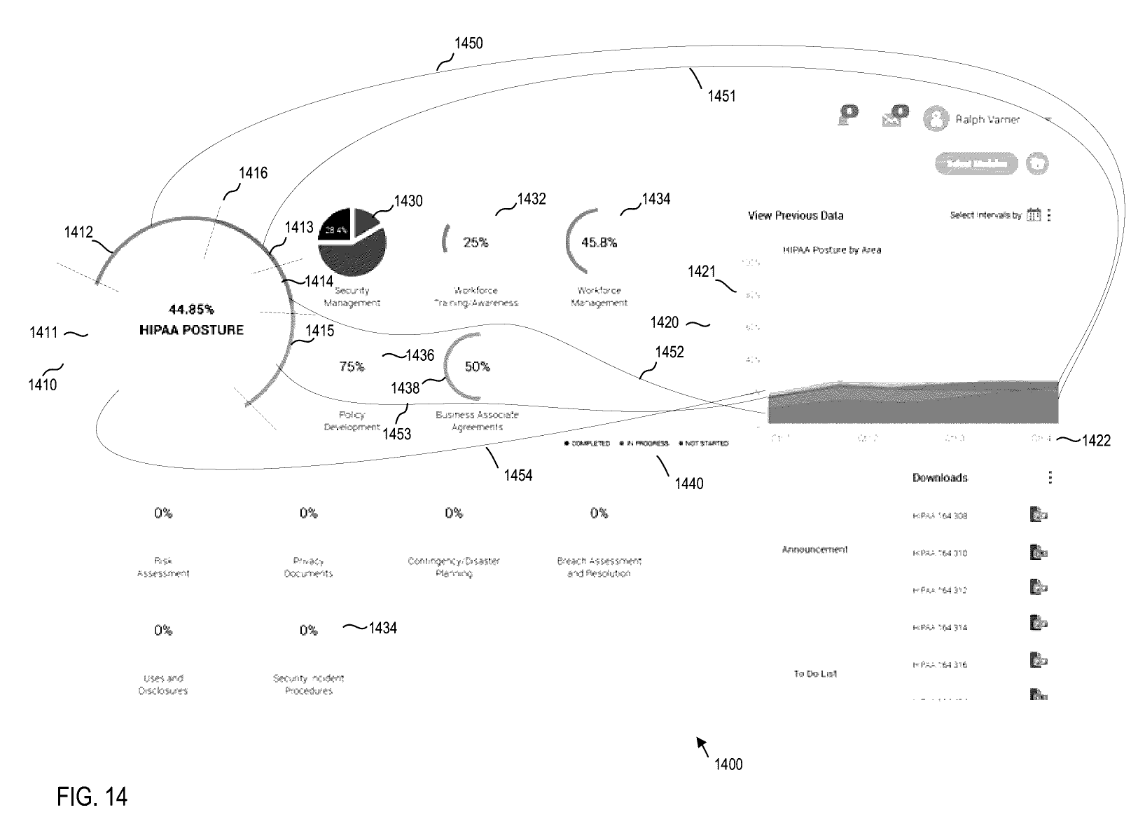

An example User Interface (UI) 1400 can be seen in FIG. 14.

A HIPAA Posture Score can be seen at progress wheel 1410. The system has calculated that the score is 44.85%. Areas can be assigned a color. For example,

Workforce Training/Awareness can be assigned dark blue, reflected on the progress wheel 1413 and individual area wheel 1432, and in a chart 1420 that can show progress overtime. Workforce management can be assigned light green, reflected on the progress wheel 1413 and individual area wheel 1434, and in a chart 1420 that can show progress over time. reflected on the progress wheel 1413 and individual area wheel 1432, and in a chart 1420 that can show progress over time. Policy Development can be assigned light blue reflected on the progress wheel 1411 and individual area wheel 1436, and in a chart 1420 that can show progress over time. Business Associate Agreements can be assigned light green, reflected on the progress wheel 1415 and individual area wheel 1438, and in a chart 1420 that can show progress over time.

Progress over time can be seen in that quarterly increments can reflect different percent completion 1421 per time increment 1422, here quarterly. The color scheme above can be used, which can cross-reference 1450, 1451, 1452, 1453, 1454 the colors in the progress wheel 1410.

Individual progress wheels such as 1434 can be grey to represent 0% progress.

Added color schemes can indicate status 1440. For example, green can indicate completed, yellow in progress, and red not started.

A dashed line 1416 on progress wheel 1410 is for illustrative purposes to demarcate boundaries between colors. These lines may not be on the actual UI.

The User Interface 1400 disclosed herein is a non-limiting example of the type of UI or “dashboard” that can be utilized. Added colors or variants thereof, symbols, graphical representations, and other elements can be used.

Prototype Business Associates Agreement Process

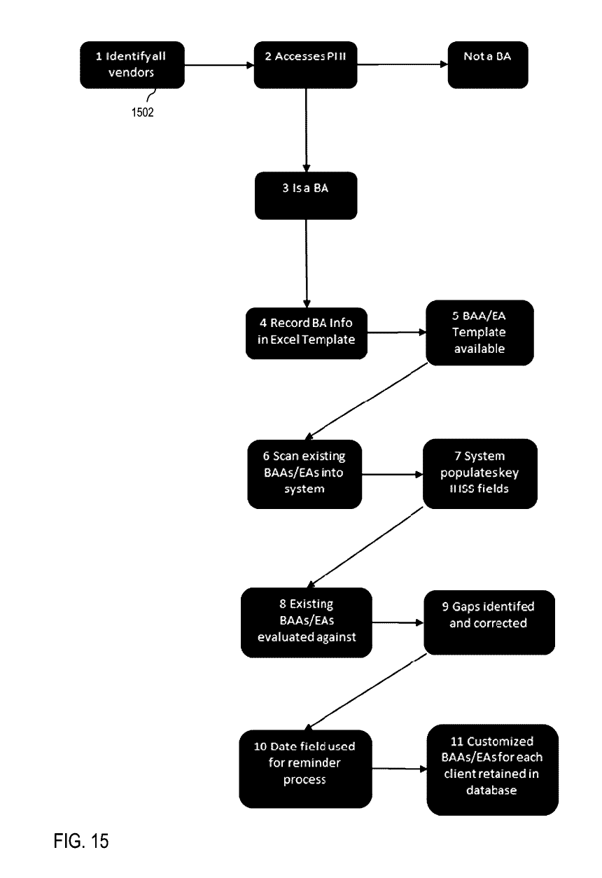

One significant challenge of a Covered Entity (CE) is identifying, developing, implementing and maintaining current HIPAA compliant Business Associate Agreements (BAAs) and Engagement Agreements (EAs). FIG. 15 is an example of how the system can identify and load into the system BAAs and EAs:

1. It is determined whether a CE enterprise can identify all vendors and affiliates that provide service to them 1502.

2. It is determined whether the vendor has any access to Protected Health Information (PHI).

3. All vendors with access to PHI can be deemed business associate's (BAs).

4. The company name, address, contact name, contact phone, contact email can be entered for all BAs (if CE already has the data electronically it can be imported via a customized interface).

5. Methods, systems and platforms herein can contain template BAA and EA structured to meet HIPAA requirements.

6. Existing contracts (BAAs and EAs) can be scanned into methods, systems and platforms herein as Word documents or other text-based documents.

7. Date field in methods, systems and platforms herein can be populated from document attributes or manually if attributes are not available.

8. Existing contracts can be electronically compared to templates to evaluate content relative to requirements (e.g., topography of the data journey, device inventory, IP address history, and security, privacy, access, consent, and permission base use of data, disclosures)

9. Any gaps can be identified to enable quick revision to meet requirements.

10. The date field can initiate a reminder process that can track all dates and provide a reminder in advance of expiration of the current contract (time of advance notice can be set within an option field in the database).

11. Customized BAAs and EAs can be maintained in the database for each individual BA.

Below is an example review process for BAAs and EAs.

1. All BAAs and EAs can be approved through a standard process.

2. Each organization can identify the appropriate roles and timelines to participate in the review process and the order in which they participate.

3. Any BAA or EA that deviates from the template version can be automatically submitted into the review process.

4. Once submitted to the review process each document can be electronically assigned to the appropriate reviewer. The project manager can know exactly where the review stands at any point in time and can be informed when to initiate reminders to manage the review process.

5. As each reviewer approves the document can be forwarded to the next reviewer until the process is completed.

6. Once a document is approved within the CE, the contracting office can collaborate with the BA to finalize a mutually acceptable version

7. Both parties can sign this version and each can retain appropriate copies. The final reviewed document can be stored online with the approval date.

8. The approved document can be sent to the project manager to post in the appropriate place, communicated to the employees and to initiate any training required for employees.

9. Reminders for the need to reapprove the document can be automatically generated and sent to the project manager to initiate the review process again.

The Business Associate Agreements screen can display both required Key Activities to be addressed with the percentage completed, in progress and pending clearly shown. Typically, a hospital can have 300 BAAs and some, even perhaps many, are not in compliance with the regulations nor precise to reflect around the actual integration of the workflow by each party as required by the Omnibus statutes. Furthermore, the service or the engagement agreements may lack defining the critical vulnerabilities since most enterprises have not conducted the topography and the journey of the PHI. It is estimated that each patient encounter can result in approximately 150 points of review. Maintaining the necessary vigilance and oversight of this journey can be lacking.

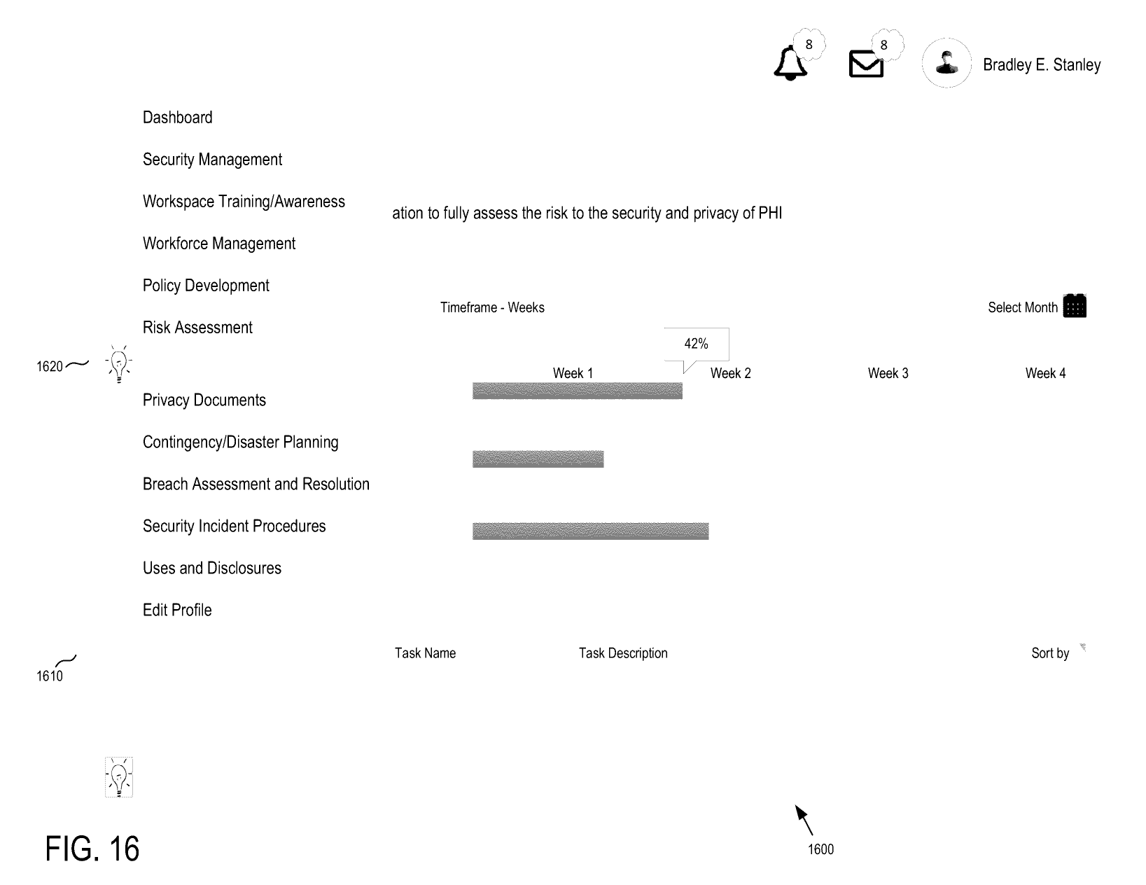

FIG. 16 is an example screen 1600 showing a menu 1610 at left of options and operations that a user can select. In this example the user can select Business Associate Agreements 1620.

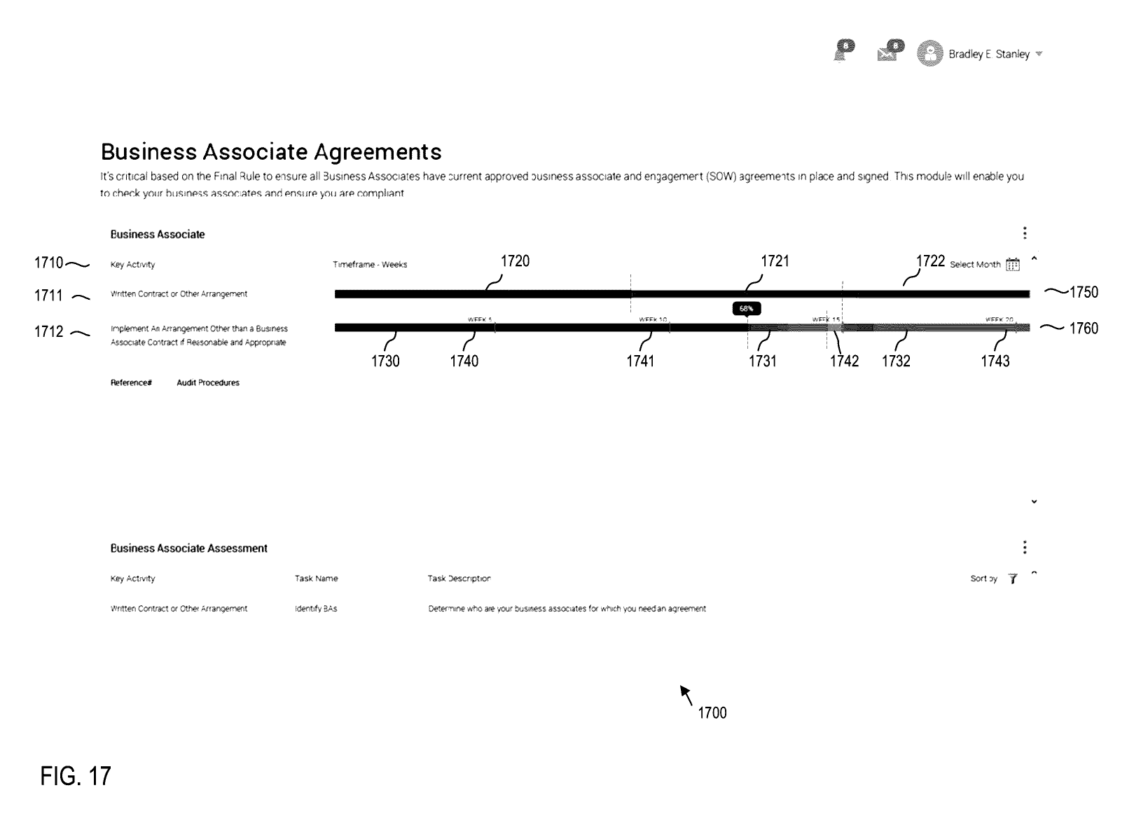

FIG. 17 shows a Business Associates Agreement screen 1700. Displayed is a Key Activity. Two progress bars are shown depicting progress in complying with relevant operations 1711, 1712. Each operation can be associated with a timeframe 1750, 1760, and progress charted thereby. Here operation 1711 can be associated with the colors green 1720, 1730 yellow 1721, 1731 and red 1722, 1732 to indicate percent completion. Colors can be assigned as desired.

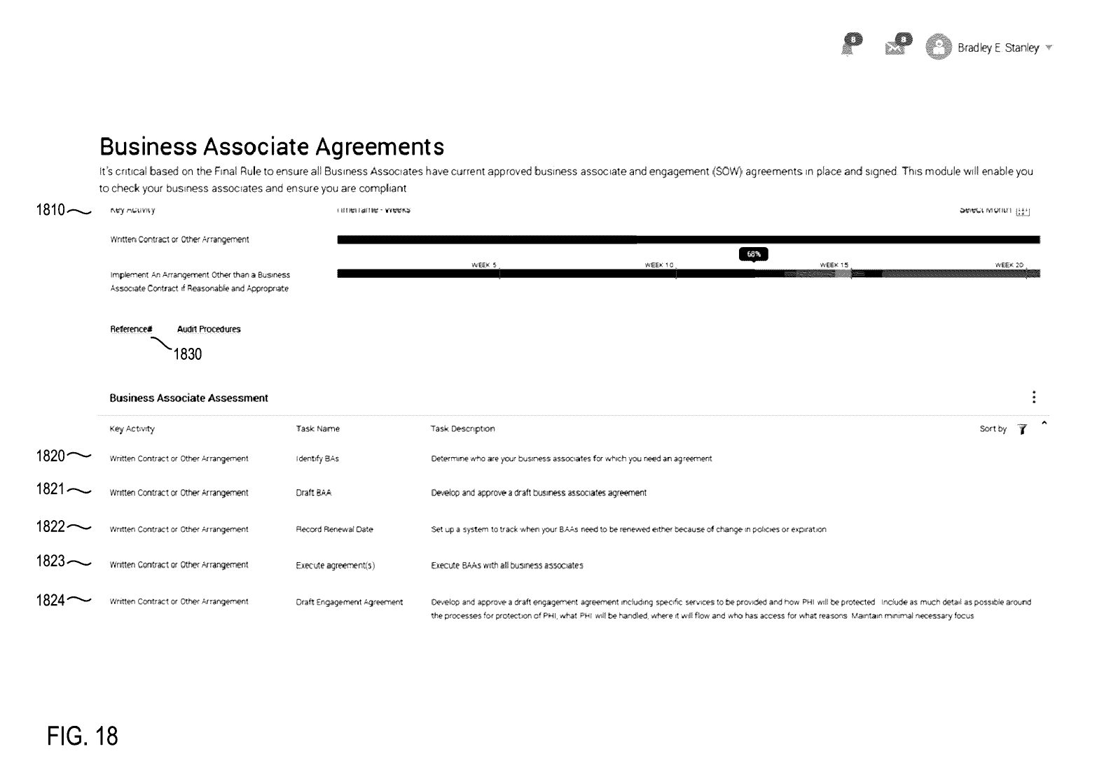

As seen for example in FIG. 18, selecting the Key Activity 1810 at the top of the screen (or in another suitable location) displays specific tasks 1820, 1821, 1822, 1823, 1824 associated with that Activity so each individual tasks can be completed.

The role based functionality can limit the key activities and tasks displayed based on the role of the individual logging into the system. This functionality streamlines the workflow for all employees in the covered entity.

For example, activity and tasks associated with the Business Associate Agreements may be assigned to contracting so it's possible an individual with an HR role would never see this information.

Selecting Reference # 1830 on the main screen opens a screen to display the specific sections of the Final Rule that are associated with this Activity. This serves to educate employees on the actual Final Rule and enhance their appreciation for why the Activity needs to be completed helping to establish a culture of compliance.

By relating tables in the manner herein, each protocol measure is associated with only one solution area but can be associated with many tasks. In addition, each task can have many action steps. An example is shown below:

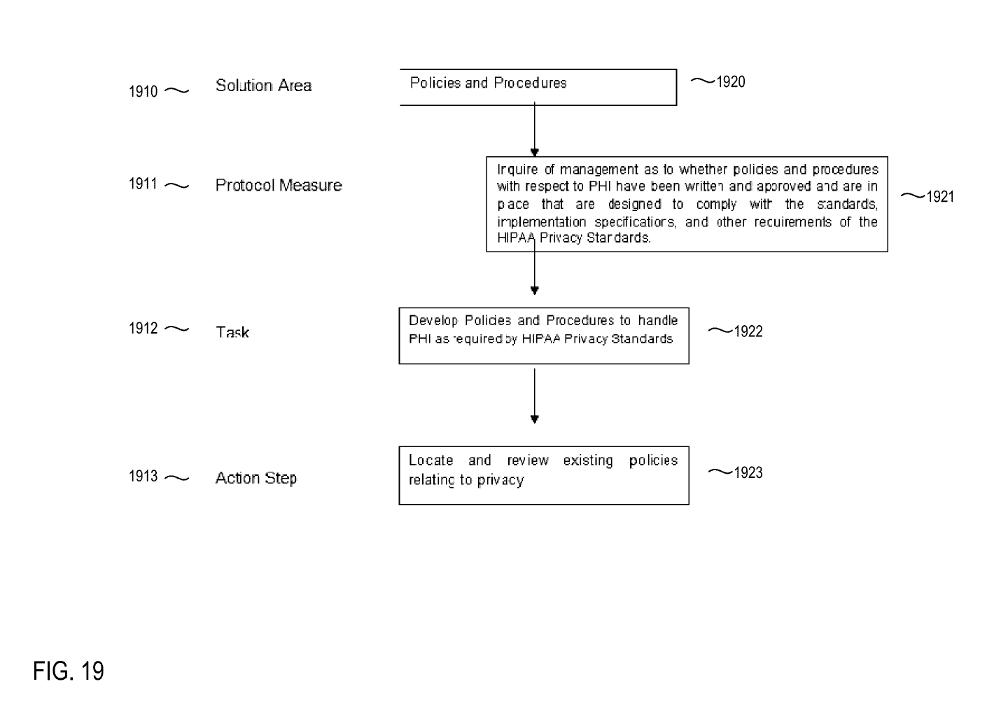

FIG. 19 shows an example relationship of Solution Area 1910, Protocol Measure 1911, Task 1912, and Action Step 1913, and their respective contents and actions associated therewith 1920, 1921, 1922, 1923. It will be understood that the relationships herein can be hierarchical, each conceptualized at a different level. Thus, levels 1910, 1911, 1912, 1913 are relatable to each other in a 1:1 and 1:many relationship, the many being two or more added levels. Additional levels and hierarchy relationships can and should be understood to exist based on numerous disclosures herein. It will be appreciated that each of the above can be represented, in logical and physical fashion, in data structures stored in memory.

Business Associates Agreement Organization and Tasks

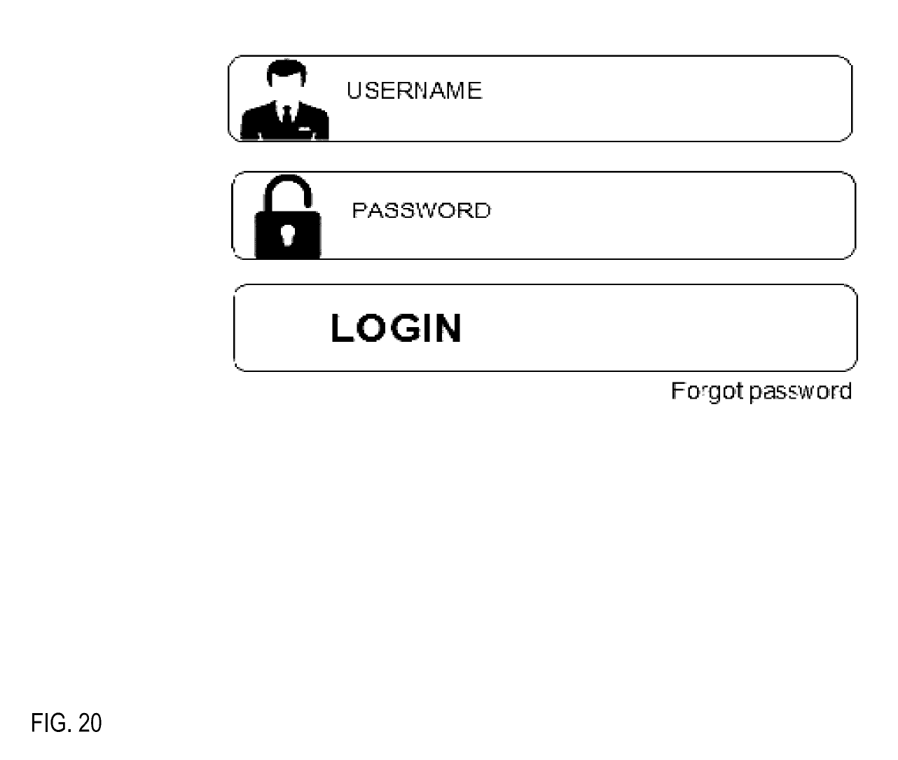

FIG. 20 shows an example login screen. A user role can be identified from a database depending on the identity of the individual logged in. The role can drive Tasks each individual can see at the tasks level. Tasks can be assigned by role. A Project Manager (Super User) can be able to redirect tasks, and see some portion or all of tasks and their assignment.

Accordingly, it will be appreciated that the identity of the individual can drive the range of options displayed, operations available, and activities that can be performed.

Scenarios

In order to further demonstrate the value and utility of functional roles (CEs and BAs) and individual roles, some common scenarios are described in the following paragraphs.

Chief Executive Officer at a Covered Entity and/or Business Associate

Although the CEO at a Health Plan has the ultimate responsibility for complying with HIPAA, he/she is not typically involved in the day to day activities. He/she can know the current HIPAA Posture Score and understand what areas need to improve to improve the score. As such, the CEO can be presented with only the high level dashboard view to look up the HIPAA Posture score in real-time and the specific score for each of the 12 areas. This enables the CEO to identify which Senior Manager needs to be further questioned and prompted to improve such person's area of responsibility.

Chief Compliance Officer (CCO) and/or Chief Security Officer (CSO)

The CCO has a greater day to day responsibility for HIPAA compliance than the CEO and therefore needs to be better informed of detail than the CEO. As such the CCO can not only have the same dashboard views as the CEO with the ability to see each of the individual Posture scores, but can also be able to see the scores for each of the individual protocol measures. By viewing the individual protocol measures the CCO can know exactly what departments have the lowest and highest scores in their areas of responsibility to further investigate and support additional resources if needed by department.

Project Manager (PM)

In order to achieve HIPAA Compliance various individuals within various departments across large organizations can work independently completing multiple tasks to identify, plan, develop and implement a variety of policies, procedures, plans, monitoring etc.

In order to maintain some order a project manager can be assigned. Without methods, systems and platforms herein, monitoring these individuals and tasks is very time consuming, expensive and challenging. To greatly simplify the process and enable a near real-time reporting of a HIPAA Posture Score a PM view can be provided. This view provides the project manager with the standard dashboards that are available to both the CEO and CCO along with the capability to drill down to each individual action step. At any point in time, the PM can easily and quickly see what areas are negligent in performing the required tasks and what specific action steps for each task need to be addressed. Knowing this information the PM can work with Senior Management to identify areas of risk, the severity of the risk, what resources may be needed to address the risk and when intervention is needed. This critical capability is essential for any organization wanting to adhere to HIPAA standards and would be nearly impossible without methods, systems and platforms herein. The PM can also know exactly who is responsible for each task and can be able to use the built in communication platform to remind that person of expected completion date.

Contracting Manager

The contracting manager is an example of an individual that has a specific role within the overall HIPAA Compliance program. Providing this individual with information on the multitude of tasks and action steps relating to Workforce Management, Policy and Procedure Development, Risk Assessment or Uses/Disclosures may be not only unnecessary but potentially confusing and distracting. This could increase the costs by requiring the individual to go through multiple steps and documents to identify his/her specific directions.

Using methods, systems and platforms herein the contract manager upon login can be presented with only information concerning the relevant processes. The contracting manager responsible for Business Associate Agreements would be shown the BAA Posture Score as well as any tasks and action steps associated with this area. The CM can see at a glance all the vendors that are handling PHI and know the status of their BAAs. Reminders can be sent to them based on the last approval date. This can all be driven from the document attributes themselves. In other words, a document can be associated with a specific coding so that it can be filtered as appropriate depending on the reader, the desirability for the reader to obtain access to the document, and based on added factors.

There are many roles required to support an organization attempting to meet HIPAA compliance and each of these roles can have their own view based on the measures, tasks and action steps assigned to their role.

Continuous Quality Improvement (CQI)

In addition to defining and producing a HIPAA Posture Score, the methods, systems and platforms herein give each client the ability to continuously improve their adherence to compliance and see their progress as they go.

Methods, systems and platforms herein are designed to have the data available and the score calculated upon entry into the system. When action steps for a task are completed the score is updated to reflect the change in status. Reports defining discrete time periods (to be determined by the client and adjustable as desired) can show the client how each area has progressed during that time period. Accordingly Management, the PM and individuals can be able to see how their actions are improving compliance. This feedback can be a stimulator to further improvement. Managers can be able to see the impact of their daily decisions on HIPAA compliance and be able to change their tactics quickly to help identify the most efficient way to address their compliance issues.

Office of Civil Rights (OCR) Documentation

In the new era of OCR audits, each client has to be prepared to deliver specific documentation requested by the OCR within 2 weeks of the request. The OCR wants only what they request and not additional information. Methods, systems and platforms herein can have a documentation engine that can allow the compilation of the specific documentation requested by OCR from each individual client. Simply selecting the necessary elements from a checklist and hitting print can produce the custom document in minutes. Without this capability, a client would have to drop other activities and assign multiple employees working extra hours to respond in such a short time frame. Not only is this disruptive to the client but fatiguing to the employees and very inefficient.

Meaningful Use

Covered Entities (CEs—Providers and Hospitals) can apply for federal incentive payments for the meaningful implementation of electronic medical records. The ability to receive the funds is based on CEs meeting criteria established by the ONC. This criterion is spelled out in the Meaningful Use measures. Meaningful Use is rolled out in stages of which there are currently 4. In both Stage 1 and Stage 2 there is a specific measure around privacy and security of PHI.

While electronic security is a very important component of HIPAA, it does not completely cover compliance with the law. In addition, complying with HIPAA does not qualify a CE for Meaningful Use.

Provided is a computer Implemented system and method to evaluate HIPAA requirements, generate analyses of gaps, and identify specific tasks and action steps for a client to complete to maximize their compliance with HIPAA.

Using a computer, multiple datasets can be imported/transformed to a common data structure, stored in the cloud and accessed using protocol guided algorithms to produce the analyses. Each individual user can be authorized to access the system based on combination of UserID and Password under the control of a system administrator. Upon entry into the system by an authenticated user, the individual's role in the organization can control access to data and to specific tasks and action steps the individual needs to complete to contribute to maintaining compliance.

Example flows in accord with disclosures herein are now provided.

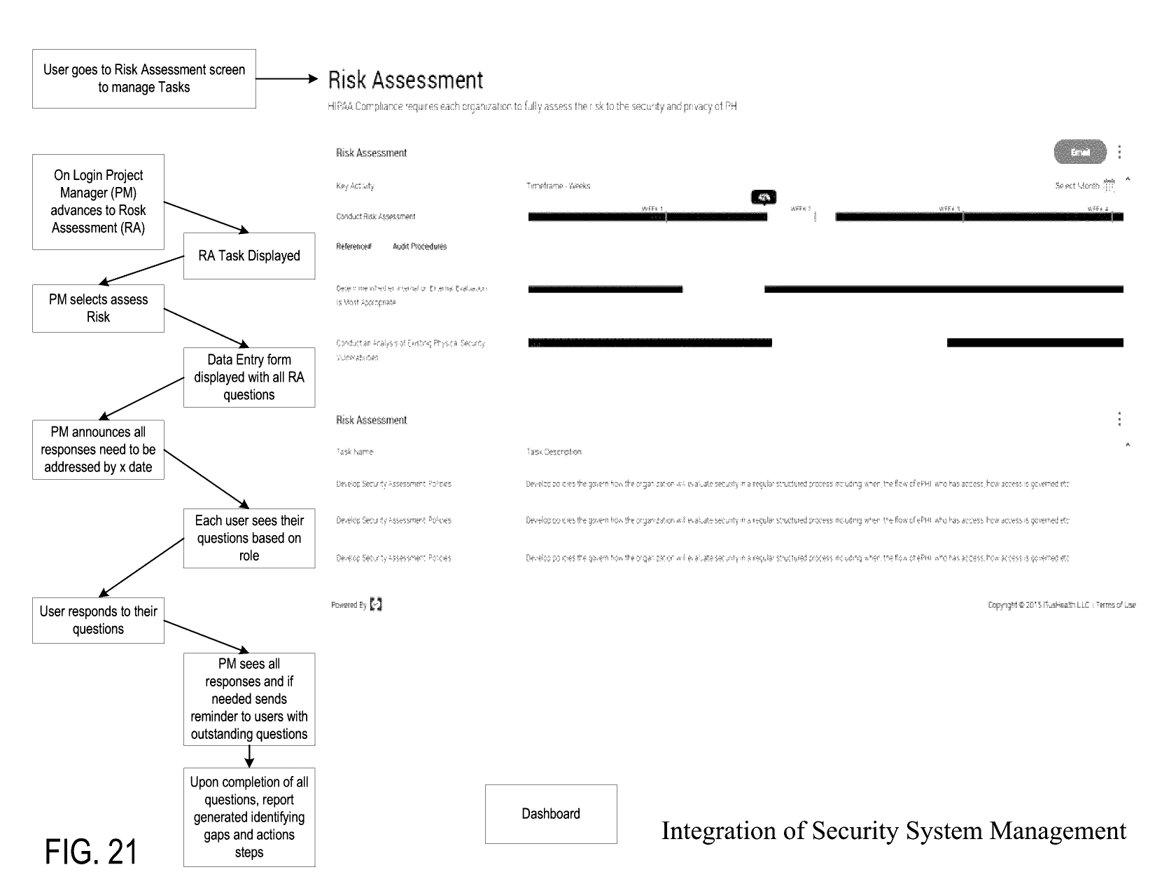

FIG. 21 is an example flow based on when a user accesses a Risk Assessment screen to manage Tasks.

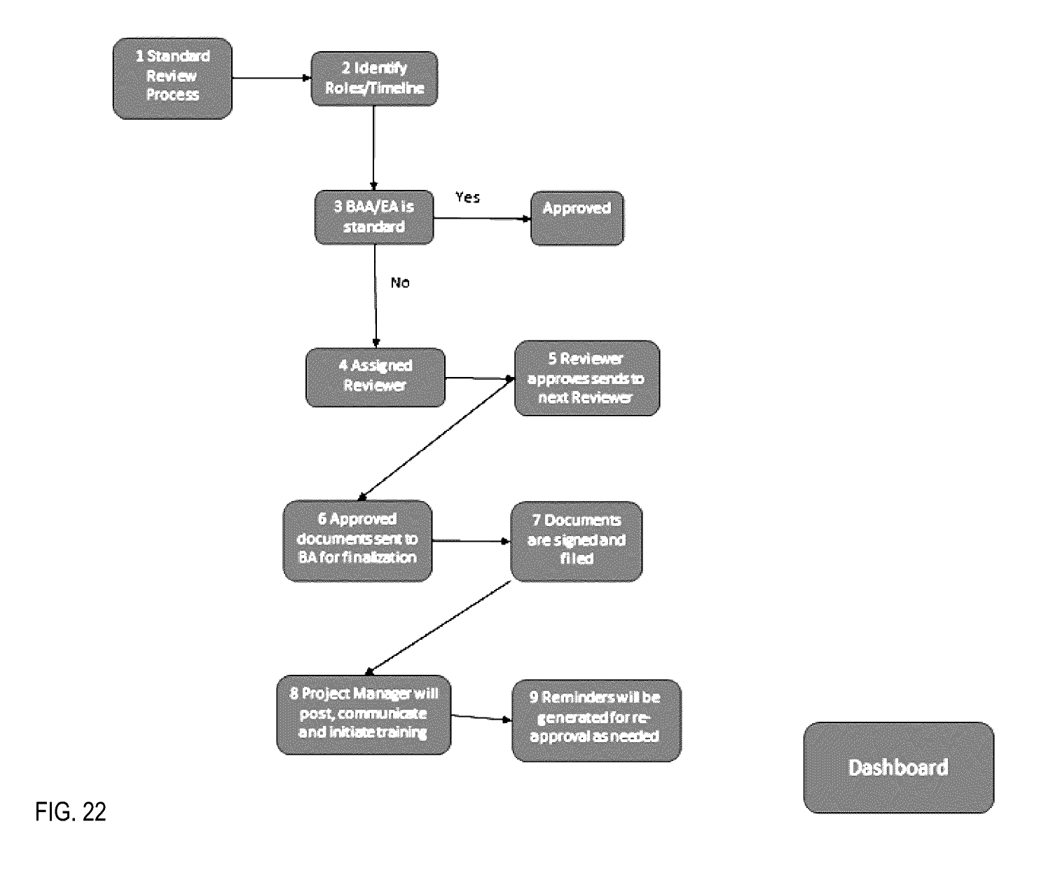

FIG. 22 is an example flow illustrating aspects of the review process and steps associated therewith.

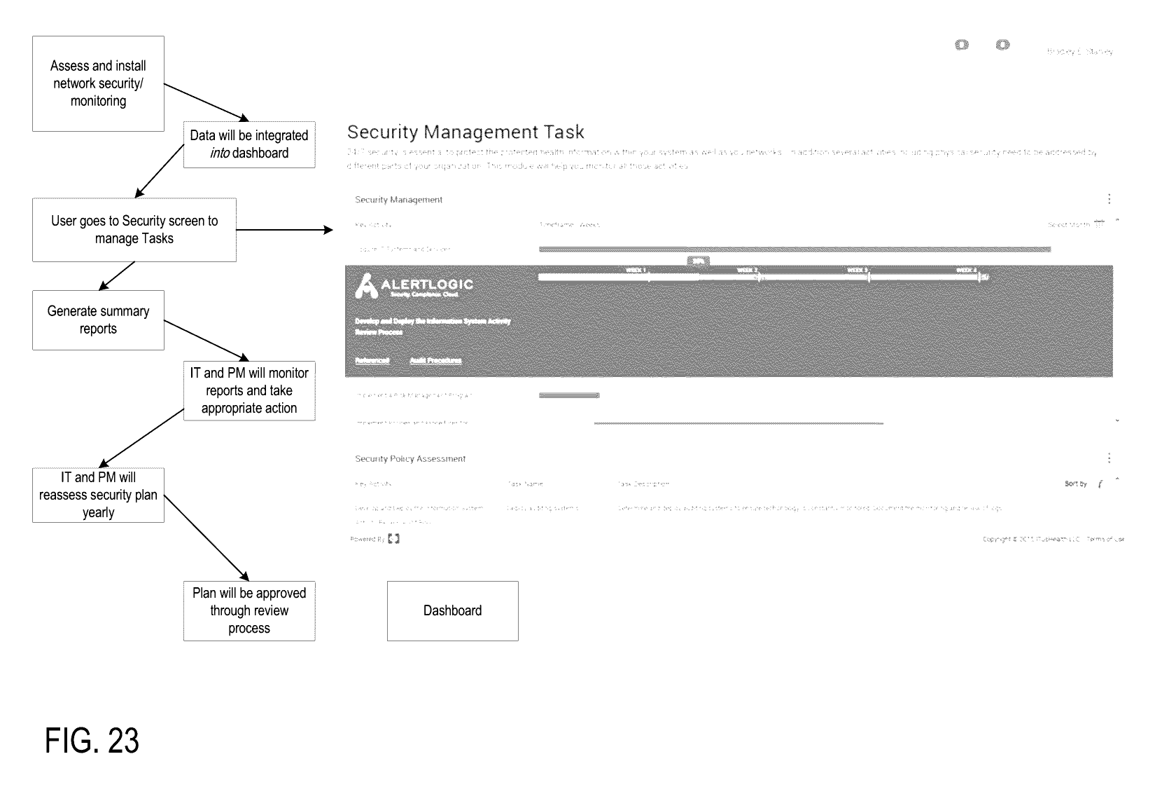

FIG. 23 is an example flow illustrating aspects of security and steps associated therewith.

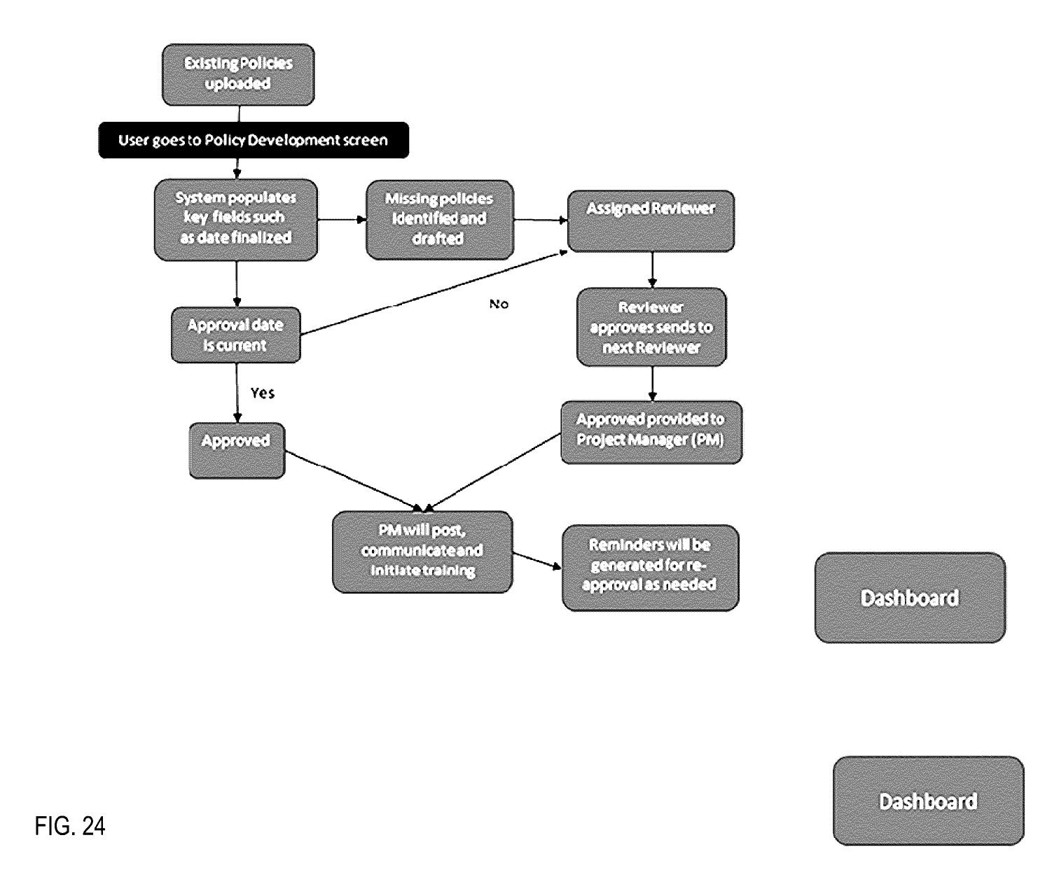

FIG. 24 is an example flow illustrating aspects of upload and steps associated therewith.

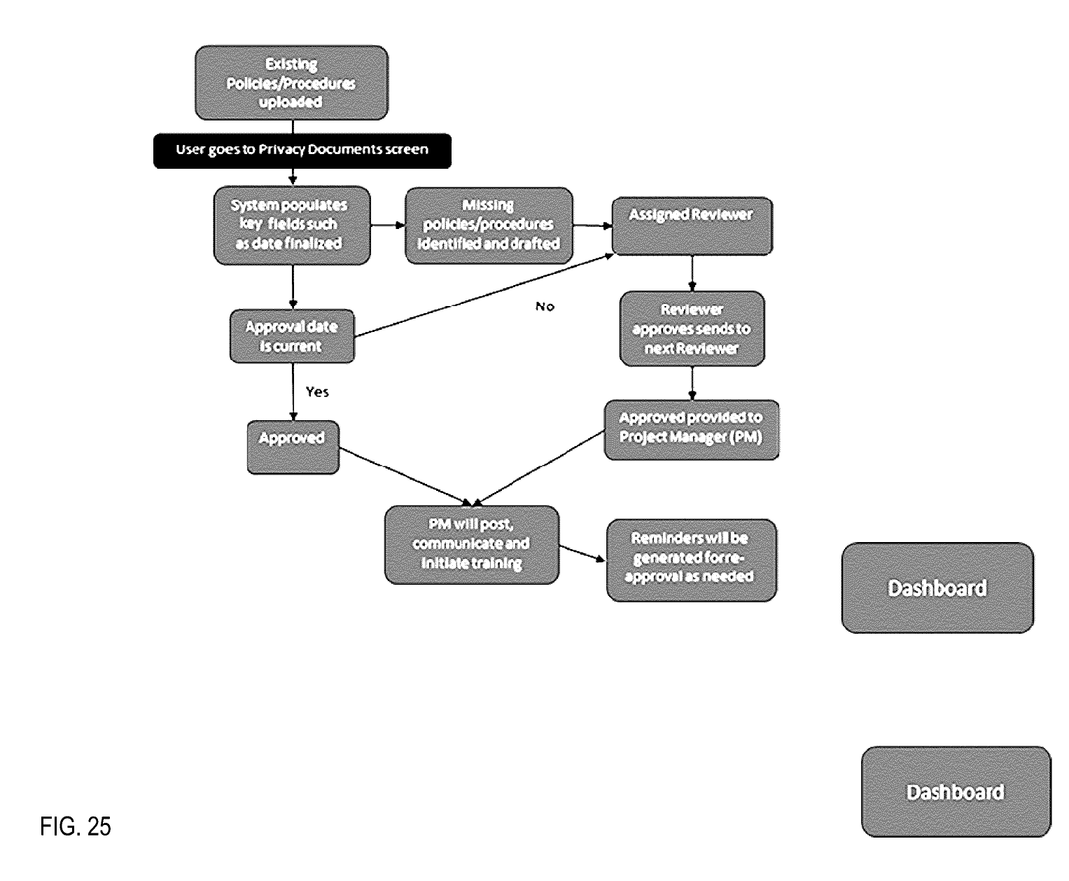

FIG. 25 is an example flow illustrating aspects of upload and steps associated therewith.

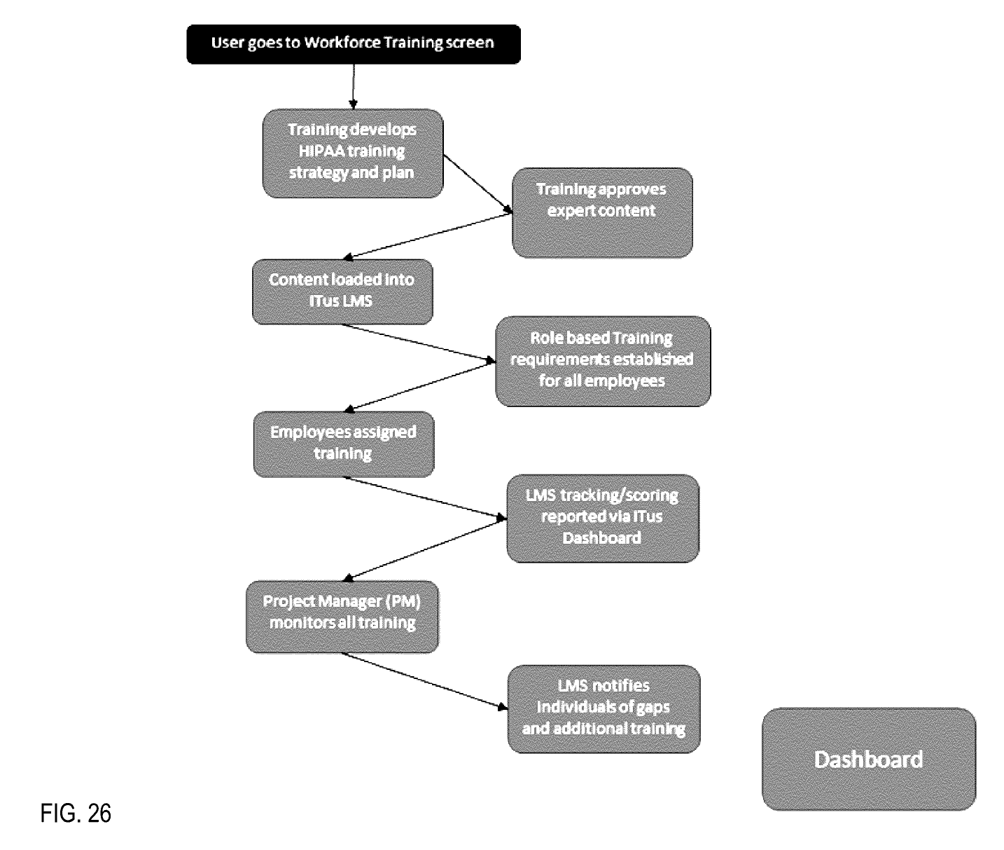

FIG. 26 is an example flow illustrating aspects of workforce training and steps associated therewith.

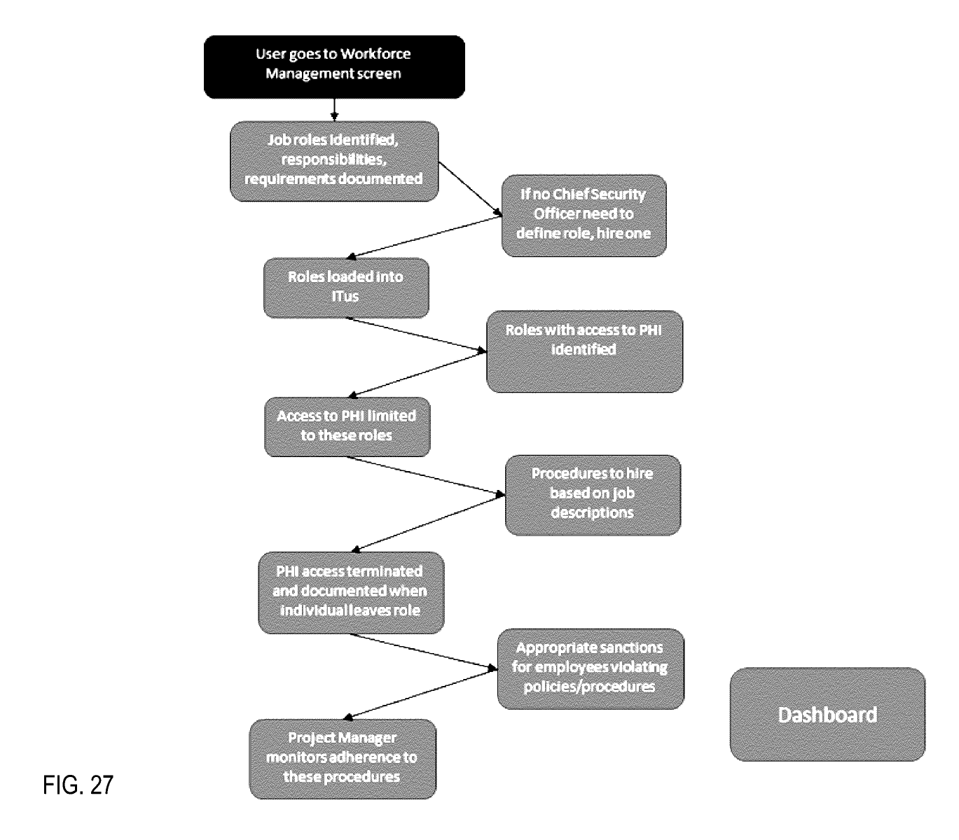

FIG. 27 is an example flow illustrating aspects of workforce training and steps associated therewith.

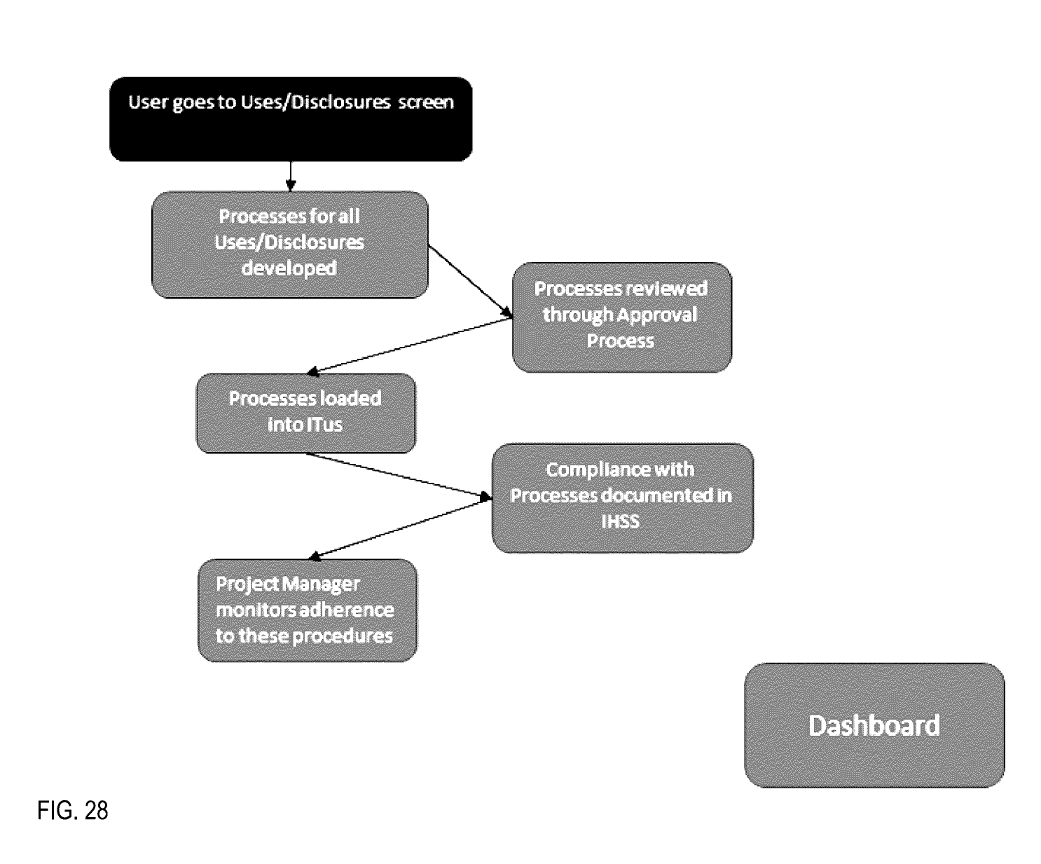

FIG. 28 is an example flow illustrating aspects of uses/disclosures. functionality and steps associated therewith.

Process to establish and apply organizational Risk Tolerance Score (RTS)

A questionnaire can be used to enable senior management of the organization to quantify their risk tolerance. Each question on the questionnaire can be scored on a scale such as a Likert scale of 1-10 with 1 being low tolerance and 10 being high tolerance. In addition each question on the questionnaire can be ranked on a scale of 1 to 5 by senior management according to their belief about the question's level of importance within their organization. A weighted average can be calculated to produce an overall Risk Tolerance Score (RTS).

The overall RTS can be applied universally to each individual risk assessment question by multiplying the product of the likelihood of the risk and risk impact scores by the RTS. This can enable Senior Management to apply a standard RTS across all departments and individuals involved in the risk assessment to enable prioritization of gaps to be addressed.

This standardization is not currently possible as Senior Management cannot weigh in on every risk assessed by the organization and each department/individual would be using their own criteria to determine importance of risk based on their beliefs which leads to variability.

Predictive Analytics

As data continues to accrue data across many organizations, methods, systems and platforms herein can use predictive analytics to determine the most likely gaps that can exist in an organization, the impact of addressing those gaps and to predictively assess degree of compliance with HIPAA based on limited risk assessment.

For each of the solution areas of the HIPAA posture assessment, the data can be collected periodically (monthly or quarterly) to predict the HIPAA Posture for the next few time periods along with HIPAA Posture risk limits using 90% 2-sided confidence intervals. After collecting the data for few time-periods for each of the solution areas, the data can be analyzed using the Bayesian predictive analysis for any future risk of noncompliance. One or more of the following statistical and analysis techniques can be used:

Bayesian predictive analysis

Adaptive regression

Auto regression

Time-series analysis

Non-linear regression

Predictive modeling

Benchmarking and HIPAA Score Model Updating

Since the scoring and gap analyses for each organization can reside on a HIPAA Compliant Secure Cloud server there can be the ability to aggregate data across all organizations. There can be a categorization of each organization based on their structure and line of business to create like organizations. For each organization, a benchmark score sheet can be developed to provide a comparison of their posture score and the gap areas to like organizations. This can provide standardization across the healthcare environment and allow Senior Management to better determine comfort with their approach to HIPAA.

In addition to the Bayesian predictive analysis, the data can be analyzed using the one or more of the following classification techniques to identify the key influencing tasks for the HIPAA posture scores and their risk levels:

Association rules

Factor analysis

Cluster analysis

Discriminant analysis

Non-parametric statistical analysis

Pattern mining (traditional and neural networks)

Non-linear mapping using Neural Networks

Visual data mining

Segmentation analysis

Using one or more of the above techniques, the key influencing tasks and their corresponding weights (WT(i,j) in Equation (2) above, which are assumed to be equal for all the tasks and carry a value of 1 in the base model) can be determined to update the model periodically.

In addition, deidentified aggregate data from all the industry sectors can be analyzed for benchmarking purposes by using one of the above methodologies.

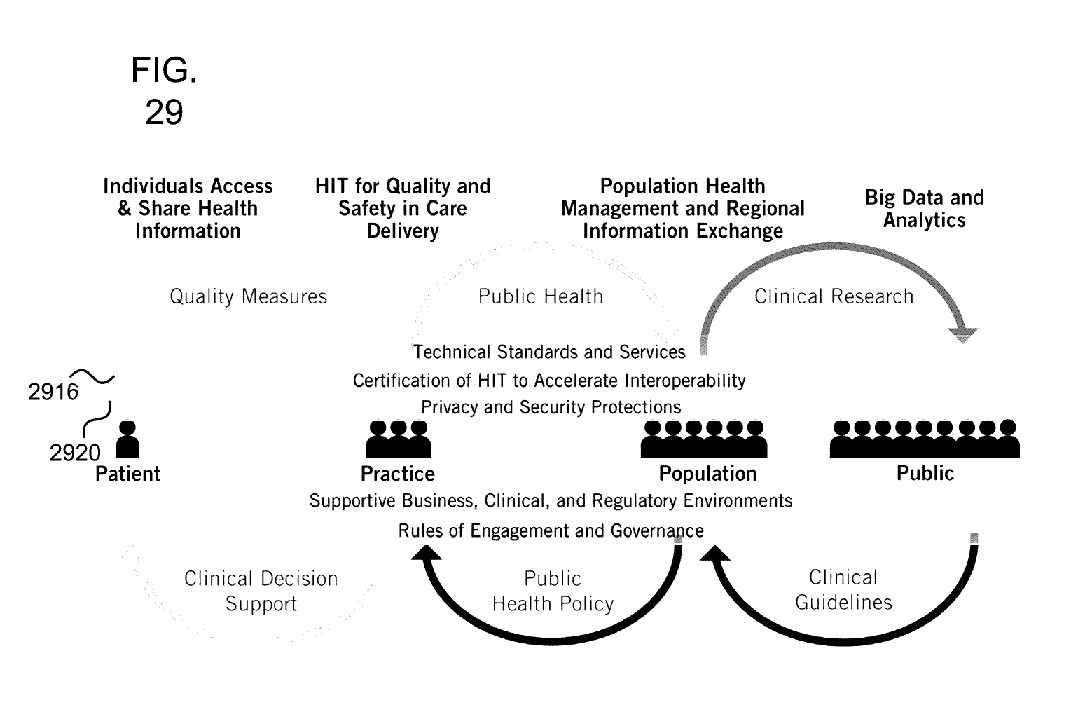

FIG. 29 is an example health IT (HIT) ecosystem roadmap. Among other things, there can be a certification of HIT to accelerate interoperability 2916 of systems in a physical and architectural sense.

Privacy and security protections 2920 are not merely significant but often critical.

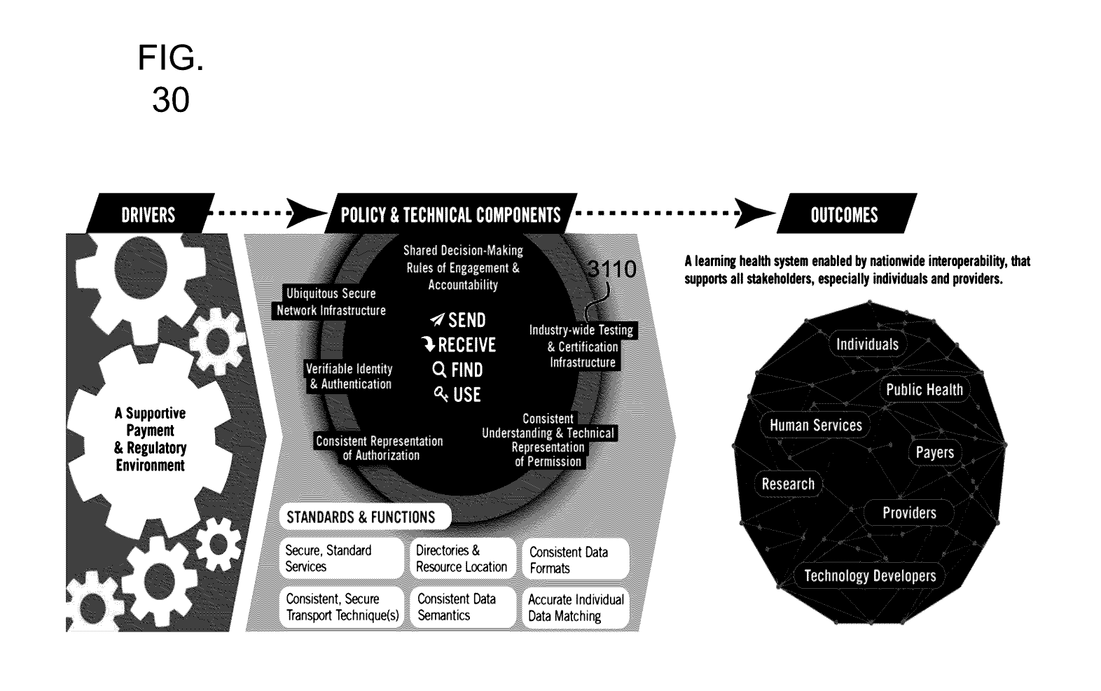

FIG. 30 is an example ONC shared responsibility roadmap, showing alignment with incentives. Drivers 3020, policy and technical components 3030 and outcomes 3040 can be seen.

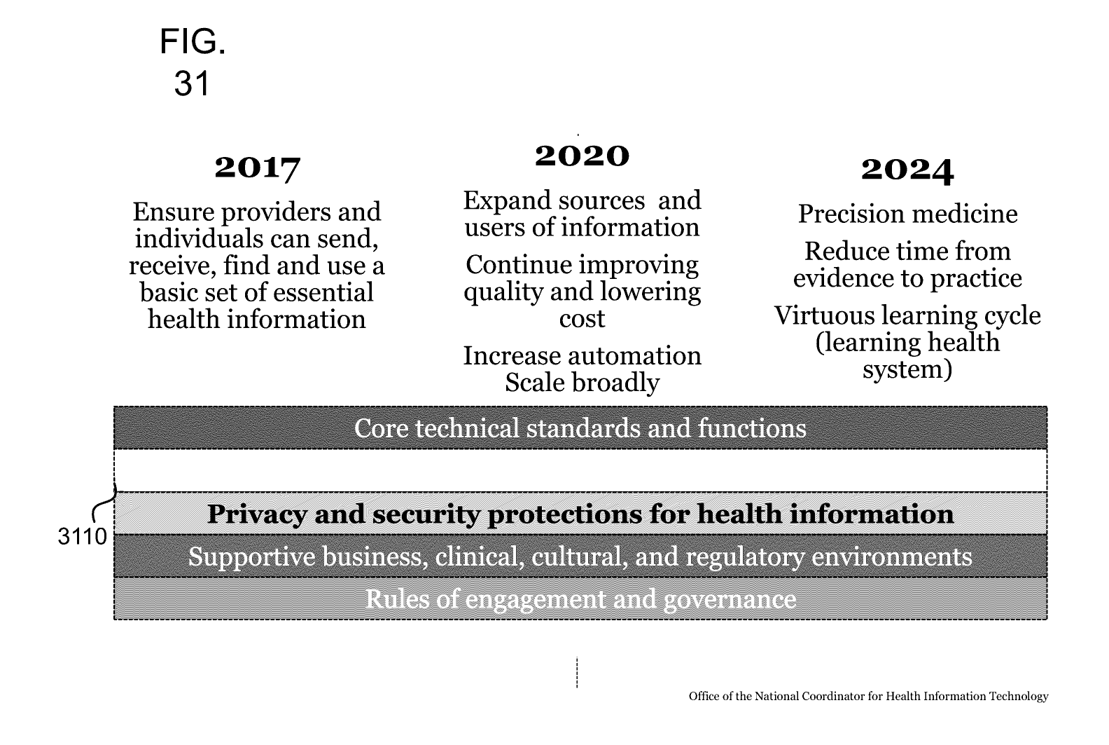

FIG. 31 is an example CMS/Office of National Coordinator (ONC) value-based reimbursement framework. An industry-wide training and certification infrastructure 3110 can be a significant benefit. An added viewpoint is that health-care compliance has not only legal ramifications but financial ones including potential levels of reimbursements.

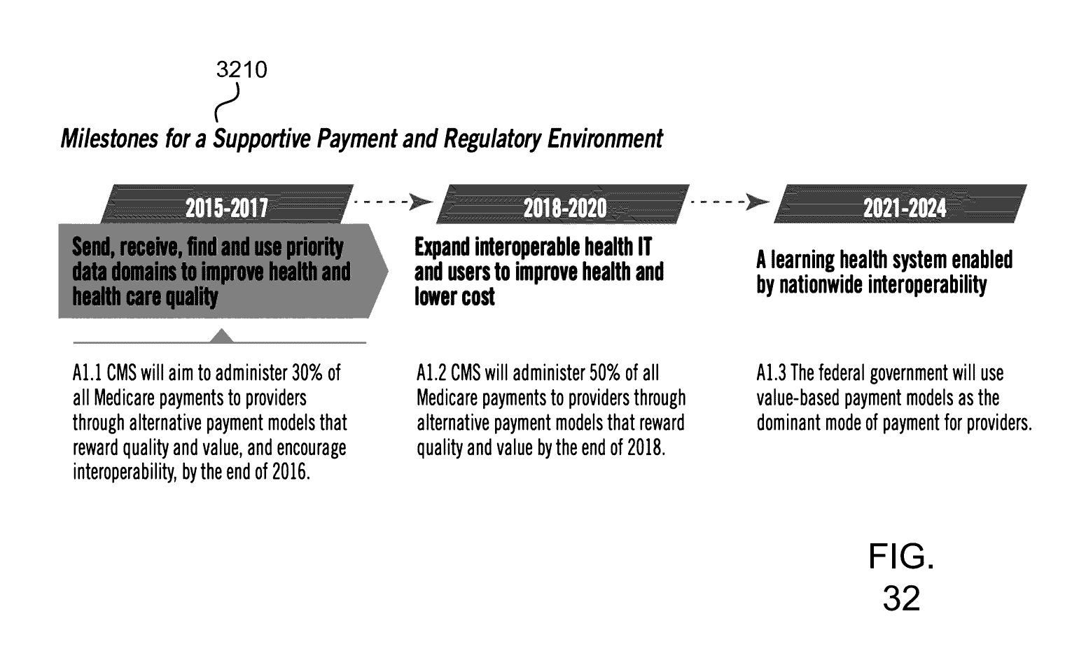

FIG. 32 is an example CMS/ONC incentive alignment. Layers of the framework 3110 are shown. Milestones 3210 representing projected dates are seen. These include several groupings of years 3220, 3230, 3240 and objectives therefor.

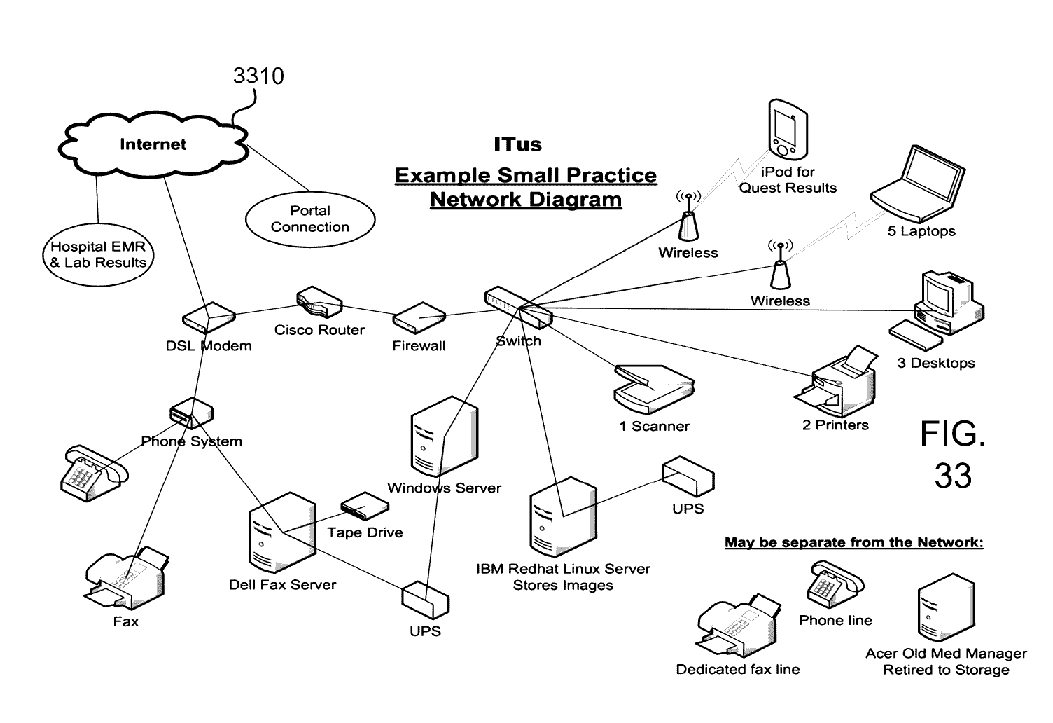

FIG. 33 is an example physician practice showing inventory examples. A network 3310 is shown in operative communication with many devices, each of which can be, via the network 3310, in interoperative communication with each other. It will be appreciated that even in a network of relatively modest scope such as that for a single physician, significant complexity can be seen. For example, if one device is considered insecure, such lack of security can affect many downstream devices.

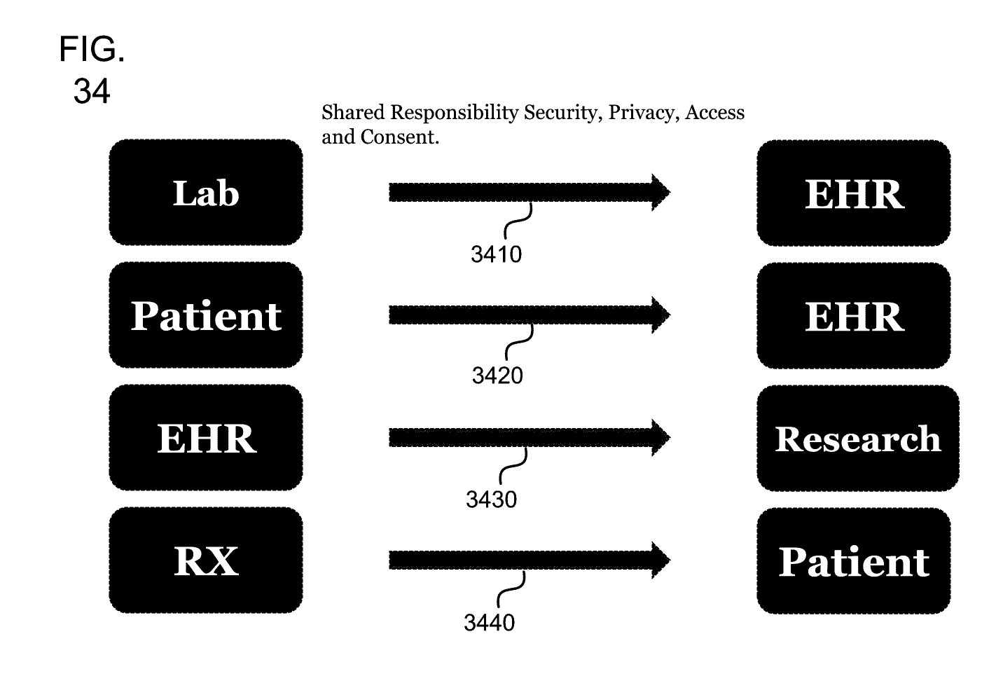

FIG. 34 is an example PHI safeguard ecosystem diagram showing points/nodes. It will be seen that within this ecosystem that a lab can be generate or otherwise be associated with EHR (electronic health records) 3410. Further, patient/HER 3420, EHR/research 3430, and Rx/patient 3440 relationships can be seen.

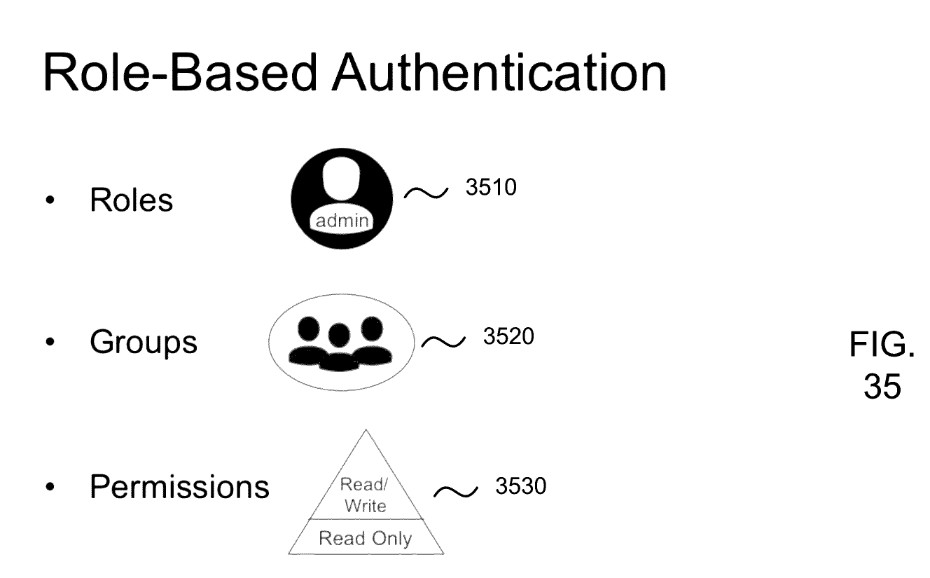

FIG. 35 is an example role-based authentication diagram. Authentication can be accomplished by reference to roles 3510, groups 3520, and permissions 3530.

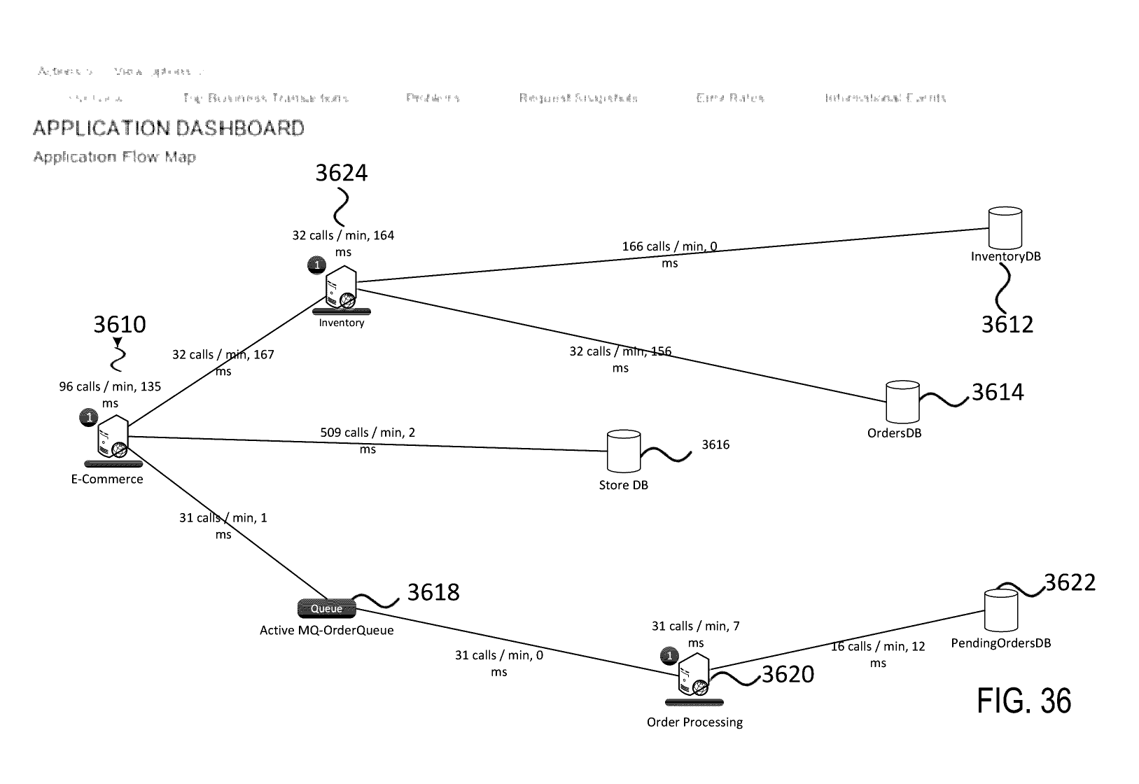

FIG. 36 is an example network topology. Dislcosed are an e-commerce node 3610 that, for example, handles 96 call/s min, with a 135 ms burden. An inventory database 3612 is a node. An orders database 3614 is another node. A store database 3616 is another node. There is an order queue node 3618 and order processing node 3620 between pending orders node 3622 and e-commerce node 3610. Intermediate nodes 3624 and node 3618 (inventory) are bidirectional nodes in this topology and as such risks thereto can affect the topology in ways different from the other nodes. It will be appreciated that the other nodes are connected to added networks (not shown), so a “snapshot” topology is seen in FIG. 36.

There are integrated application performance management (APM) vendors that can provide applications to identify, inventory, map, monitor, manage, analyze, performance-assessment and optimize networks from both a back-end and front-end perspective, and provide reports that can be based on qualitative and quantitative measures. The report can provide a visualization or other form of GUI-enabled mapping. Vendors include AppDynamics, Ruxit, and many others.

To implement risk analysis and assessment of the PHI journey life cycle successfully involves mapping at use (create and capture data), in motion (sharing with CEs, BAs, Third Parties), and at rest (analysis, assessment, and destruction). Data must be transparently encrypted/decryption management at motion at each step of the PHI journey. The system should carry out a comprehensive inventory of PHI related data, access controls, internal/external systems, devices, age of data, vendor APPs and APIs, and other devices and functionalities. Vulnerability monitoring should be done of CEs and BAs with access to PHI. A security system can include alerts, intrusion detection, prevention, audit logging, and log management, connectivity, remote access, and disaster recovery.

Putting the disclosures herein in further context, a network can be understood as an interconnected set of 1 to N nodes. The nodes are in interoperable communication. There may be a direct connection from node A to B (via one path or edge), and an indirect connection from node A to node Z. In other words, node Z can reflect a “distant” node from a physical or logical perspective, or both. There can be several nodes between A and Z (multiple paths or edges). The failure of one node can result in a failure of the entire system, meaning that the network system does not as a whole carry out the desired objectives.

Viewed alternatively, if one node has inadequate security parameters then, because it is a node along a chain for which security is required, the entire chain, and indeed entire network, can be “tainted” by the inadequate security of a single node or subset of nodes.

Accordingly, where a node or subset of nodes represents or implements data center, host, process, service or other functionalities then that node can project such risk or vulnerability to multiple nodes—representing multiple health-care compliance parameters, functionalities, and/or activities—and throw a subset of nodes or the entire system out of compliance. Downstream nodes may comprise dependencies, further compounding challenges.

As a result, a shared responsibility model can be advantageous in the sense that multiple nodes of diverse health-care compliance relationships may need to be controlled to ensure an adequate level of compliance. It is true that health care agreements and documents should reflect this shared responsibility model; however, it is just as desirable that the network on which this PHI flows should reflect the shared responsibility model as well.

Individual nodes can be identified by function associated therewith (e.g., security), role associated therewith (e.g., COO), IP address, or other parameters. If a user has improper credentials associated with a given IP address, this could represent an undesirable level of risk. For example, if an employee whose role involves processing PHI at rest, motion or use leaves the entity, there may be a relatively low risk the next day. However, if the same node is accorded the same level of security 30 days after the employee leaves as one day after the employee leaves, it can represent an undesirable risk. The vulnerability is greater for the one than the other.

Put another way, one parameter for assessing risk at the system and/or node level is period of time for which a node is considered at risk.

Another parameter for the above is role/type of position in an entity associated with amount of PHI data.

Another parameter for the above is number of downstream nodes, and upstream nodes, which can reflect magnitude of system “taint” by a node having unacceptable risk, and dependencies.

Another parameter is relationship of the node with one or more of the 168 (or more or fewer) rules associated with federal health-care compliance laws, statutes, rules and regulations.

Another parameter can be solution areas and progress in compliance therewith, protocol measures, and tasks, and other functionalities relating to tables in FIG. 13.

Another parameter can be functionality associated with the node. A given functionality can be assigned a higher value or higher risk, and vice versa.

Another parameter can be progress in meeting health-care compliance as seen above in determining posture scores, solution area scores, task scores, and the like. Values assigned can be comparable with those in the numerators and denominators of the equations given herein.

Another parameter can be any of the above, but suitably weighted.

Another parameter can be magnitude of risk assigned to a node.

Another parameter is overall network topology. For example, how is the network configured: is a vulnerable node upstream of a second node, or downstream? It is possible that the former situation can result in less overall health-care compliance risk. A “heat map” can be made showing nodes or clusters, or chains, or higher or lower risk.

Thus, an inventory of all nodes can be made. This can be seen as a static endeavor, even though dynamic features can apply as well. In addition, a dynamic inventory can be made of nodes that have contact with PHI. In addition, monitoring and tracking of the network and nodes and subsets thereof can be made.

The identity, rating and other parameters associated with a node or nodes can be compared with adequately protected nodes or nodes. An overall score can be obtained. Individual nodes can be ranked on a synchronic basis (at one time, i.e. a snapshot) or diachronic (over time). The evolving risk profile associated with the passage of time and measures taken (or not taken) can be made.

As but one example, a node carrying a threshold value of PHI above a certain level can be made subject to a higher level of scrutiny and/or protection. A node carrying a value below the threshold can be treated otherwise. This concept can be applied beyond the level of an individual node, e.g., to a chain of nodes (path or node, in tree theory), another subset and/or cluster of nodes, and at the level of the entire system. For example, if seven of ten pieces and/or packets of data carried by a node is associated with PHI, and the threshold is 70%, then this node can be flagged for treatment different from one carrying six of ten. If this node is particularly vulnerable—e.g., employee associated with node departed more than one week prior—then a multiplier can be accorded the percentage. Thus, a risk factor of 1.5 can be assigned such that the equation reflects 1.8×0.7 =1.26. An added threshold can be assessed based on such a risk factor multiplier. In other words, if the risk factor threshold is predetermined at 1.1, then because 1.26 exceeds 1.1 then special protection/risk can be associated with this node. The same solution can apply to multiple nodes in chains, other subsets, and in other ways. Multiplier factors can be assigned based on role, group, entity, permissions level and other parameters. An added parameter of concern could be ability of an individual, group, entity or other parameter to modify data such as PHI data; the same can be understood as a node associated with an individual, group, etc. Tree designs can be factored in. For example, the sequence of nodes can be significant. Turning to FIG. 3 again, if one of the core functionalities 310 is considered to be in a risky network topology with respect to an added functionality or functionalities in level 312, 314, then this could be assigned a certain value. If a hospital is in direct connection with another functionality and this is considered undesirable this can be another “red flag” accorded a different value.

In addition, for a network of 10,000 nodes, it is possible that 50 nodes handle PHI on a relatively elevated basis. These nodes can be assigned special attention by the system, and parameters can be determined, as above, such as factors associated with role, group, entity, permissions level, and ability to modify data.

If undesirable levels of risk are found, a workflow can be altered. A node can be bypassed. A node can be “shut down”. Added security measures can be applied. Intrusion tracking can be enhanced. Monitoring and tracking can be strengthened. Other measures can be taken to address, manage and/or lower risk.

Further, in embodiments relevant actors can be determined. Additionally, it can be determined to what extent the actors are in compliance with a predetermined measure. There can be specified sequence of tiers the system consults in accordance therewith. In other words, as seen in FIG. 3, an inner tier can comprise a doctor's office 332, lab 324, hospital 326, and prescription entity. This tier can be consulted first to determine extent of compliance. A second tier can comprise IT services 330, EMR 332, suppliers 334 and vendors 336. These can be consulted second. A further tier can be with reference to third parties 342, CROs 344, claims 346 and payments 340.

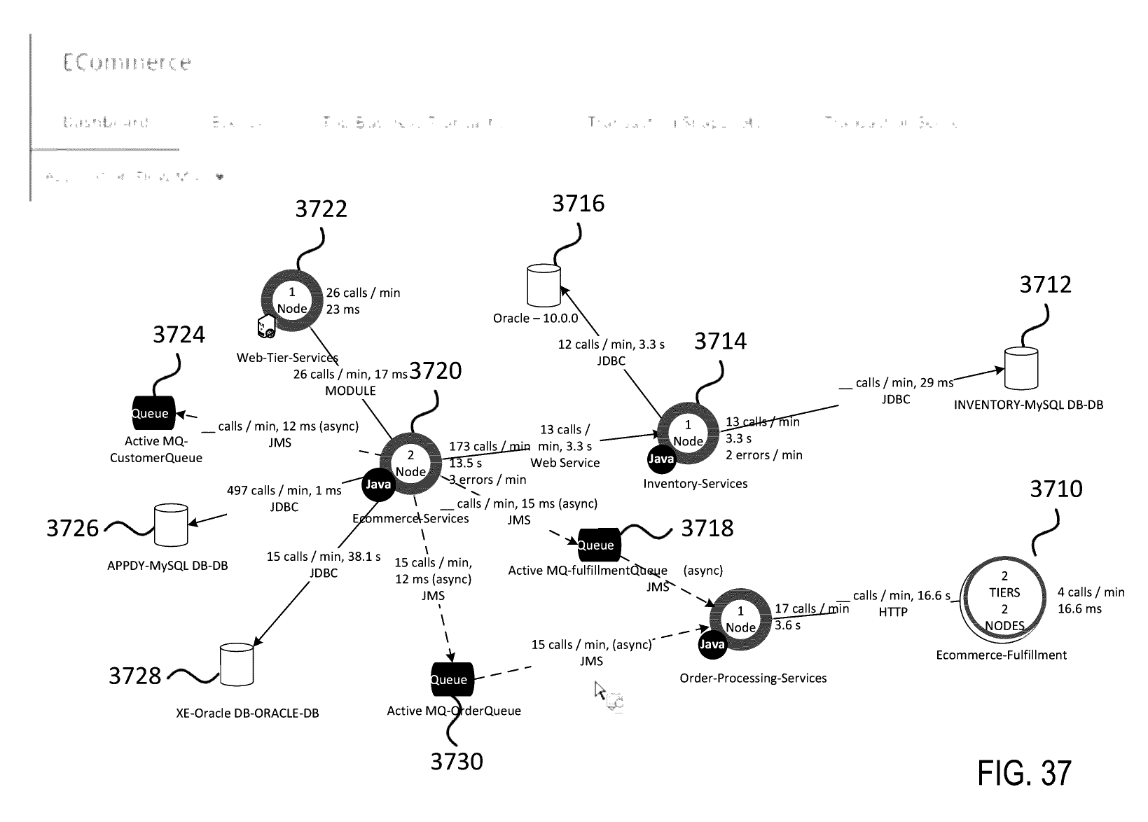

FIG. 37 is an example network topology. Node 3710 is an e-commerce fulfillment node associated with 2 tiers and 2 nodes. Inventory database 3712 is shown. Inventory services db 3714 is shown, as is db 3716. A fulfillment queue 3718 is shown that communicates with a e-commerce services node 3720 associated with two nodes. Shown is a web-tier-services node 3722, customer queue 3724, d 3726 and 3728, as well as an order queue 3730. A tier can be understood as a service, as with an AppDynamics framework. It can also be conceptualized architecturally as nodes.

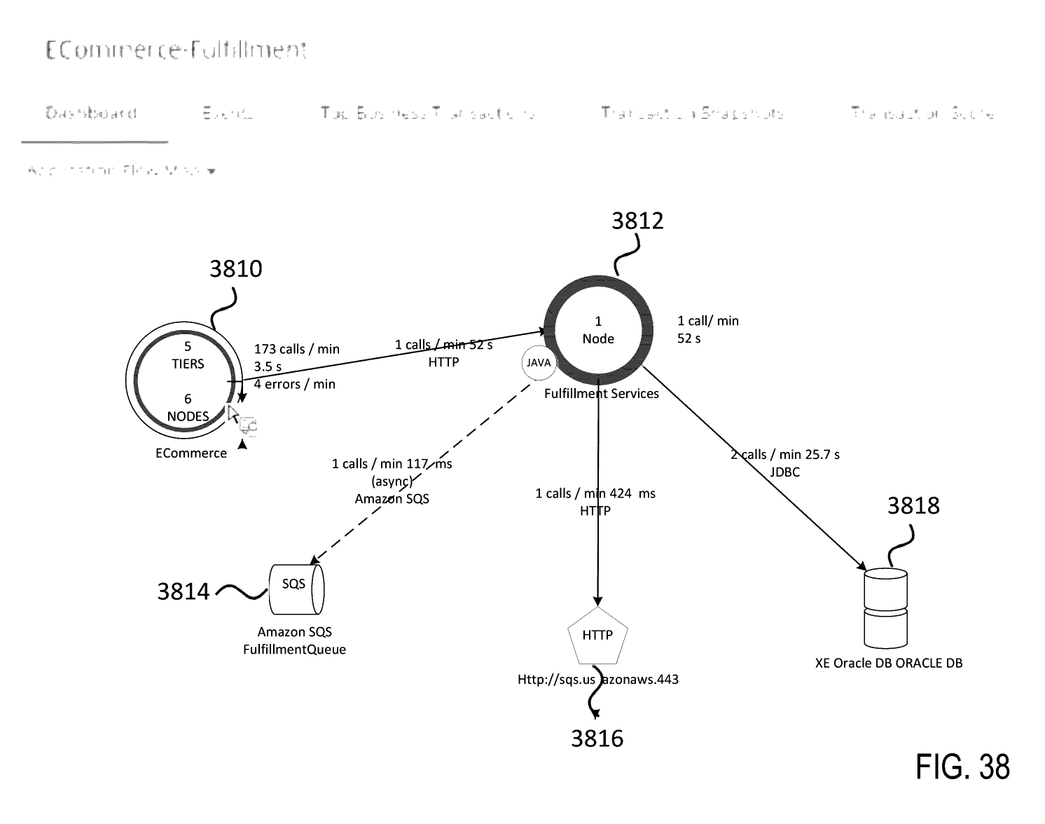

FIG. 38 is an example network topology. Shown are a node 3810 associated with 5 tiers and 6 nodes in communication with node 3812 which is associated with one node. Further, there is Amazon fulfilment queue 3814, node 3816 representing a network and db 3818.

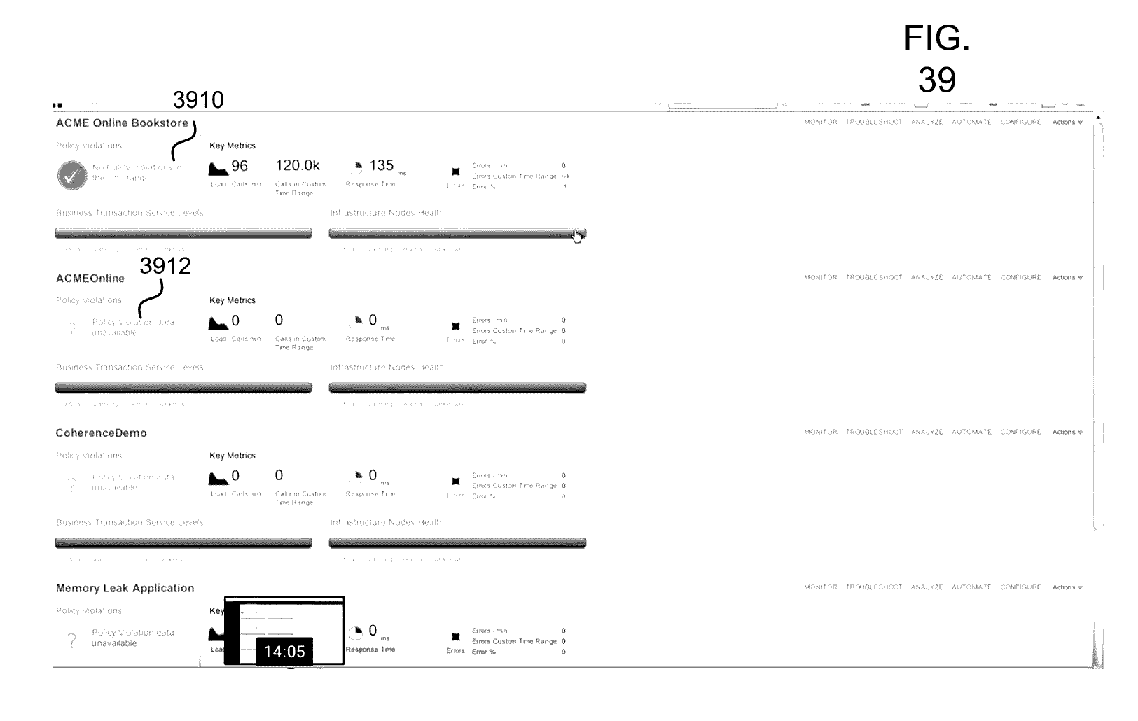

FIG. 39 is an example report on potential policy violations. This can be shown, for example, as a conclusion where there are no policy violations 3910 for a certain entity. Alternatively, it can show a policy violation 3912, which can obtain if policy violation data is unavailable or a violation has been otherwise detected.

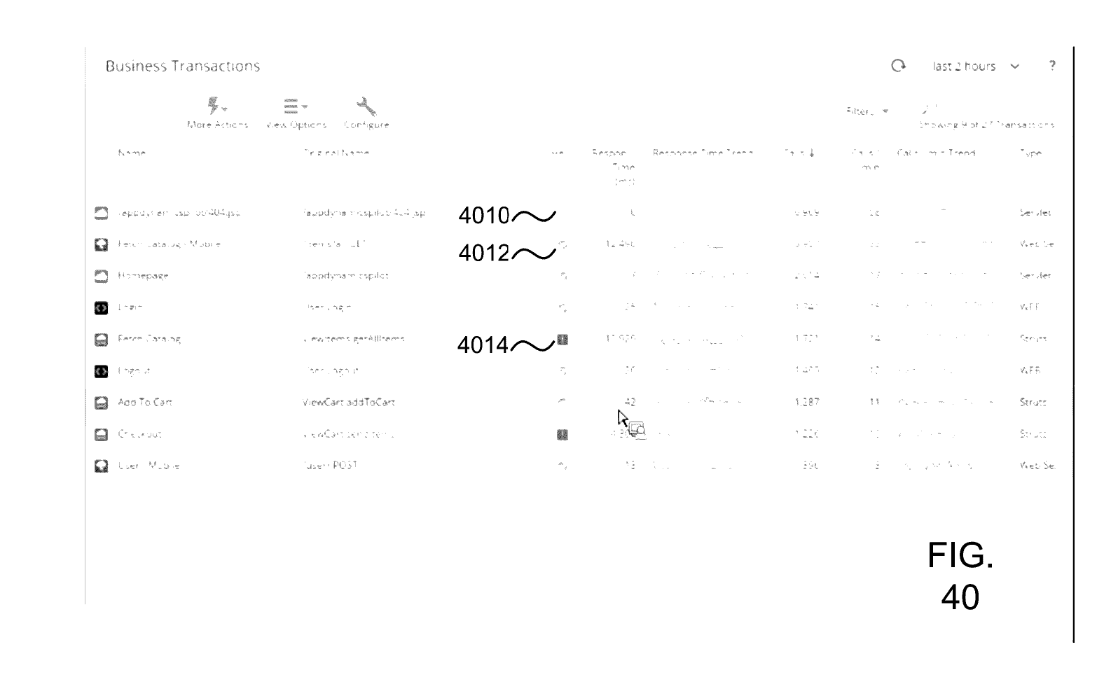

FIG. 40 is an example report on business transactions. It can provide status such as in progress or not yet acceptable 4010, acceptable 4012, or unacceptable 4014.

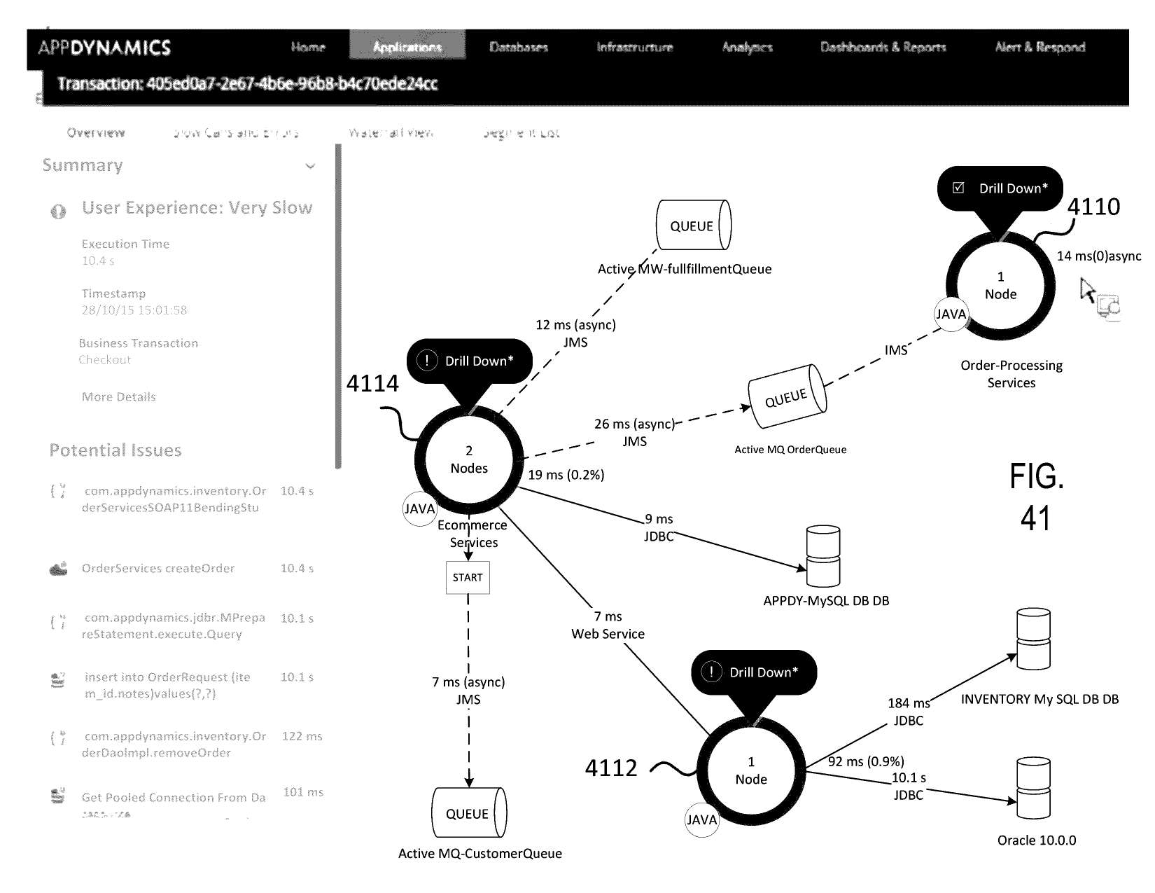

FIG. 41 is an example transaction flow map. Shown are nodes 4114 associated with 2 nodes and in communication with multiple nodes, node 4110 associated with 1 node and in communication with a node, and node 4112 associated with 1 node and in communication with multiple nodes. Nodes 4110, 4112, 4114 can be “drilled down into” to determine additional attributes and parameters, including nodes, tiers, topology and performance of all of the above.

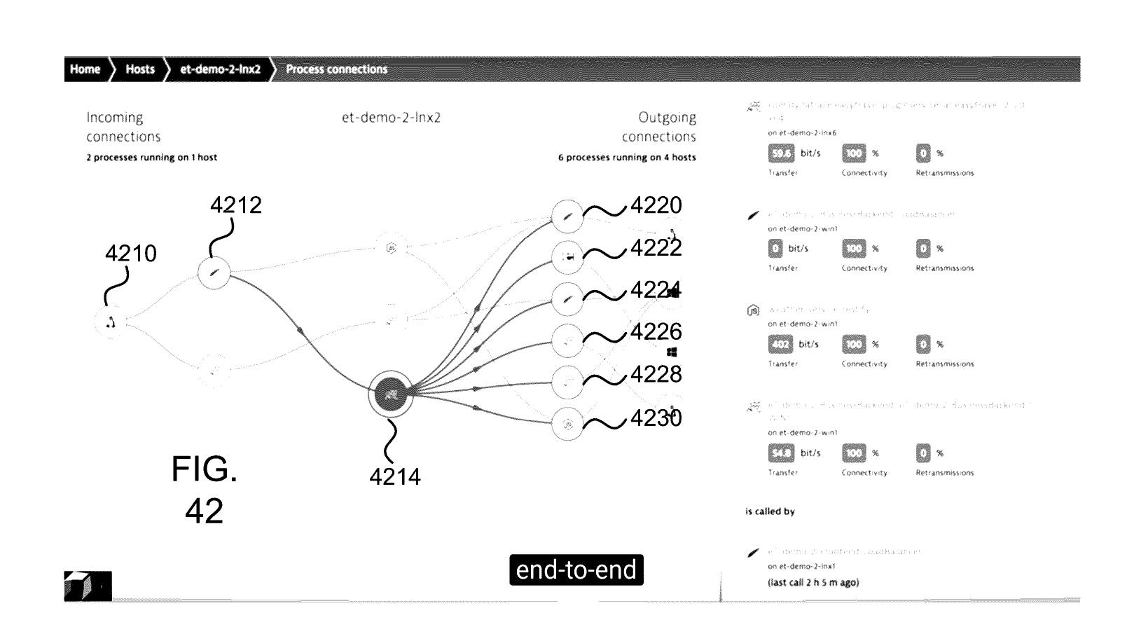

FIG. 42 is an example diagram mapping the flow of PHI in a network. Incoming connections are shown for example at node 4210. A network can transmit to an added node 4212, which sends to node 4214. Node 4214 can be in operative communication with added nodes 4220, 4222, 4224, 4226, 4228, and 4230. This helps to show an example of mapping with an end-to-end model.

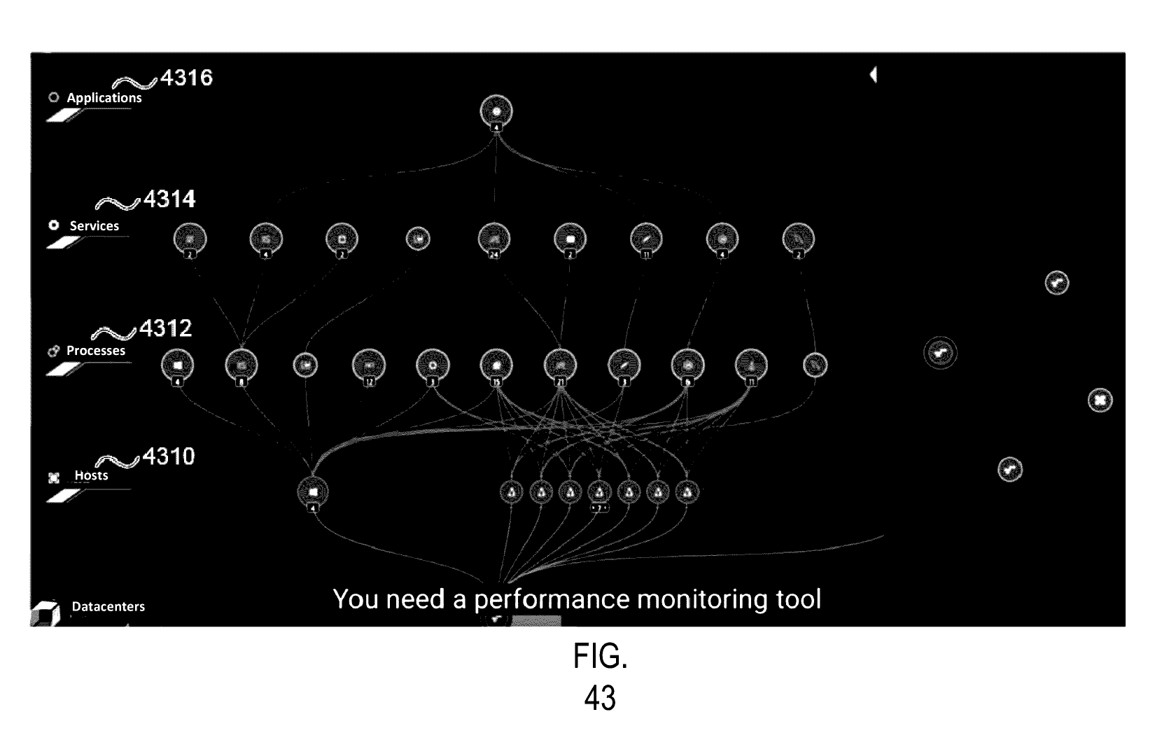

FIG. 43 is an example diagram mapping the flow of PHI in a network. Level 4310 can represent hosts, level 4312 processes, 4314 services and 4316 applications. Thus a node in a given level can represent a host node, process node, services node, and application node respectively, illustrating that a “node” can represent not just a device but a bundle of functionalities that can be addressed as such. Thus performance of such nodes from the perspective of individual nodes, subsets of nodes, and the entire network can be understood.

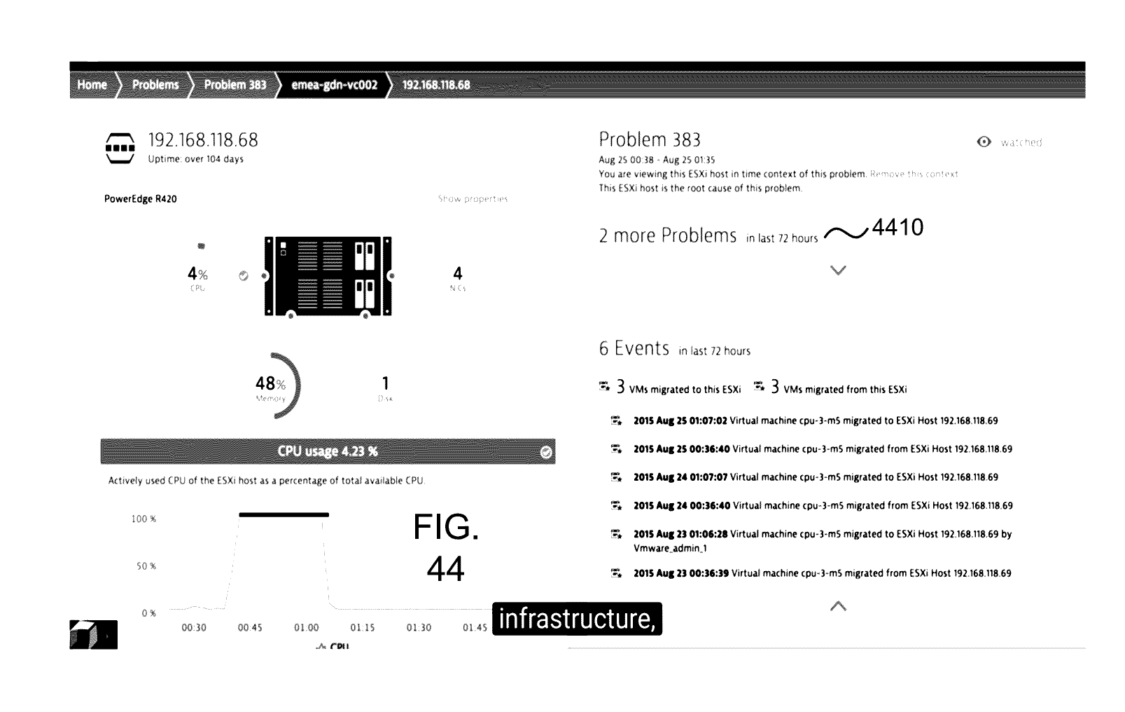

FIG. 44 is an example infrastructure analysis showing IP address logs. Problems can be illustrated and details provided.

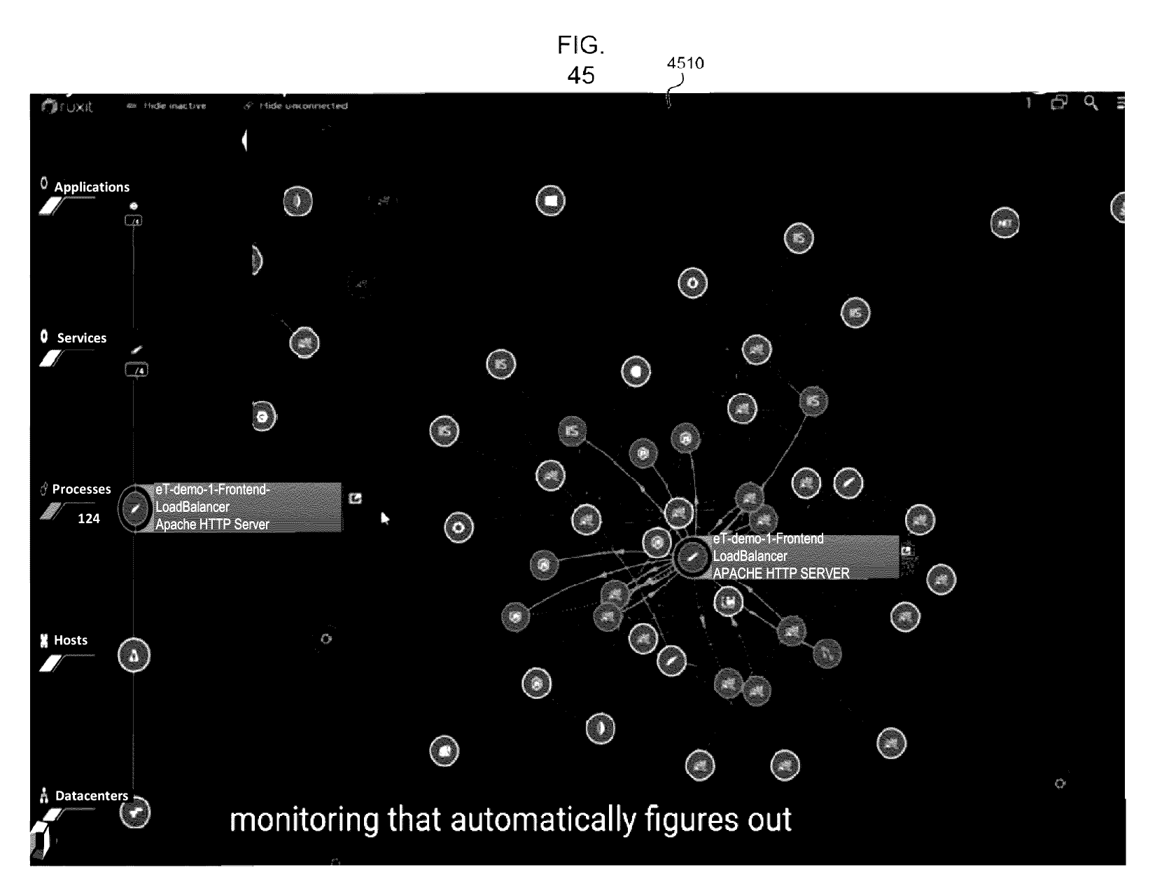

FIG. 45 is an example visualization of flow of PHI in a network. The screenshot 4510 is a visual report of the relationships among nodes and the performance thereof. Again, performance of various functional representations is possible.

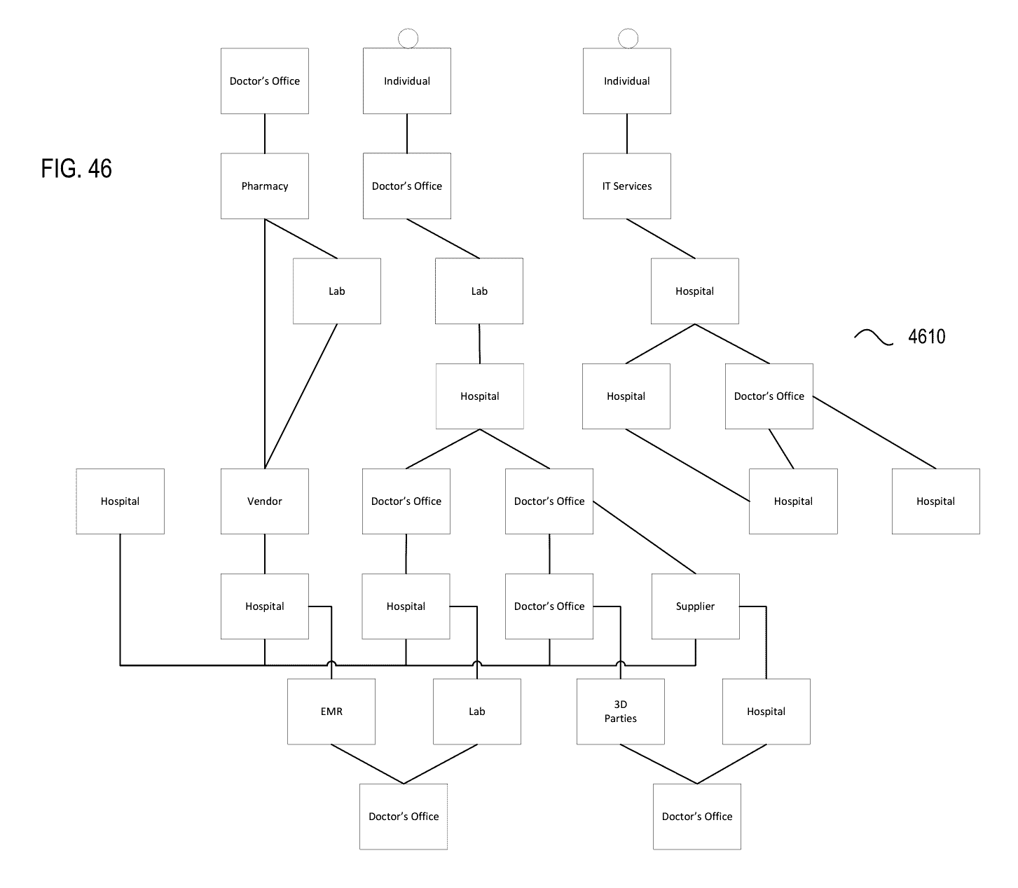

FIG. 46 is an example map of the PHI ecosystem. This can show the growing complexity as subsets of the ecosystem are viewed. Levels and nodes herein can represent those in FIG. 3, i.e., doctor's office 322, vendors 336 and third parties 342. Again, individual nodes can represent single functionalities or multiple ones bundled together as in FIG. 43. Clearly, the PHI ecosystem can represent a highly complex system, with multiple sources of risk at the device level as well as “multiple functionality node” level. An example of the latter is uploading PHI of business associate agreements, storing in memory, and where such PHI is in use, in motion in the network, and perhaps destroyed—all this representable by a node, which itself can be assigned qualitative and quantitative characteristics.

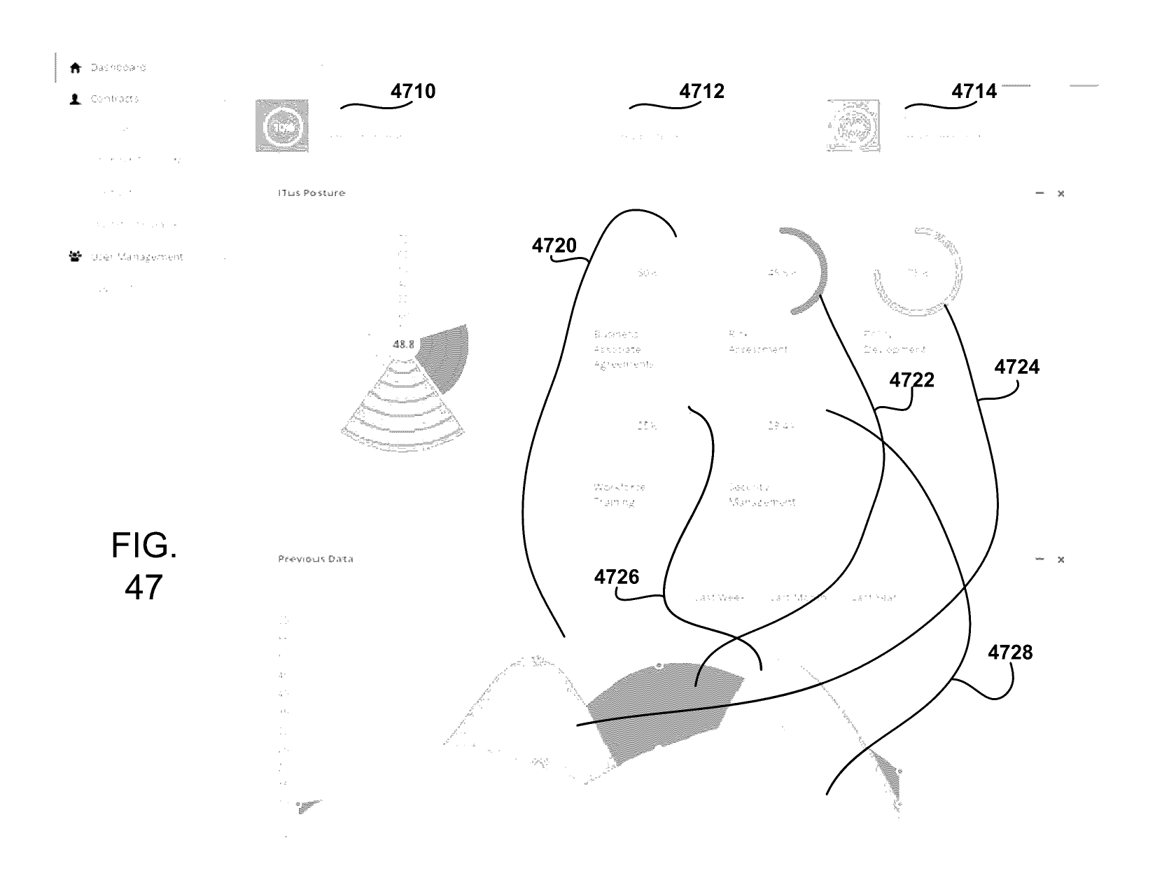

FIG. 47 is an added embodiment of a customized dashboard showing a posture score. By way of non-limiting examples, a dashboard can show a percentage of unstarted status such as if a contract is not started 4710. A percentage of in progress status can be shown 4712. A percentage of completed status can be shown 4714. Each of the foregoing can be shown in respective colors (red for unstarted, yellow for in progress, blue for completed). Further, added color schemes can be given for progress wheels and matched with a table by date 4730. An added overall posture diagram 4740 can be given based on the five areas herein (Business Associate Agreements, Risk Assessment, Policy Development, Workforce Training, Security Management).

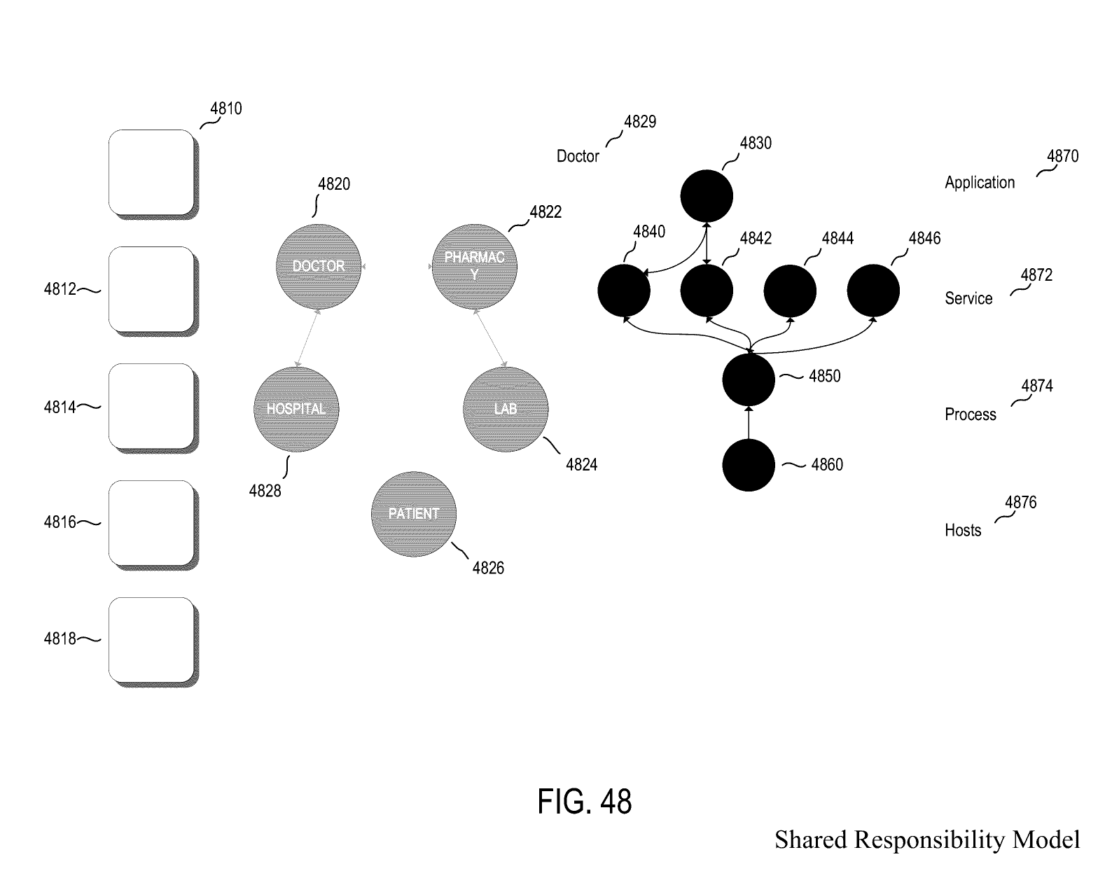

FIG. 48 is an example health-care compliance ecosystem focusing on a doctor's office. Modules for an application 4810, risk analysis 4812, monitoring 4814, security 4816 and privacy 4818 are shown. These modules can assist in managing health-care compliance for PHI by individuals and entities. Also seen are entities/individuals who can generate or otherwise be associated with PHI, such as a doctor 4820, pharmacy 4822, lab 4824, patient 4826 and hospital 4828. PHI associated with a doctor 4829 are seen in nodes 4830, 4840, 4842, 4844, 4846, 4850 and 4860. It will be appreciated that more nodes may in actuality be present, and reference is made to FIG. 33 as but one topology and the complexity thereof. Further, attention is now drawn to the layers nodes can be conceptualized as belonging to. There may be one or more nodes in an application layer 4870, and such nodes may contain parameters specific thereto or be treated under special circumstances. There may be one or more nodes in an application layer 4870, and such nodes may contain parameters specific thereto or be treated under special circumstances. There may be one or more nodes in a service layer 4872, and such nodes may contain parameters specific thereto or be treated under special circumstances. There may be one or more nodes in a process layer 4874, and such nodes may contain parameters specific thereto or be treated under special circumstances. There may be one or more nodes in a hosts layer 4876, and such nodes may contain parameters specific thereto or be treated under special circumstances. In addition, there may be overlap as to parameters or functionalities regarding the layers.

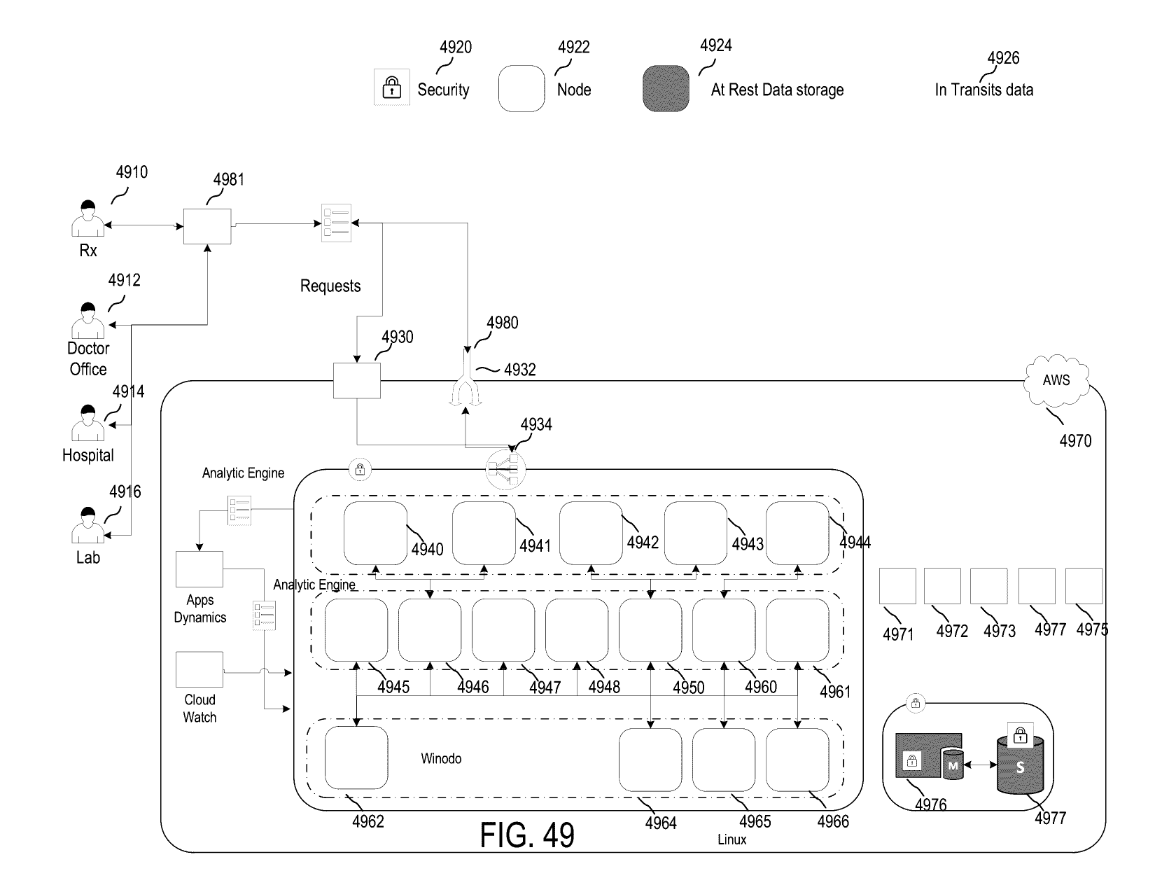

FIG. 49 is an example of a network showing PHI and functionalities, mechanisms and architectures for handling such within the context of health-care compliance. It must be stressed that this is a non-limiting example of such functionalities, mechanisms and architectures which may be in multiple forms and variants. Individuals/entities such as prescription entities 4910, a doctor's office 4912, hospital 4914 and lab 4916 are shown. It will readily be appreciated that added entities and individuals can be shown, such as are disclosed elsewhere herein and may include insurance entities, payers, payees, and additional entities and individuals. Data including PHI data can be in transit 4926; lines in FIG. 49 representing such can be seen, specifically including those interconnecting nodes and shown as with arrows. Such interconnections can include 4980, 4981 and many more. Further, security functionalities 4920 exist. Nodes 4922 are present; indeed many such nodes are typically found throughout a network. Requests can be sent to a set of health-care compliance management modules interoperable with analytics engine, a performance monitoring/assessment functionality such as that by AppDynamics, and there can be a monitoring functionality such as CloudWatch. Instances of applications 4940, 4941, 4942, 4943, 4944 can be run within the health-care compliance management modules, as well as applications 4945, 4946, 4947, 4948, 4950, 4960 and 4961. These can be in interoperative communication with a Winodo module 4962, and Linux modules 4963, 4964, 4966. Amazon Web Services 4970 can be seen as a service handling certain modules. In addition, a router 4930 and API Gateway 4932 are seen. Added functionalities such as Glacier 4971, Lambda 4972, Cloud Search 4973, S3 4974 and Cognito 4975 can be interoperative therewith. Further, at-rest data storage can be seen such as an encrypted database 4976, and a database slave 4977. Again, FIG. 49 shows an example network and many variants, features and functionalities and can be understood to represent numerous networks reflecting PHI data in transit, at rest and in use.

While various details have been set forth in the foregoing description, it can be appreciated that the various aspects of the HIPAA compliance methods and systems process may be practiced without these specific details. For example, for conciseness and clarity selected aspects have been shown in block diagram form rather than in detail. Some portions of the detailed descriptions provided herein may be presented in terms of instructions that operate on data that is stored in a computer memory. Such descriptions and representations are used by those skilled in the art to describe and convey the substance of their work to others skilled in the art.

In summary, numerous benefits have been described which result from employing the concepts described herein. The foregoing description of the one or more embodiments has been presented for purposes of illustration and description. It is not intended to be exhaustive or limiting to the precise form disclosed. Modifications or variations are possible in light of the above teachings. The one or more embodiments were chosen and described in order to illustrate principles and practical application to thereby enable one of ordinary skill in the art to utilize the various embodiments and with various modifications as are suited to the particular use contemplated.

What is claimed is:

1. A system for determining a health-care compliance score, the system having at least one processor and at least one memory in operative communication therewith, the system comprising:
identifying a set of health-care compliance parameters enumerable as integers 1 through N;
for each compliance parameter, based on health-care compliance data:
identifying an extent of progress made in completing the compliance parameter;
determining a numerical completion value for each compliance parameter representing the extent of progress made in completing the parameter;
determining a first sum, the first sum representing the sum of the numerical completion values; and
determining a health-care compliance score by dividing the first sum by the numerical value of N.

2. The system of claim 1, wherein the numerical completion value is represented by one of the binary values 100% complete or 0% complete.

3. The system of claim 1, wherein the numerical completion value is represented by a value representing greater than 0% complete or less than 100% complete.

4. The system of claim 1, wherein a weighting factor is applied to at least one numerical completion value.

5. The system of claim 4, wherein the weighting factor is based on a value representing a level of importance assigned to the health-care compliance activity.

6. The system of claim 1, wherein the system is structured to transmit instructions to a display to display the health-care compliance score.

7. The system of claim 6, wherein the displayed health-care compliance score data is formatted for presentation in the form of color, symbolic elements, or graphical elements.

8. The system of claim 7, wherein the presentation format represents an overall progress in completing at least one health-care compliance parameter.

9. The system of claim 1, wherein the system uses health-care compliance data to predict status of a future health-care compliance parameter.

10. A system for storing health-care compliance data in hierarchically based data structures, the system having at least one processor and at least one memory in operative communication therewith, the system comprising:
storing a first health-care compliance parameter data structure on an upper level of a hierarchy;
storing a second health-care compliance parameter data structure on a level of the hierarchy below that of the first data structure; and
identifying a relationship between the first health-care compliance parameter data structure and the second health-care compliance parameter data structure.

11. The system of claim 10, wherein the first health-care compliance parameter data structure or second health-care compliance parameter data structure represents a Solutions Area data structure, Protocol Measures data structure, Tasks data structure, or an Action Steps data structure.

12. The system of claim 10, wherein a Solutions Area data structure represents health-care compliance parameters related to at least one of: Policy Development, Business Associate Agreements, Risk Assessment, Security Management, Privacy Documentation and Access, Work Force Management, Work Force Training, Uses and Disclosure, Security Incident Procedures, Breach Assessment and Resolution, Contingency Disaster Planning, and Attestation.

13. The system of claim 11, wherein the first health-care compliance parameter data structure comprises a Solutions Area data structure, and the second health-care compliance parameter data structure comprises a Tasks data structure or a Protocol Measures data structure.

14. The system of claim 11, wherein the first health-care compliance parameter data structure comprises a Tasks data structure, and the second health-care compliance parameter data structure comprises an Action Steps data structure.

15. The system of claim 11, wherein a numerical value can be assigned to represent a measure of health care compliance by:
summing values of an extent of progress in completing individual health-care activities in the second data structure, and dividing by a numerical value representing the number of health-care activities in the second data structure.

16. The system of claim 11, wherein a health-care compliance parameter in the first data structure is pairable with two or more health-care compliance parameters on a lower level of the hierarchy.

17. The system of claim 11, wherein the system is structured to transmit instructions to a display to display a measure of health-care compliance in graphical form on a display.

18. A system for managing health-care compliance, the system having at least one processor and at least one memory in operative communication therewith, the system comprising:
at least one database storing a set of health-care compliance parameters derived from health-care statutes, regulations, rules or guidelines;
a user interface on a display, the user interface enabling a user to access a platform comprising the at least one database;
a table associated with the at least one database, the table having information related to a health-care compliance role held by an individual;
determining, when the user accesses the platform, a role associated with the user; and
selectively displaying health-care compliance parameters, activities or analytics to the user based on the role associated with the user.

19. A system for mapping a network carrying health-care information, the system having at least one processor and at least one memory in operative communication therewith, the system comprising:
a mapping module to determine entities or individuals in the health-care ecosystem that have access to the health-care information when the information is at rest, in motion, or in use;
a solutions module to determine an extent of compliance with a predetermined level health-care compliance parameter; and
a reporting module structured to transmit a report of a status of compliance to a user display.

20. The system of claim 19, wherein the mapping module identifies a network node in association with at least one of a doctor's office, laboratory, prescription entity or hospital.

21. The system of claim 19, wherein the solutions module is associated with one of the following solution areas associated with federal health-care statutes, rules or regulations:
policy and process, business associate agreements, risk analysis, security management, policy document, work force management, work force training, uses and disclosure, security incident procedures, breach assessment and resolution, contingency disaster planning, and attestation.

22. The system of claim 19, further comprising a shared responsibility module that determines an amount of individuals or entities considered to be in compliance.

23. The system of claim 22, wherein a threshold is set at or above which compliance is determined to exist.

24. A system for mapping a network carrying health-care information, the system having at least one processor and at least one memory in operative communication therewith, the system comprising:
a mapping module to determine nodes in the health-care ecosystem that have access to the health-care information when the information is at rest, in motion, or in use;
a node-identification module that associates a value with a node; and
a risk-management module that determines a level of risk associated with a node.

25. The system of claim 24, wherein the value is based on a security parameter.

26. The system of claim 24, wherein the value is based on a privacy parameter.

27. The system of claim 24, wherein the value is the IP address associated with the node, identity or role of an individual or entity associated with the node, or functionality of the node.

28. The system of claim 24, wherein the value is quantitative.

29. The system of claim 24, wherein the value is based on the role of an individual or entity associated with the node.

30. The system of claim 24, wherein the value is based on a physical location of the node in the network.

31. The system of claim 24, wherein the value is based on a logical location of the node in the network.

32. The system of claim 24, wherein the level of risk is based on the amount or nature of the PHI flowing through or stored at the node.

33. The system of claim 24, wherein the level of risk is weighted based on at least one factor.

34. The system of claim 24, wherein, based on a determined level of risk, the network is determined to be in compliance with health-care laws, rules, statutes or regulations.

35. The system of claim 24, wherein, based on a determined level of risk, a subset of nodes of the network is determined to be in compliance, in partial compliance, or out of compliance with health-care laws, rules, statutes or regulations.

36. The system of claim 24, wherein, based on a determined level of risk, an individual node of the network is determined to be in compliance, in partial compliance, or out of compliance with health-care laws, rules, statutes or regulations.
